(19) United States
(12) Patent Application Publication
(10) Pub. No.: US 2023/0221556 A1
(43) Pub. Date: Jul. 13, 2023

(54) LENSLET BASED ULTRA-HIGH RESOLUTION OPTICS FOR VIRTUAL AND MIXED REALITY

(71) Applicant: Tesseland, LLC, Pasadena, CA (US)

(72) Inventors: Pablo BENITEZ, Madrid (ES); Julio C. CHAVES, Coimbra (PT); Juan Carlos MINANO, Madrid (ES); Dejan GRABOVICKIC, Madrid (ES); Marina BULJAN, Madrid (ES); Milena NIKOLIC, Madrid (ES); Ruben MOHEDANO, Madrid (ES)

(21) Appl. No.: 17/780,799

(22) PCT Filed: Dec. 7, 2020
(86) PCT No.: PCT/US2020/063629

§ 371 Date: May 27, 2022

Related U.S. Application Data
(60) Provisional application No. 63/090,795, filed on Oct. 13, 2020.
(60) Provisional application No. 62/944,105, filed on Dec. 5, 2019.

(51) Int. Cl. G02B 27/01; G02B 3/00

(52) U.S. Cl. CPC G02B 27/0172; G02B 3/0056; G02B 2027/0123; G02B 2027/0147

(57) ABSTRACT

A display device including a display to generate a real image, and an optical system. The optical system includes a plurality of lenslets, each having one cluster of object pixels, where the assignation of object pixels to clusters may change periodically in time intervals. Each lenslet produces a ray pencil from each object pixel of its cluster which has waists laying close to a waist surface. The ray pencils are projected towards an eye position. The ray pencils are configured to generate a partial virtual image from the real image of its corresponding cluster. At least two of the lenslets cannot be made to coincide by a simple translation rigid motion. Foveal rays are a subset of rays emanating from the lenslets.

### CROSS REFERENCE TO RELATED APPLICATIONS

This application claims benefit of and priority to commonly invented and assigned U.S. Provisional Patent Application No. 62/944,105, filed on 5 Dec. 2019 for “Lenslet Based Ultra-High Resolution Optics For Virtual And Mixed Reality”, and U.S. Provisional Patent Application No. 63/090,795, filed on 13 Oct. 2020 for “Lenslet Based Freeform Optics”. Both of those provisional applications are incorporated herein by reference in their entirety.

### FIELD OF THE INVENTION

The present invention relates to a display device including a display to generate a real image and an optical system and, more particularly, to an improved optical system with a plurality of lenslets each producing a ray pencil from each object pixel of a cluster.

### BACKGROUND

### 2. Definitions

| | |
|---|---|
| Accommodation | Small region in the image space where a single human eye accommodates |
| pixel or a-pixel | when it gazes that region and so its foveal region is illuminated (completely |
| | or partially) by a set of pencils carrying the same information (same |
| | luminance and color). This set of pencils, which may consist of one or |
| | more pencils, is said to form the a-pixel. That luminance and color become |
| | a property of the a-pixel at a given instant. The pencils are such that their |
| | principal rays meet near the a-pixel, which is also close or coincident with |
| | the location of the waist of the union of those pencils. Nevertheless, this |
| | waist is not necessarily close to the individual waists of the different |
| | pencils forming the a-pixel. A given pencil is part of no more than one a- |
| | pixel during a given time interval but it may be part of different a-pixels at |
| | different instants. If a set of pencils is forming always the same a-pixel, the |
| | a-pixel is said to be static. In this case, all the pencils of the a-pixel carry |
| | always the same luminance and color. Otherwise, the a-pixel is said to be |
| | dynamic. The eye perceives the a-pixel as an emitting region when its |
| | luminance is high enough and it is located at sufficient distance from the |
| | eye. |
| Accommodation | In some optical systems, accommodation pixels can be grouped by its |
| surface | proximity to certain surfaces. These surfaces are called accommodation |
| | surfaces. Sometimes they are approximated by spheres or even by planes, |
| | taken the names accommodation sphere or accommodation plane. |
| Centered gazing | Field associated to the ray trajectory passing through the lenslet exit |
| field of a lenslet | aperture center and whose straight prolongation passes through the center |
| | of the eye ball sphere. |
| Channel | Cluster and all the optics through which the cluster emits. This optics is in |
| | general a lenslet made up of microlenses but can also comprise conforming |
| | lenses. For this reason a channel is also called sometimes lenslet, even |
| | though it may include conforming lenses. Sometimes channel refers to the |
| | set of rays emitted by a cluster and reaching the pupil range. |
| Cluster | Set of o-pixels assigned to a single channel and that are imaged by it. This |
| | set may change with time. The assignation of object pixels to clusters may |
| | change periodically in time intervals, preferably a frame period |
| Conforming lens | Lens intercepting the path of every ray illuminating the pupil range from |
| | the digital display. Unlike a lenslet array, a conforming lens cannot be |
| | divided in disjoint portions such that each one of them is working solely for |
| | a single channel. A conforming lens can be placed between the eye and the |
| | rest of the optical system or between lenslet arrays or even between the |
| | digital display and the rest of the optical system. A conforming lens may- |
| | have at least one surface with slope discontinuities to either reduce its |
| | thickness as a Fresnel lens, or to habilitate the use two or more displays per |
| | eye. |
| Dark corridor or | Set of o-pixels turned off around the clusters. The guard avoids optical |
| guard | cross-talk while guaranteeing a certain tolerance for the optics positioning. |
| | In the underfilling strategy, the dark corridor is used to increase resolution |
| | relative to the overfilling strategy. This set may change with time. Drak |
| | corridors are composed by unlit viewable object pixels. Typically are more |
| | than 25% of the total of viewable object pixels: but could reach more than |
| | 50% of the total of viewable object pixels in certain embodiments; |
| Digital display | Opto-electronic component that modulates temporally and spatially the |
| | light emitted by a surface. It can be self-emitting as an OLED display or a |
| | micro-LED display or externally illuminated by a front or a backlight |
| | system as an LCOS or an LCD. This invention is not restricted to flat |
| | displays. Curved displays, in particular cylindrical ones, are of interest to |
| | increase the FOV and reduce optical aberrations. |
| Directional | Consider an array of channels, each one of them approximately imaging a |
| magnification | portion the digital display on a sphere of radius R_{∞} centered at the eye’s |
| and directional | sphere center. R_{∞} is much greater than the radius of the eye’s sphere. Let |
| focal length | r = (x, y) be a point of the digital display and let (θ, φ) be two spherical |
| functions | coordinates of the point on that sphere (a field point) where the rays issuing |
| | from (x,y) are virtually imaged by the channel (i, j), i.e., these rays are |
| | virtually coming from the field point (θ, φ) of the sphere when they intercept |
| | the eye. Let’s call θ the polar angle and φ the azimuthal angle. Let’s θ = 0 be |
| | the eye’s frontward direction. Then r = (x, y) depends on θ, φ, i , j. Let Δr be the |
| | change of r when the point of said sphere moves differentially from (θ, φ) to |
| | (θ + Δθ + Δφ) such that tan α = sinθΔφ/Δθ. Let’s call α the direction angle. |
| | The directional magnification m of the channel (i, j) is a function |
| | $of ( θ , φ , α , i , j ) defined as m = \frac{1}{{R}_{∞}} \vert {r}_{θ} cos α + ( {r}_{φ} / sin θ ) sin α \vert , where the$ |
| | subindices θ, φ indicate partial derivative. This function is called directional |
| | magnification along direction a at the field point (θ, φ). Notice that this |
| | magnification definition corresponds to ray trayectories reversed from the |
| | actual ones i.e., from display to the eye, since it corresponds to a ratio of a |
| | distance between points on the display surface to the distance between the |
| | field points on the waist-surface. This reverse operation is the usual one in |
| | Head Mounted Display (HMD) optics design, so this magnification m is the |
| | commonly used in commercial software as Zemax or Code V, while m⁻¹ is |
| | the one normally used in magnifying instruments as binoculars or |
| | microscopes. In the limit case when R_{∞} is infinity, it is preferable to use the |
| | direction focal length defined as f = mR_{∞} =\|R_{θ} cos α + r_{φ}/sin θ)sin α\|, |
| | which will be called directional focal length along direction a at the field |
| | point (θ, φ). The directional magnification as well as the directional focal |
| | length are called respectively radial magnification and radial focal length |
| | when α = 0. |
| Equi-focal | A channel array where all its channels have the same directional |
| channel (or | magnification, i.e., where m = m(θ, φ, α) does not depend on (i, j). Not to be |
| lenslet) array | confused neither with channels that have the same magnification function |
| | for different points (θ, φ) of the R_{∞}-sphere (i.e., for all θ, φ in the domain of |
| | interest, ∂f(θ, φ, α, i ,j)/∂θ = ∂f(θ, φ, α, i, j)/∂φ = 0, which are called constant |
| | directional lenslets nor with channels that have the same magnification |
| | function for different directions (i.e., ∂f(θ, φ, α, i ,j)/∂α = 0 for all α), which |
| | are called isotropic directional magnification lenslets. |
| Eye pupil | Image of the interior iris edge through the eye cornea seen from the exterior |
| | of the eye. In visual optics, it is referenced to as the input pupil of the |
| | optical system of the eye. Its boundary is typically a circle from 3 to 7 mm |
| | diameter depending on the illumination level. |
| Eye sphere | Sphere centered at the approximate center of the eye rotations and with |
| | radius rₑ the average distance of the eye pupil to that center (typically 10-13 |
| | mm). |
| Field of View or | Simply connected angular region containing the solid angle subtended by |
| FOV | union of all pencil waists from the eye center. Its size use to be described |
| | by its horizontal and its vertical full angles. It may be different for left and |
| | right eye’s. |
| First reference | Plane normal to skull’s frontward direction and containing the eye pupil |
| plane | center which is the origin of its x′, y′ coordinates whose y′ axis is in the |
| | vertical direction. |
| Fixation point | Point of the scene that is imaged by the eye at center of the fovea, which is |
| | the highest resolution region of the retina. Rays hitting the fovea typically |
| | imping on the eye ball forming an angle smaller than 2.5 deg with respect |
| | to the eye lens optical axis. |
| Foveal ray | Ray reaching the eye ball such that its straight prolongation virtually |
| | intersects the foveal reference sphere |
| Foveal reference | A sphere concentric with the eye sphere center with radius between 2 and 4 |
| sphere | mm. This sphere is virtually crossed by the straight prolongation of the |
| | foveal rays which reach the fovea for at least one pupil position belonging |
| | to the pupil range. |
| Full color pixel | RGB or RGBW or any other set of different color neighbor o-pixels which |
| | is commonly called “pixel” in the literature |
| Gaze vector γ | Unit vector γ of the direction linking the center of the eye pupil and the |
| | fixation point. |
| Gazeable region | Angular region of the Field of View containing the projections from the |
| of the FOV | eye sphere center of all the a-pixels that can be gazed. |
| Gazing line | Straight line supporting the gaze vector. |
| Human angular | Minimum angle subtended by two point sources which are distinguishable |
| resolution | by an average perfect-vision human eye. The angular resolution is a function |
| | of the peripheral angle and of the illumination level. |
| Inner lit pencil | Pencil illuminating properly the pupil, i.e., the pencil belongs to a cluster |
| | whose associated optical channel is the one through which the pencil |
| | illuminates the pupil. |
| Kappa angle | The kappa angle is the angle formed between a human eye visual axis (also |
| | called line of sight or foveal-fixation axis) and its optical axis (called also |
| | pupillary axis). The optical axis is composed of an imaginary line |
| | perpendicular to the cornea that intersects the center of the entrance pupil. In |
| | comparison, the visual axis is an imaginary line that connects the object in |
| | space, the center of the entrance and exit pupil, and the center of the fovea. |
| | The value of the kappa angle varies greatly (1.5 to 5.8 deg) not only between |
| | different people but even between the two eyes of the same person (Oman J |
| | Ophthalmol. 2013 Sep-Dec; 6(3):151-158.doi: 10.4103/0974-620X.122268) |
| Lenslet | Each one of the individual optical imaging systems (such as a lens or a set |
| | of lenses for instance) of the optics array, which collects light from the |
| | digital display and projects it to the eye sphere, sometimes directly to eye |
| | sphere and sometimes with the aid of an additional lens, called |
| | “conforming lens”, which is common for all the lenslets in the array. The |
| | lenslets are designed to lit pencils with the light of its corresponding o- |
| | pixel. There is one cluster per lenslet. The cluster gathers all the o-pixels |
| | corresponding to a single lenslet. The mapping between the o-pixel plane |
| | and the waist surface of the corresponding pencils induced by a single |
| | lenslet is continuous. Each lenslet may be formed by one or more optical |
| | surfaces, not necessarily refractive. The different parts of a lenslet are |
| | generically called microlenses. The microlenses of a single lenslet process |
| | the light sequentially or “in series”, i.e., one microlens after another from |
| | the digital display to the eye, unlike the microlenses of a single microlens |
| | array that process the light in “parallel”. |
| Object pixel or | Unit of information of the display. The object pixel is a small emitting |
| o-pixel | surface region (diameter between 3 and 6 microns typically) of the display. |
| | The o-pixel feeds a pencil with light power. All the points of an o-pixel |
| | surface emit (really or virtually) with the same illuminance and color, with |
| | a constant angular emission pattern and with similar polarization state. |
| | Illuminance and color are detectable by the eye when the light reaches the |
| | retina. Emission pattern, polarization state and sometimes color are |
| | characteristics that may determine the path of the light through the optics, |
| | conditioning, for instance, the channel through which the light is going to |
| | flow. All the rays emitted by an o-pixel and reaching a human eye have, in |
| | general, the same or similar luminance and color. The o-pixel is often |
| | called subpixel in the literature where the name pixel is reserved to the |
| | combination of several colors (typically RGB) neighbors’ subpixels. |
| Optical cross-talk | Undesirable situation in which more than one pencil illuminated by the |
| | same o-pixel reaches the eye’s retina. |
| Outer lit pencil | Pencil illuminating the eye globe outside the pupil that shares an o-pixel |
| | with a pencil of a cluster illuminating the pupil through its corresponding |
| | channel. |
| Outer region of | Angular region of the virtual screen complementary to the gazeable region |
| the FOV | of the FOV. |
| overfilling | Eye illumination strategy such that the light sent from the digital display to |
| | the eye pupil by the optics fills the pupil completely. |
| Pencil | Set of straight lines that contain segments coincident with ray trajectories |
| | illuminating the eye, such that these rays carry the same information at any |
| | instant. The same information means the same (or similar) luminance, color |
| | and any other variable that modulates the light and can be detected by the |
| | human eye. In general, the color of the rays of the pencil is constant with |
| | time while the luminance changes with time. This luminance and color are |
| | a property of the pencil. The pencil must intersect the pupil range to be |
| | viewable at some of the allowable positions of the pupil. When the light of |
| | a pencil is the only one entering the eye’s pupil, the eye accommodates at a |
| | point near the location of the pencil’s waist if it is being gazed and if the |
| | waist is far enough from the eye. The rays of a pencil are representable, in |
| | general, by a simply connected region of the phase space. The set of |
| | straight lines forming the pencil usually has a small angular dispersion and |
| | a small spatial dispersion at its waist. A straight line determined by a point |
| | of the central region of the pencil’s phase space representation at the waist |
| | is usually chosen as representative of the pencil. This straight line is called |
| | central ray of the pencil. The waist of a pencil may be substantially smaller |
| | than 1 mm² and its maximum angular divergence may be below ±10 mrad, |
| | a combination which may be close to the diffraction limit. The pencils |
| | intercept the eye sphere inside the pupil range in a well-designed |
| | embodiment. The light of single o-pixel lights up one or more pencils each |
| | one of them corresponding to different lenslets. These pencils are called the |
| | associated pencils of the o-pixel. In a well designed embodiment the |
| | associated pencils of an o-pixel that pass through the pupil and reach the |
| | eye’s retina simultaneously must have the same or similar waist, otherwise |
| | there is undesirable cross-talk between lenslets. When at least one of these |
| | associated pencils reaches the retina the o-pixel is said to be viewable. One |
| | lenslet plus one o-pixel may determine more than a single pencil when the |
| | lenslet optics is sensitive to polarization state, to color or to any other |
| | variable that the o-pixel may change. The o-pixel to lenslet cluster |
| | assignation is dynamic and depends on the eye pupil position. |
| Pencil interlacing | Pencil interlacing happens when pencils of neighbor lenslets have their |
| | corresponding waists interleaved in the waist surface. Pencil interlacing |
| | strategy allows increasing the density of pencil waists without increasing |
| | the lenslets focal length nor the o-pixel density. When the lenslets apertures |
| | are small enough, these interlaced pencils reach the retina simultaneously |
| | through the eye’s pupil, thus effectively increasing the perceived resolution |
| | (i.e., increasing the pixels per degree). |
| Pencil print | Region of the eye globe enclosing the intersection of the straight lines of a |
| | pencil with the globe. The globe is sometimes approximated by a plane. |
| Peripheral angle | Angle β formed by a certain direction with unit vector θ and the gaze unit |
| | vector γ, i.e., β = arccos(θ · γ) |
| Peripheral pencil | A peripheral pencil is a pencil where none of its rays is foveal. |
| Pupil range | Region of an imaginary sphere comprising all expected eye pupil positions. |
| | Said sphere is fixed to the user’s skull and approximates the eyeball sphere. |
| | Its diameter is between 8 and 12 mm. In practice, the maximum pupil |
| | range is an ellipse with angular horizontal semi-axis of 60 degs and vertical |
| | semi-axis of 45 degs relative to the front direction, but a practical pupil |
| | range for design can be a 40 to 60 deg full angle cone, which is the most |
| | likely region to find the pupil. This region is known as the static pupil |
| | range. When the system has eye-tracking it is interesting to define also a |
| | dynamic pupil range, which comprises the expected pupil positions for a |
| | given time slot. This region in general comprises a single pupil position. |
| Scene | Simply connected region of the space containing, at least, every a-pixel, v- |
| | pixel and pencil waist. |
| Surface S1 | Entry surface of the lenslet array that is closer to the digital display. |
| Surface S2 | Exit surface of the lenslet array which is closer to the eye. |
| underfilling | Eye illumination strategy such that the light sent from the digital display to |
| | the eye pupil by the optics does not fill the pupil completely. Maxwellian |
| | pupil illumination is a case of underfilling. |
| VA-design | Optical design in which every v-pixel and its 2 associated a-pixels |
| | essentially coincide. |
| Vergence pixel or | Small region in the image space where the two human eye converge when |
| v-pixel | each one of them is illuminated on its foveal region by pencils forming a |
| | corresponding a-pixel, one for each eye, both a-pixels carrying the same |
| | information (same luminance and color). This pair of a-pixels is said to |
| | form the v-pixel. The v-pixel is located near the intersection of the two |
| | gazing lines (one per eye) when the v-pixel is gazed. A given a-pixel is part |
| | of no more than one v-pixel at a given time interval but it may be part of |
| | different v-pixels at different instants. The human vision perceives the v- |
| | pixel as a single emitting region when its luminance is high enough and |
| | when it is located far enough from the eye. The location of the v-pixel does |
| | not coincide in general with the location of the two a-pixels forming it, but |
| | it should be as close to them as possible to minimize the vergence- |
| | accommodation conflict (VAC). |
| Viewable o-pixel | viewable object pixel is an object pixel for which at least one of its |
| | associated pencils intersects the eye pupil. |
| WA-design with | Optical design in which the pencil’s waists are grouped in n different (and |
| n planes | essentially parallel) waist planes and the a-pixels, and consequently the |
| | accommodation planes, are also coincident with those waist planes. The 2 |
| | a-pixels necessary for generating one v-pixel are selected among the ones |
| | located in the accommodation plane closest to the v-pixel. The greater the |
| | number of accommodation planes the smaller the vergence-accommodation |
| | conflict (VAC). |
| Waist | The waist of a set of straight lines, for instance a pencil, is the minimum |
| | area region of a plane intersecting all the straight lines such that when all |
| | those straight lines are rays carrying the same radiance, then the waist |
| | encloses all the points of that plane with irradiance greater than 50% of the |
| | maximum irradiance on that plane. This flat region is in general normal to |
| | the pencil’s central ray. |
| Waist plane or | In some optical systems the waists of some or all of the pencils can be |
| waist surface | grouped by its proximity to certain surfaces. These surfaces are called waist |
| | surfaces. Sometimes they are approximated by planes. These planes use to |
| | be normal to the frontward direction |

### 3. State of the Art

Head mounted display (HMD) technology is a rapidly developing area. An ideal head mounted display combines a high resolution, a large field of view, a low and well-distributed weight, and a structure with small dimensions.

The embodiments disclosed herein refer to lenslet array based optics. This type of optics have been used in HMD technologies in the frame of Light Field Displays (LFD) to provide a solution to the vergence-accommodation conflict (VAC) appearing in most present HMDs. As yet LFD may solve this conflict at the expense of having a low resolution. State of the art of a LFD of this type was described by Douglas Lanman, David Luebke, “Near-Eye Light Field Displays” ACM SIGGRAPH 2013 Emerging Technologies, July 2013, “Lanman 2013”, and the way this prior art LFDs work is described next in FIG. 1 and FIG. 2.

Following the nomenclature defined in [0008] (which will be further developed in the DETAILED DESCRIPTION below), FIG. 1 shows eye 101 with pupil 102 (not to scale) looking into the prior art microlens array 103, which faces a display 104 and images its o-pixels on to a waist plane 109. FIG. 1 illustrates the concept of eye accommodation provided by the microlens array 103 and display 104 being operated to produce a light field. By turning on pencils 106 (this is, all the rays of those pencils carry the same luminance and color) one may create the accommodation pixel 105 (or a-pixel for short). The eye may gaze said a-pixel 105 and will accommodate there, by focusing pencils 106 on the retina. Accordingly, by turning on pencils 107 one may create a-pixel 108. The eye may gaze said a-pixel and will accommodate there, by focusing pencils 107 on the retina. Notice that when a-pixel 108 is gazed, its image on the retina will be much smaller than the image of a-pixel 105 when it is gazed, because a-pixel 108 is formed by the intersection of pencils 107 at their waist, while a-pixel 105 is form by the intersection of pencils 106 far from their waist (which are also at the waist plane 109)

FIG. 2 shows the prior art system 200 in stereoscopic operation where eyes 201 and 202 with pupils 203 and 204 looking into microlens arrays 205 and 206 facing displays 207 and 208. Both microlens arrays form virtual images of the corresponding displays at waist plane 209. By turning on pencils 210 and 211 one can create 2 a-pixels intersecting at the vergence pixel 212 (or v-pixel, for short). The eyes may also accommodate at position 212 and therefore there will not be VAC. However, as in the case of a-pixel 105 in FIG. 1, the size of v-pixel 212 may be large as it results from the intersection of several pencils, whose waists are located at the waist plane 209. Accordingly, by turning on pencils 213 and 214 one can create v-pixel 215, which will also be larger than minimum because 215 is not located at the waist plane 209.

Therefore, LFD based on microlens arrays as “Lanman 2013” have a very limited resolution, as mentioned before, due to the distance between most a-pixels and the waist plane. Additionally, state of the art LFD use arrays in which all microlenses have rotational symmetric surfaces and are identical (except for translation) which makes the ones far from the center of the field of view perform very poorly in terms of image quality. Moreover, prior art designs are based on ideal lens raytracing, with rectilinear mapping following the tangent law, which further limits the achievable resolutions with respect to other possible mapping functions with distortion. The embodiments herein overcome this three aspects of that lead to the low resolution in prior art.

U.S. Pat. No. 10,432,920 by common invertors to this application discloses the use of pencils in a different way as the LFD just described, in which VAC exists, but the perceived resolution is higher. FIG. 3 illustrate that disclosure showing a stereoscopic system 300 where eyes 301 and 302 with pupils 303 and 304 looking into microlens arrays 305 and 306 facing displays 307 and 308. Both microlens arrays form virtual images of the corresponding displays' o-pixels at waist plane 309, which are made to coincide with an accommodation plane. By turning on pencils 310 and 311, light will appear to come from a v-pixel 314. This configuration is not resolving the VAC because the v-pixel is formed at 314 but eye 301 accommodates at 316 and eye 302 accommodates at 317. However, provided that the distance in diopters between the v-pixel 314 and 309 is not too large, each eye sees the virtual image at full resolution, the one displayed at 309. Similarly, by turning on pencils 312 and 313, light will appear to come from a v-pixel 315. Therefore, this prior art is not resolving the VAC because the v-pixel is formed at 315 but eye 301 accommodates at 318 and eye 302 accommodates at 319. This mismatch coincides with the one produced by present commercial VR headsets, as Oculus Go, Sony PS VR or HTC Vive. U.S. Pat. No. 10,432,920 introduces several other concepts related with the present invention, as the use of freeform optical surfaces in the lenslets and pixel interlacing. However, it differs from the present invention in multiple aspects, since it lacks making the lenslets being equi-focal, the use of an eye-tracker to dynamically adjust the cluster content, the use of unlit viewable object pixels surrounding the clusters, among other features, which make the present invention increase dramatically the attainable resolution of U.S. Pat. No. 10,432,920.

### SUMMARY

Designing a optic for virtual reality that is compact, produces a wide field of view and a high resolution virtual image is a challenging task. Refractive single channel optics are commonly used, but the difficulty in designing them arises from the fact that they must handle a significant etendue. In order to control all this light one needs a large number of degrees of freedom which typically means using many optical surfaces, making the resulting optic complex and bulky. One possible alternative is to use folding optics, such as the pancake design. However, these tend to have very low efficiencies, which is a significant drawback in devices meant to light and to run on batteries.

An alternative to these technologies is to use multiple channel optics. Now, each channel handles a much smaller etendue and is therefore easier do design, resulting in simpler, smaller and more efficient optical configurations. Multiple channel configurations, however, tend to have duplicated information on the display, which lowers the resolution that may be achieved.

This invention describes several strategies to overcome the limitations to multi-channel configurations, increasing resolution while reducing the size of the optics. Traditional multi-channel configurations (such a lens arrays combined with a display) create an eye box within which the eye may move and still be presented with a visible virtual image. These, however, are low focal, low resolution configurations. One option to increase resolution is to increase the focal length of the lenses in the array. This reduces the eye box size and leads to the need to use eye tracking. Also it increases the thickness of the device (due to the longer focal length). This strategy increases resolution at the cost of eye tracking and an increased device thickness. These configurations maintain duplicate information in the display, where the same information is shown through different channels in order to compose the virtual image.

One step further may be taken in which one eliminates the duplicate information in the display. As is disclosed herein this strategy permits an increased focal length, which in turn results in an increased resolution. However, a longer focal length also leads to a larger device which may be undesirable. In an alternative configuration, the lenses in the array may be split into families and the focal length reduced, reducing device size. Each family now generates a lower resolution virtual image, but said virtual images generated by the different families may be interlaced to recover a high resolution. These configurations combine the compactness of short focal devices with high image resolution.

Further improvements may be achieved by using polarization and/or time multiplexing. Also, the relative orientation of microlenses and their cluster may lead to some additional resolution improvements, as disclosed.

combine the compactness of short focal devices with high image resolution.

In an embodiment a display device is disclosed comprising a display, operable to generate a real image comprising a plurality of object pixels, and an optical system, comprising a plurality of lenslets, each lenslet having associated one cluster of object pixels. The assignation of object pixels to clusters may change periodically in time intervals, preferably a frame period. Each lenslet produces a ray pencil from each object pixel of its corresponding cluster, the pencils having corresponding waists laying close to a waist surface. Each lenslet projects its corresponding ray pencils towards an imaginary sphere at an eye position; the sphere being an approximation of the eyeball sphere and being in a fixed location relative to the user's skull. The ray pencils of each lenslet are configured to generate a partial virtual image from the real image of its corresponding cluster, and the partial virtual images of the lenslets combine to form a virtual image to be visualized through a pupil of an eye during use. At least two of the lenslets cannot be made to coincide by a simple translation rigid motion. The foveal rays are a subset of rays emanating from the lenslets during use that reach the eye and whose straight prolongation is away from the imaginary sphere center a distance smaller than a value between 2 and 4 mm. The corresponding foveal lenslets of a given field point are those intercepted by the foveal rays of that field point. The directional magnification function is a ratio of distance on the display surface over distance between field points. Wherein for any field point of a gazeable region of a field of view, values of a directional magnification function for the foveal lenslets corresponding to that field point differ less than 10%.

The present invention may include various other optional elements and features, such as:
a. The ray pencils may be activated to make the accommodation pixels lay close to a waist surface.
b. There may be more green color ray pencils than blue color ones.
c. At least one pencil may be represented as a non-connected set in the phase space.
d. The only ray pencils of each lenslet that intersect the imaginary sphere inside a static pupil range are associated to the object pixels of its corresponding cluster, and the static pupil range is the region of the imaginary sphere comprising the expected eye pupil positions.
e. The display device may include a display driver operative to assign and drive the object pixels of the lenslet clusters.
f. The display device may include a pupil tracker and a display driver operative to dynamically assign and drive the object pixels of the lenslet clusters.
g. The only ray pencils of each lenslet that intersect the imaginary sphere inside a dynamic pupil range are associated to the object pixels of its corresponding cluster; and wherein the dynamic pupil range is the region of the imaginary sphere comprising the expected eye pupil position provided by a pupil tracker.
h. The waists of the pencils of adjacent lensets may be interlaced at a waist surface.
i. The interlacing may be produced by rotation of a display relative to a lenslet array.
j. The directional magnification in the radial direction multiplied by the square of the cosine of the polar angle is a decreasing function of the polar angle; and wherein the polar angle of a field is the angle formed by that field with the skull's frontward direction.
k. The directional magnification in the radial direction may be a decreasing function of the polar angle.
l. There may be at least a conforming lens along the ray path from the display to the eye.
m. The conforming lens has at least one surface with slope discontinuities.
n. The display device may include two or more displays per eye.
o. For every direction angle, the directional magnification of at least one lenslet is maximum at its centered gazing field; and wherein said centered gazing field being associated to a ray trajectory passing through a lenslet exit aperture center and whose straight prolongation passes through the center of the imaginary sphere.
p. For every direction angle, the image quality of at least one lenslet is maximum at its centered gazing field.
q. There may be at least two waist surfaces, one closer to the eye during use than the other. The he waist surfaces may be approximated by planes normal to the skull's frontward direction spaced by a distance between 2 and 5 diopters.
r. At least two pencils with waists at different waist surfaces may be fed by light with orthogonal polarizations.

It is also contemplated that the display device further comprises a second display device, a mount to position the first and second display devices relative to one another such that their respective lenslets project the light towards two eyes of a human being, and a display driver operative to cause the display devices to display objects such that the two virtual images from the two display devices combine to form a single image when viewed by a human observer.

Furthermore in any of the embodiments, it is also contemplated that:
a. The pencils may be activated so every vergence pixel has their two corresponding accommodation pixels laying on the waist surface closest to said vergence pixel.
b. The clusters may be surrounded by unlit viewable object pixels; and wherein a viewable object pixel is an object pixel which illuminates at least one associated pencil that intersects the eye pupil.
c. The unlit viewable object pixels may be more than 25% of the total of viewable object pixels.
d. The unlit viewable object pixels may be more than 50% of the total of viewable object pixels.
e. At least 80% of the waists of pencils may contain foveal rays and that may be associated to objects pixels belonging to clusters do not overlap angularly from a center of the eye pupil.
f. The display driver may drive more power to the viewable object pixels whose corresponding pencils enter partially the eye pupil to compensate for flux lost by vignetting.
g. The display device of may include a mask to block the undesired light from the lenslet exit apertures.
h. The display device may include one or more actuators to shift components lenslet array relative to display to produce interlacing, waist-surface modification or eye prescription correction.
i. The light carried by pencils associated to object pixels of adjacent clusters may have orthogonal polarizations.

The foregoing and other features of the invention and advantages of the present invention will become more apparent in light of the following detailed description of the preferred embodiments, as illustrated in the accompanying figures. As will be realized, the invention is capable of modifications in various respects, all without departing from the invention. Accordingly, the drawings and the description are to be regarded as illustrative in nature, and not as restrictive.

### BRIEF DESCRIPTION OF DRAWINGS

The above and other aspects, features and advantages of the present invention will be apparent from the following more particular description thereof, presented in conjunction with the following drawings wherein:

FIG. 1 shows different configurations of pencils forming accommodation pixels.

FIG. 2 shows configurations of pencils forming vergence pixels and solving the vergence-accommodation mismatch at the expense of decreased resolution.

FIG. 3 shows configurations of pencils forming vergence pixels with high resolution but not solving the vergence-accommodation mismatch.

FIG. 4 shows a pencil of rays 404 that may be represented as one single central ray 405.

FIG. 5 shows the eye capturing part of a pencil.

FIG. 6 shows a microlens array facing a display. The pencils derived from this configuration intersect at accommodation pixels in space.

FIG. 7 shows an embodiment that generates several planes with 3D pixels at variable resolution and corresponding variable interlacing.

FIG. 8 shows a display with red (R), blue (B), white (W) and green (G) sub-pixels. Each pixel is a RBWG set of sub-pixels.

FIG. 9 shows an embodiment of the prior art in which different lenses of a lens array form accommodation pixels at the waist surface of the pencils.

FIG. 10 shows an embodiment in which different lenses in a lens array generate interlaced images at the waist surface increasing the perceived resolution.

FIG. 11 shows the same embodiment in FIG. 10 with a different set of sub-pixels turned on.

FIG. 12 shows a similar embodiment to that shown in FIG. 10 but now with several lenses in a lens array.

FIG. 13 shows an embodiment where the aperture of each lens is split into different channels.

FIG. 14 shows a display with a RGB delta configuration.

FIG. 15 shows a lens array with different families of microlenses: A, B, C.

FIG. 16 interlacing with factor 2 for square-like lenslets matrix configuration to a display with a classical pentile configuration results in a resolution half of what it could be.

FIG. 17 shows a pentile RGBG configuration.

FIG. 18, FIG. 19, FIG. 20 show different o-pixel configurations corresponding to one cluster of the 4 families of lenslets.

FIG. 21 a-pixel distribution in the virtual image for the Green a-pixels.

FIG. 22 a-pixel distribution in the virtual image for the Red a-pixels.

FIG. 23, FIG. 24, FIG. 25, FIG. 26 show another o-pixel configuration for RGBW displays and square-type lenslet arrays.

FIG. 27 fully packed a-pixel distributions for all colors.

FIG. 28 shows a microlens forming a pencil with waist on the waist plane.

FIG. 29 shows how a rotating microlens displaces pencil's waist along the waist plane.

FIG. 30 shows several microlenses whose pencil's waists overlap in a 3D pixel.

FIG. 31 shows how a rotating microlens array breaks a 3D pixel into spreading pencil's waists.

FIG. 32 shows how a rotating microlens array about a far axis breaks a 3D pixel into spreading and moving pencil's waists.

FIG. 33 shows how a rotation of a microlens array may be decomposed as a rotation in place and a displacement.

FIG. 34 shows an embodiment of the prior art where a microlens array forms a series of accommodation pixels on a waist plane. Said a-pixels (say, formed by red sub-pixels) do not fully fill the waist plane.

FIG. 35 shows how a rotation of the lens array breaks the a-pixels fully filling the waist plane and increasing the perceived resolution.

FIG. 36 shows an embodiment similar to that in FIG. 30 but with a higher number of microlenses that fit into the eye pupil

FIG. 37 shows a triple (linear) resolution increase by sub-pixel interlacing.

FIG. 38 shows a conforming lens with separate channels.

FIG. 39 shows a converging/diverging lens coupled with a microlens array.

FIG. 40 shows an optic (lenslet) of a microlens array to be used without eye tracking. The eye pupil may move inside a prescribed pupil range.

FIG. 41 shows an optic (lenslet) of a microlens array to be used with eye tracking. The cluster on the display must move (via software) to follow the eye pupil in its movement.

FIG. 42 shows the RMS spot size 4201 of exemplary optic shown in FIG. 41 as a function of angle to the optical axis.

FIG. 43 shows the accommodation pixels plane and the a-pixel centers for differente families.

FIG. 44 shows the cross maximum movement range for the eye pupil for lenses with different focal lengths.

FIG. 45 shows some pencils and their diagrammatic representation as only two rays to reduce figure complexity.

FIG. 46 shows an optical system comprising a lens array facing a display. Said system has a wide pupil range.

FIG. 47 illustrates how increasing the focal length (and system resolution) decreases the pupil range.

FIG. 48 illustrates how a system with a small pupil range needs eye tracking to operate.

FIG. 49 illustrates how turning off display pixels with repeated information reduces the cross-talk restrictions increasing the pupil range.

FIG. 50 shows how the device in FIG. 49 can increase focal length and resolution taking by reducing the pupil range.

FIG. 51 shows the same configuration in FIG. 50 but now showing the edge pencils of one lens in the array and how they cross the eye pupil.

FIG. 52 shows a configuration similar to that in FIG. 50 illustrating eye tracking that is needs to operate.

FIG. 53 shows the same situation as FIG. 51 but for a different pupil position that occurs during eye tracking.

FIG. 54 shows how the focal length of a configuration similar to that in FIG. 50 may be increased when using polarization.

FIG. 55 shows a lens array split into two families of microlenses, each family creating essentially the whole virtual image.

FIG. 56 shows the cross-talk conditions of the configuration in FIG. 55.

FIG. 57 compares the configurations in FIG. 50 and FIG. 55.

FIG. 58 shows similar configurations to those in FIG. 57 but now in the particular case in which the virtual images are at an infinite distance.

FIG. 59 shows the cross-talk conditions of the configuration shown in FIG. 58 for the different families of mirolenses in the array.

FIG. 60 shows four sets of edge rays for a microlens: those coming from the edges of its cluster (lit area) and adjacent dark areas (cross-talk conditions).

FIG. 61 shows representative rays of different microlenses showing how the virtual images generated by each microlens join to form a single continuous virtual image.

FIG. 62 shows how different edge rays of adjacent microlenses of different families relate to each other.

FIG. 63 shows a diagram with the mappings of adjacent microlenses of different families. Said diagram also contains points representing the edge rays in FIG. 62.

FIG. 64 shows different configurations of the embodiment in FIG. 62 that occur when the eye pupil moves and the system performs eye tracking.

FIG. 65 shows the same diagram as in FIG. 63 but now for different pupil positions.

FIG. 66 illustrates how the knowledge of the mappings of two lenses in the array places restrictions on the mapping of the next lens in the array

FIG. 67 shows different configurations of edge rays (as shown in FIG. 62). Some variations are acceptable while others are not.

FIG. 68 illustrates how part of a beam print may fall outside the eye pupil. In such a case the power of said beam needs adjustment via software.

FIG. 69 shows a configuration similar to that in FIG. 68, but now in three-dimensional geometry.

FIG. 70 shows display 7002 paired with microlens array 7001 which is moved by actuators.

FIG. 71 shows a configuration that allows see-trough.

FIG. 72 shows a display and the clusters of four different families of microlenses.

FIG. 73 shows a diagram similar to that in FIG. 72 but for a different eye position. The clusters perform eye tracking via software to follow the eye pupil movement.

FIG. 74 shows a matrix of diagrams. Each diagram corresponds to a different microlens in the lens array. Each diagram shows how the pencils from the edges of the cluster may fall partially outside the eye pupil, in which case the brightness of said pixels needs adjustment via software.

FIG. 75 shows a cross section of the conforming lens for the calculations of the conforming lens mapping functions.

FIG. 76 shows a 2-surfaces lens designed with an Simultaneous Multiple Surface (SMS) technique.

FIG. 77 shows some design examples done with the SMS method.

FIG. 78 shows the conforming lens mapping in the p, y plane.

FIG. 79 shows the trajectories of edge rays from a cluster of the digital display, passing through the first and second microlenses of the corresponding lenslet and through the conforming lens towards the eye.

FIG. 80 illustrates the maximum size of the eye pupil free of cross-talk illumination.

FIG. 81 case in which the mapping functions are equi-spaced straight lines.

FIG. 82 shows raytracing of edges rays through the edges of the pupil and one lenslet.

FIG. 83 shows raytracing through the center of one lenslet and also center and edge of the pupil range.

FIG. 84 shows the physical display to they left and the surface or virtual screen to the right.

FIG. 85 shows VR pixel resolution as a function of the angle to the optical axis.

FIG. 86 shows diagonal cross section of and exemplary design.

FIG. 87 shows a double-sided minilens array.

FIG. 88, FIG. 89 show the modulation as a function of spatial frequency for different lenslets.

FIG. 90 shows, as an example, the values of the radial focal length as a function of the polar angle.

FIG. 91 shows, as an example, the analysis of a diagonal lens of a design.

FIG. 92 shows a generic microlens array with a mask.

FIG. 93 a mask to limit the aperture of a freeform surface close to the eye.

FIG. 94 shows a multi-focal optical system generating vergence pixels formed by accommodation pixels which may accommodate at 2 different accommodation planes thus allowing for the reduction of the vergence-accommodation mismatch.

FIG. 95 shows an optical system generating vergence pixels formed by a-pixels coincident with the v-pixels thus eliminating the vergence-accommodation mismatch.

FIG. 96 shows at the top a component of a lens array and at the bottom a similar component, but with an additional birefringent material block between optic and display, which may be used to shift the waist plane position via change in light polarization. This optical system generates pencils with different waist plane depending on its light polarization state or a multifocal pencil if we don't consider polarization.

FIG. 97 shows a lenslet (a component of a lens array) with different birefringent blocks between optic and display which, when used in combination with liquid crystal panels and polarized light may be used to shift the waist plane to different positions, creating multifocal pencils with selectable waist planes.

FIG. 98 shows elements of a display device with interlacing factor 2 and underfilling strategy.

FIG. 99 shows an alternative embodiment with underfilling strategy, for lenslets 9801 but with interlacing factor.

FIG. 100 shows an embodiment with underfilling strategy, an interlacing factor 8^{1/2}, and with 8 families of lenslets.

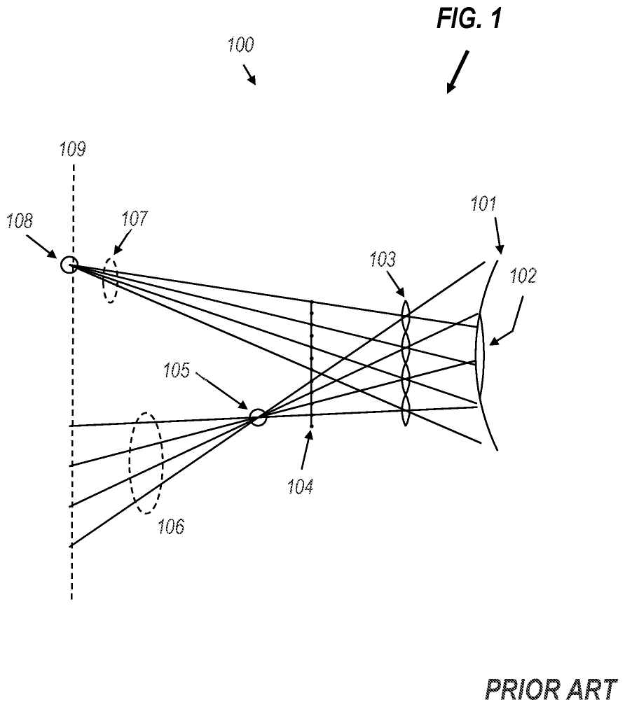

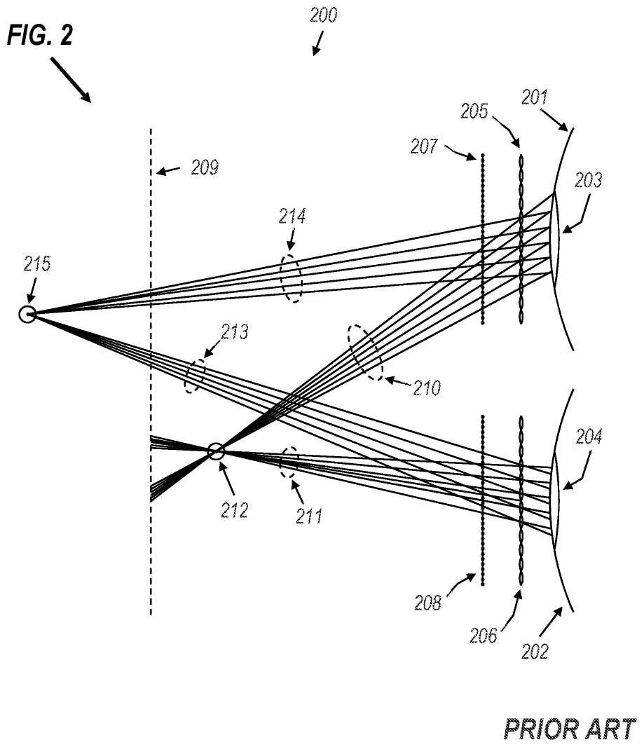

### DETAILED DESCRIPTION

A better understanding of the features and advantages of the present invention will be obtained by reference to the following detailed description of the invention and accompanying drawings, which set forth illustrative embodiments in which the principles of the invention are utilized.

The embodiments in the present invention consist on an display device comprising one or more displays per eye, operable to generate a real image comprising a plurality of object pixels (or opixels for short); and an optical system, comprising a plurality of lenslets, each one having associated at a given instant a cluster of object pixels. Each lenslet produces a ray pencil from an object pixel of its corresponding cluster. We shall call ray pencil (or just pencil) to the set of straight lines that contain segments coincident with ray trajectories illuminating the eye, such that these rays carry the same information at any instant. The same information means the same (or similar) luminance, color and any other variable that modulates the light and can be detected by the human eye. In general, the color of the rays of the pencil is constant with time while the luminance changes with time. This luminance and color are a property of the pencil. The pencil must intersect the pupil range to be viewable at some of the allowable positions of the pupil. When the light of a pencil is the only one entering the eye's pupil, the eye accommodates at a point near the location of the pencil's waist if it is being gazed and if the waist is far enough from the eye. The rays of a pencil are represented, in general, by a simply connected region of the phase space. The set of straight lines forming the pencil usually has a small angular dispersion and a small spatial dispersion at its waist. A straight line determined by a point of the central region of the pencil's phase space representation at the waist is usually chosen as representative of the pencil. This straight line is called central ray of the pencil. The waist of a pencil may be substantially smaller than 1 mm² and its maximum angular divergence may be below ±10 mrad, a combination which may be close to the diffraction limit. The pencils intercept the eye sphere inside the pupil range in a well-designed system. The light of a single o-pixel lights up several pencils of different lenslets, in general, but only one or none of these pencils may reach the eye's retina, otherwise there is undesirable cross-talk between lenslets. The o-pixel to lenslet cluster assignation may be dynamic because it may depend on the eye pupil position.

The waist of a pencil is the minimum RMS region of a plane intersecting all the rays of the pencil. This flat region is in general normal to the pencil's central ray. In some embodiments the waists of some or all of the pencils can be grouped by its proximity to certain surfaces. These surfaces are called waist surfaces. Sometimes planes can approximate these surfaces. These planes are preferably normal to the frontward direction.

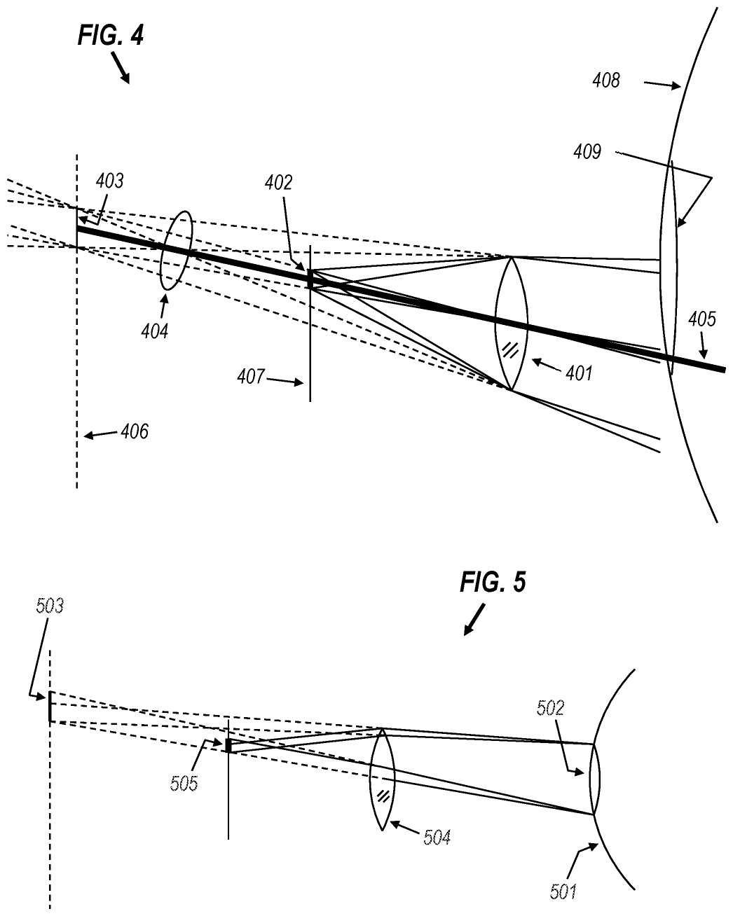

FIG. 4 shows a refractive lens 401 that creates a virtual image (waist plane) 406 of an object plane (oplane) 407. In particular, lens 401 and opixel 402 creates a pencil 404 with waist 403. Said pencil is diagrammatically represented by its central ray of the pencil 405 through the centers of elements 403 and 401. As mentioned before, surface 106 may not be a plane but curved if, for instance, lens 401 is designed with field curvature.

Optic 401 is part of a lenslet array. Each element of said array may be a combination of deflective surfaces, so the drawing 401 is only illustrative of a lens with a positive optical power. Examples may include trains of lenses or “pancake” optical configurations described by La Russa U.S. Pat. No. 3,443,858. In particular, the train may include two or three lenses of equal or different materials, at least one with positive power and at least another with negative power, combination providing chromatic aberration correction and/or other geometrical aberration corrections, as field curvature. Alternatively, two materials can be used, one with higher dispersion than the other. Lens surfaces may therefore be convex or concave, or even how inflection points so they are peanut type in form.

Also shown in FIG. 4 is the eye 408 and its pupil 409. As the eye rotates (i.e., the observer gazes to different directions), the eye pupil may intersect different portions of pencil 404 which will result in a perceived variation in the brightness of its waist 403. This effect may be reduced if another pencil with similar information and similar waist enters the eye pupil to compensate said brightness variation. When performing eye tracking, the position and size of the eye pupil relative to the pencil is known and the pencil brightness may be adjusted (via software), increasing the brightness as a higher portion of the pencil does not enter the eye pupil (so the pencil is vignetted).

FIG. 5 shows eye 501 with pupil 502 capturing part of a pencil defined by waist 503 and lens 504. This light comes from opixel 505.

The light of the ray pencils are projected towards an eye position and the pencils of each lenslet are configured to generate a partial virtual image from the real image on its corresponding cluster. The partial virtual images are viewable by a normal human eye located at the eye position. The partial virtual images of different lenslets combine to form a virtual image to be visualized by the eye. This combination may include, not exclusively, overlapping, tessellation and interlacing between partial images.

We will refer to accommodation pixel (or a-pixel) to the small region in the image space where a single human eye accommodates when it gazes that region, at a sufficient distance. In this situation the eye's foveal region is illuminated (completely or partially) by a set of pencils carrying the same information (same luminance and color). This set of pencils, which may consist of one or more pencils, is said to form the a-pixel. That luminance and color become a property of the a-pixel at a given instant. The pencils are such that their principal rays meet near the a-pixel, which is also close or coincident with the location of the waist of the union of those pencils. Nevertheless, this waist is not necessarily close to the individual waists of the different pencils forming the a-pixel. A given pencil is part of no more than one a-pixel during a given time interval (which is typically a frame period) but it may be part of different a-pixels at different time intervals. If a set of pencils is forming always the same a-pixel, the a-pixel is said to be static. In this case, all the pencils of the a-pixel carry always the same luminance and color. Otherwise, the a-pixel is said to be dynamic. The eye perceives the a-pixel as an emitting region when its luminance is high enough and it is located at sufficient distance from the eye. In some embodiments, accommodation pixels can be grouped by its proximity to certain surfaces. These surfaces are named accommodation surfaces (or a-surfaces). Sometimes they are approximated by spheres or even by planes, taken the names accommodation sphere or accommodation plane.

1. Interlacing

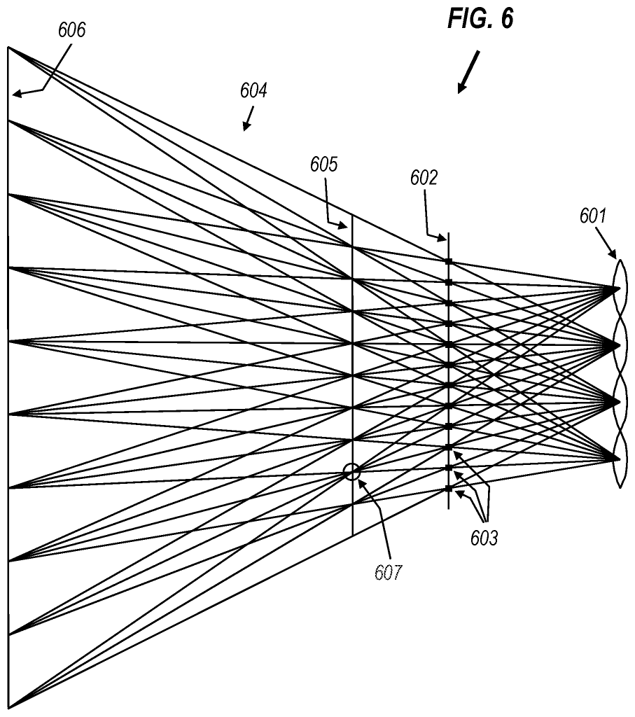

FIG. 6 shows an illustrative example with a set of lenslets 601 facing a display 602 containing equi-spaced o-pixels 603. Many pencils (potentially as many as number of opixels times number of lenslets or channels) are then generated, diagrammatically represented with its central rays 604. These pencils intersect at different planes like 605 or 606 so those are candidate accommodation planes with a-pixels as 607. In this simplified example pencil central ray trajectories pass by their corresponding o-pixels 603, which does not happen in general in this invention.

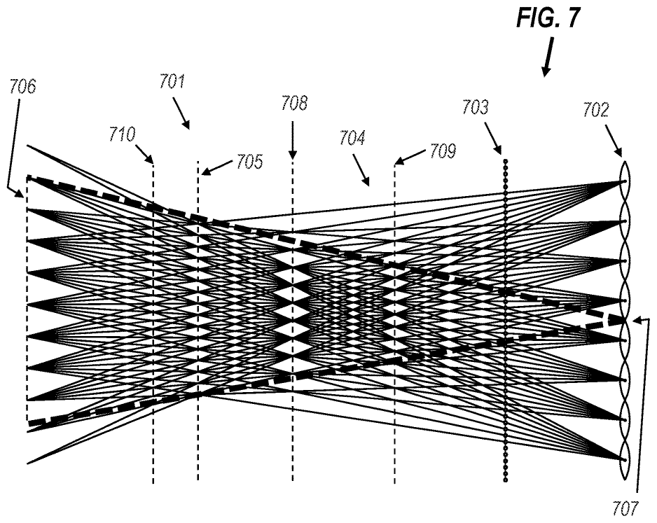

FIG. 7 shows a more detailed look to the pencil intersection of FIG. 6. FIG. 7 shows embodiment 701 containing microlens array 702, o-pixel plane (also called o-plane) 703 and many pencils shown as straight lines 704. There are several planes such 706, 710, 705, 708 and 709 where groups of pencils intersect, and so they are potentially accommodation surfaces. Let us define a-pixel density of a small portion of an accommodation surface as the number of a-pixels in that surface per steroradian measured from, for instance, point 707. The surface portion should be small enough for the density to be a local property but big enough to include several a-pixels. The square root of such a density is the resolution of that portion of the virtual image when that accommodation plane is used, and it is usually expressed in pixels per degree instead of pixel per radian. Planes as 706, 708 and 709 are the ones with minimum a-pixel density, because each one of the a-pixels is illuminated by pencils from all lenslets of array 702. Plane 705 has four times the density of a-pixels (that is, twice the resolution) when compared to plane 706. Since the number of pencils crossing both planes is the same, the a-pixels in plane 705 are just being illuminated by pencils from a quarter of the lenslets of array 702 (shown as half in this cross section). We will say that plane 705 has an interlacing factor of 2. There are other planes in FIG. 7 with interlacing factor 2, and there are also other planes as 710 with even higher interlacing factors.

Lenslets in square-like matrix configuration would use preferably square o-pixels. For instance. RGBW-square OLED microdisplays with high aperture ratio have, for each color, a fill factor up to 25%, i.e., 25% of the display area may emit a given color. Therefore a lenslet array with interlacing factor k=2 may be conveniently designed to make that the fill factor in the virtual image for each color is 100%. The resulting full-color a-pixels in the virtual image will have the four RGBW colors overlapped.

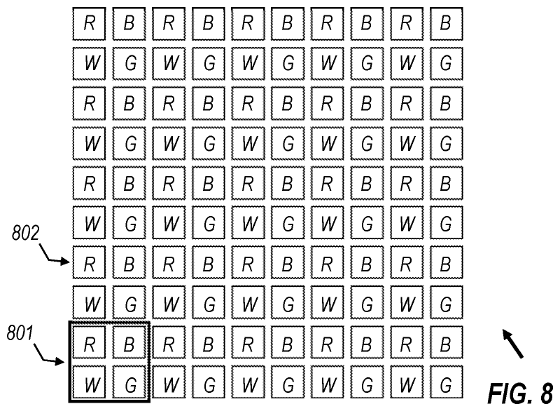

FIG. 8 shows a display with red (R), blue (B), white (W) and green (G) o-pixels. Each full color pixel such as 801 is a RBWG set of o-pixels.

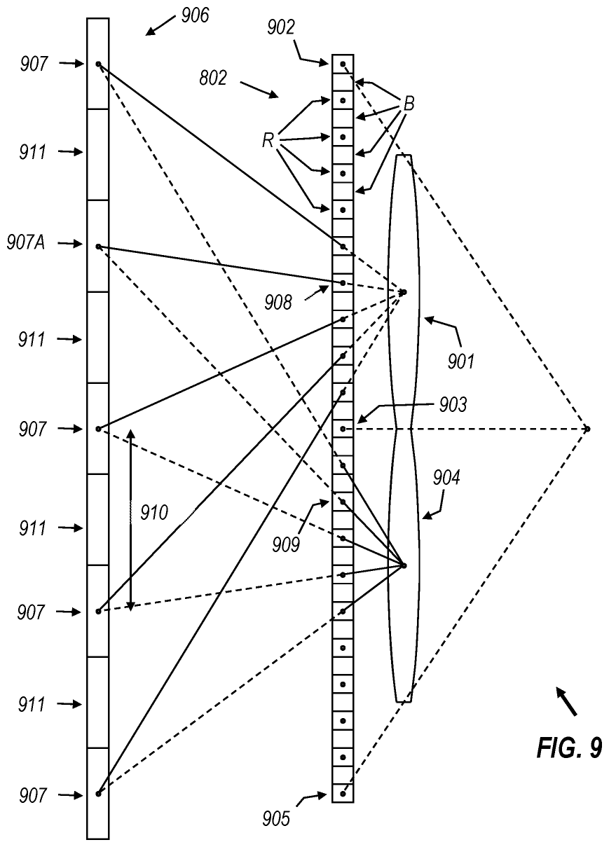

FIG. 9 shows, not to scale, another embodiment. It is a cross-section of a lens array coupled to a display similar to that shown in FIG. 8. Said cross section is taken through one line (or column) such as 802 of the display in FIG. 8. Lens 901 is associated with a part of the display (its cluster) schematically extending from 902 to 903. Lens 904 is associated with a part of the display (its cluster) schematically extending from 903 to 905. Section 802 of the display has o-pixels of alternate colors, say red (R) and blue (B). Assume that the red (R) o-pixels are on and the blue (B) o-pixels are off. Lenses 901 and 904 form overlapping virtual images 906. As an example, a-pixel 907A is the superposition of the virtual image of o-pixel 908 through lens 901 and o-pixel 909 through lens 904. The display driver can make o-pixels 908 and 909 have the same information (same luminance and color), that of a-pixel 907A. The red virtual image formed by red o-pixels 907 has its corresponding a-pixels spaced by 910. Each o-pixel together with its corresponding lens define a pencil whose waist is preferably at the a-pixel location.

If the red (R) o-pixels are off and the blue (B) o-pixels are on, a blue virtual image is formed by blue o-pixels 911 that has its corresponding a-pixels spaced by 910. A pixel, formed by one blue and one red o-pixels has a size 910 defining the resolution of the system.

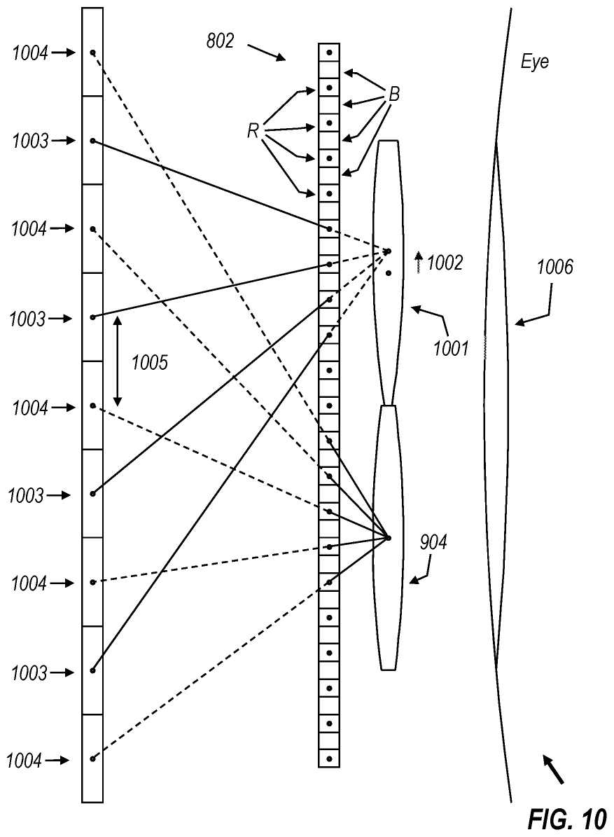

FIG. 10 shows, not to scale, the cross section of another embodiment based on the embodiment shown in FIG. 9. Again let's assume that only the red (R) o-pixels are on and the blue (B) o-pixels are off. Lens 904 is the same as in FIG. 9 and forms the same virtual image. However, lens 901 is now displaced by a small amount 1002 resulting in lens 1001. By displacing lens 1001, its virtual image is also displaced. In particular, a displacement 1002 may be selected such that the a-pixels 1003 formed by lens 1001 are interleaved between a-pixels 1004 formed by lens 904. This results in a virtual image whose red a-pixels are spaced by 1005, half the spacing 910 in the embodiment of FIG. 9, doubling the resolution. This may also be interpreted as going back to FIG. 9 and moving lens 901 so that its red a-pixels 907 move “on top” of blue a-pixels 911.

Accommodation pixels 1004 are visible through lens 904 and accommodation pixels 1003 are visible through lens 1001. The eye pupil 1006 must be large enough to capture light from both lenses 1001 and 904 so both images are overlapped on the retina.

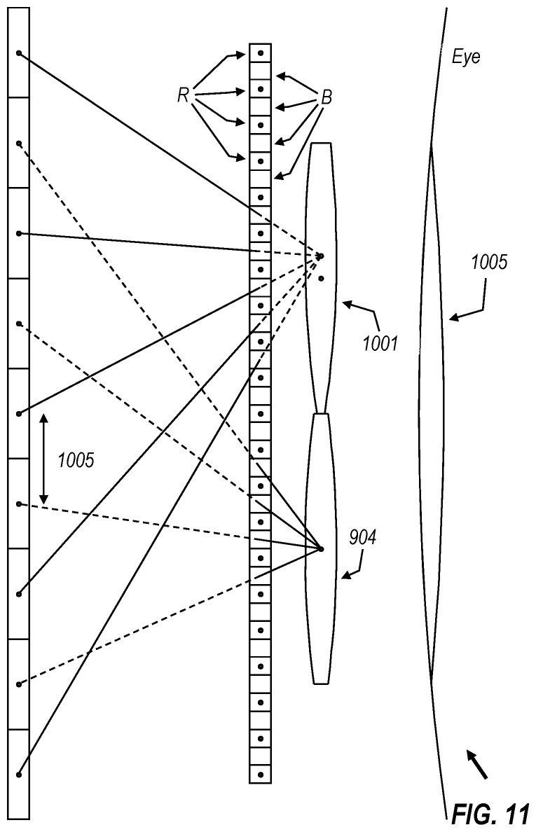

FIG. 11 shows the same embodiment in FIG. 10, but now the red (R) o-pixels are off and the blue (B) o-pixels are on. Now a blue virtual image is formed whose a-pixels are spaced by 1005.

When both red (R) and blue (B) o-pixels are on, the red and blue images overlap. The result is an image with double the resolution along the direction of the cross section shown in FIG. 9.

When taken to three-dimensional geometry, displacement 1002 of the lenses is done in the horizontal direction and then in the vertical direction of FIG. 8. This results in an image with double the resolution in the two dimensions of the display, that is, four times the number of pixel than that of the prior art. The eye pupil now captures light from four lenses, each producing an image displaced in the horizontal or vertical direction. Take, for example, the red o-pixels of FIG. 8. Assume the eye pupil is big enough to capture light from four adjacent lenses A, B, C, D forming a square. Lens A is kept in place. Its red o-pixels are seen in the positions shown in FIG. 8. Lens B is displaced so that its blue o-pixels are seen as overlapping the positions of the red o-pixels of lens A. Lens C is displaced so that its white o-pixels now overlap the positions of the red a-pixels in lens A. Lens D is displaced so that its green o-pixels now overlap the positions of the red o-pixels of lens A. This set of lenses A, B, C, D repeats in a pattern forming four families of lenses: family A, family B, family C and family D, and four color images are seen overlapped with resolution four times the original one when the pupil is big enough to capture simultaneously light from the 4 families of lenses.

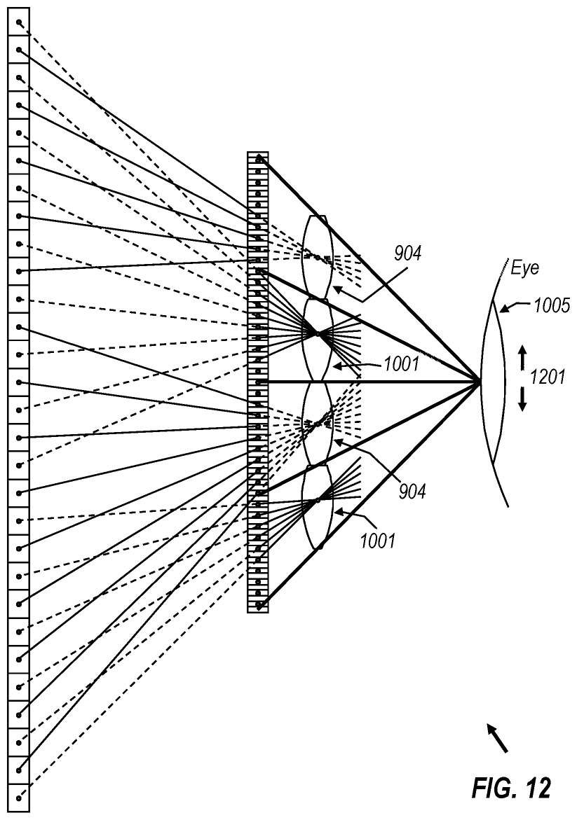

FIG. 12 shows a similar embodiment to that shown in FIG. 10 (when the red (R) o-pixels are on and the blue (B) o-pixels are off) but considering more lenses. FIG. 12 shows a lens array which repeats the pattern of one lens like 1001 plus one lens like 904. As the eye pupil 1005 rotates around its center, it moves across the lens array (as indicated by arrows 1201), the light from some lenses enters the pupil coming into view while the light from other lenses leaves the pupil falling out of view. This entering and leaving into view of lenses generates oscillations in the brightness of the perceived image that we call “scintillations”.

Referring back to FIG. 10, let us consider the situation in which the eye rotates around its center and so the pupil 1006 moves upwards across the lens array and over lens 1001. The light emitted by lens 1001 is still visible but part of the light emitted by lens 904 starts to falls outside the pupil. This results in a-pixels 1003 being visible while some of a-pixels 1004 become invisible. This may generate the scintillations in the a-pixels of the perceived image.

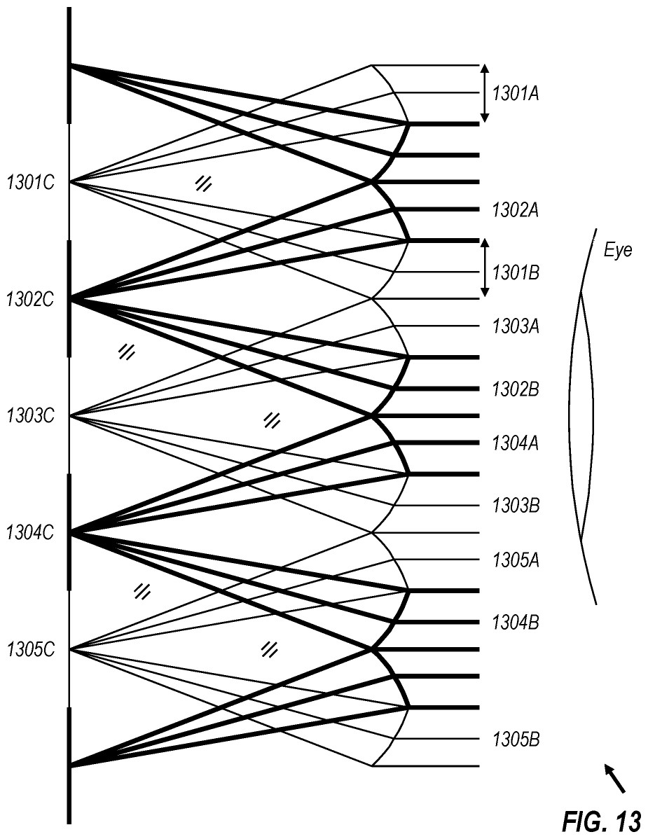

FIG. 13 shows an embodiment with reduced scintillation. Lens 1301 is split into two channels 1301A and 1301B that share the same cluster 1301C. Similarly, Lens 1302 is split into two channels 1302A and 1302B that share the same cluster 1302C. Other lenses are split similarly. Now as the eye pupil moves, for instance downwards, if part of the lens (say 1303A) leaves the pupil, the other part of the lens (1303B) remains, reducing scintillation.

Lens 1301 has a combined aperture of size 1301A+1301B. In this case, the phase space representation of the pencils through this combined aperture may be non simply connected from the topology point of view. These apertures may be made coherent. All we need for this purpose is that the apertures be parts of single continuous original lens imaging the same cluster. Then, the diffraction limit of the lens is determined by the combined aperture, and since the combined aperture has a larger area than any of its parts, the diffraction limit is less restrictive than the situation in which the different parts were emitting incoherently. Of course, the combined aperture determines the diffraction limit of the lens only when the light of both apertures pass through the pupil. Otherwise, the pupil vignetting will introduce an additional effect.

Diffraction imposes a limit on the smallest aperture of the lenslets generating a pencil. Let's D be the diameter of the lenslet aperture and let (θ_{R})⁻¹ the resolution (in pixels per degree) of the image of the cluster imaged by that lenslet. Following Rayleigh Criterion, the pencil's waists of that image will be resolvable if D>1.22λ/sin(2θ_{R}), where λ is the wavelength of the light. For λ=550 nm and (θ_{R})⁻¹=52 ppd, then D must be greater than 1 mm to be resolvable according to that criterion.

On the other side, a small lenslet aperture is required to have several pencils sending light to the eye's pupil with directions imaged in the fovea, and so to be able to overlap on the retina images from different lenslets. Additionally, we need several lenslets providing the same a-pixels on the fovea to minimize “scintilliation”. We may consider that a standard condition for the human pupil is such that its diameter is at least 4 mm. Then it is evident that there is a trade-off for the lenslet diameter: on one side we need an aperture big enough to diminish the diffraction effects and on the other side we need small lenslet apertures to be able to send to the fovea images from different lenslets through the human pupil. The strategy shown in FIG. 13 can be used to overcome this trade-off if the combined aperture of the same cluster is made of coherent parts. In this strategy the lenslet apertures are split in different coherent parts which are interleaved with the parts of other lenslets to diminish scintillation.

Display Pixel Configurations, Array Geometries and Interlacing Factor

The previous section has disclosed in detail the interlacing design for an RGBW-square o-pixel display with interlacing factor 2, so lenslets are grouped in 4 families. Notice that since the blue o-pixel resolution can be lowered without affecting the resolution perceived by the user, and its current density it is preferred to be lower than for the other colors to increase its lifetime, an alternative embodiment would consist in eliminating the white o-pixel to allow the blue o-pixel occupy its area, which is normally referred to as RGB-π pixel display design.

Consider the case of an RGBW-square o-pixel display with lower fill factor, for instance such that the o-pixel side is ⅓ of the full-color pixel side. This display fits perfectly with a square-type lenslet array design with interlace factor 3, so lenslets are grouped in 9 families. This interlace factor could also be applied to the RGBW case with o-pixel side ½ of the full-color pixel side, but there will be some overlapping on the virtual image of o-pixels.

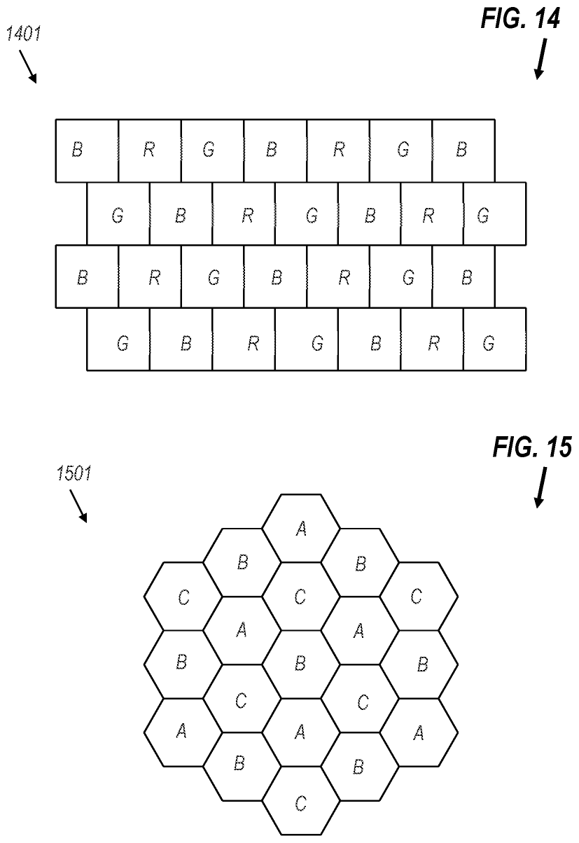

FIG. 14 shows a display 1401 with a RGB delta configuration in which the red (R), green (G) and blue (B) o-pixels are arranged in successive triangular configurations. This display design fits with using hexagonal-type lenslet array with interlacing factor 3^{1/2}, so the lenslets in the array are grouped in 3 families. FIG. 15 shows a lens array 1501 with different families of lenslets: A, B, C. Said array may be used in combination with a display configuration as shown in FIG. 14 resulting in an interlaced configuration with increased resolution. Smaller o-pixel fill factors in delta configuration invite to increase the interlacing factor, for instance, to 7^{1/2}, so the lenslets in the array are grouped in 7 families.

In the eventuality that o-pixels are rectangular with high aspect ratio, as occurs in RGB stripe pixel designs, interlacing only in the direction perpendicular to the stripes may be done, preferably with a higher directional magnification in the perpendicular direction. If in this case orthogonal directions result with different virtual image resolutions, the headset can be configured so left eye has a high resolution direction set vertical while right eye has the high resolution horizontal, for the user to approximately perceive high resolutions both horizontal The application of subpixel rendering may also be applied, in particular with RGBGRGB-type designs.

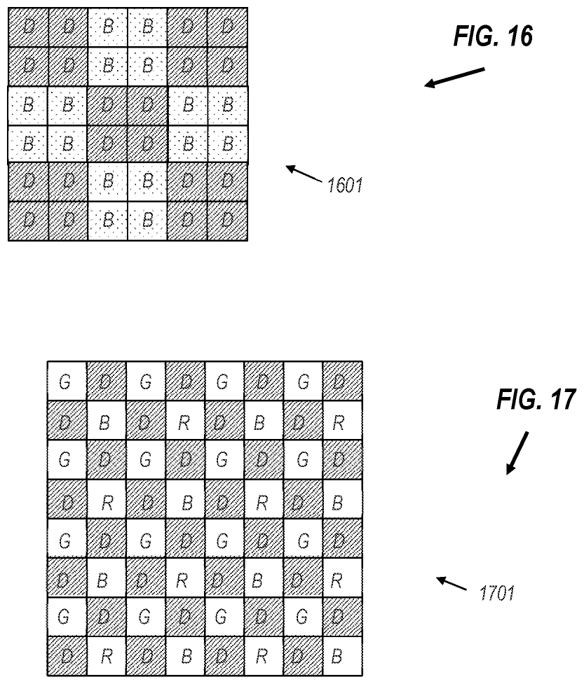

Further resolution increase can be achieved if the number of green o-pixel of the display is larger than the red and blue ones. In direct-view displays, this is used in the so-called pentile RGBG configurations, as the one shown in FIG. 17, which use the fact the human eye resolution is lower for the blue color (although it lowers the red resolution too), and it is most sensitive to green, especially for high-resolution luminance information. D means that this location is dark. When we apply interlacing with factor 2 for square-like lenslets matrix configuration to a display with that classical pentile configuration, it does not work properly for red and blue colors. FIG. 16 shows 1601, the distribution of Blue (B) and Red (R) a-pixels in the virtual image, which appear clustered in groups of 4 and with 4 dark (D) spaces in between, so its resolution is half of what could be.

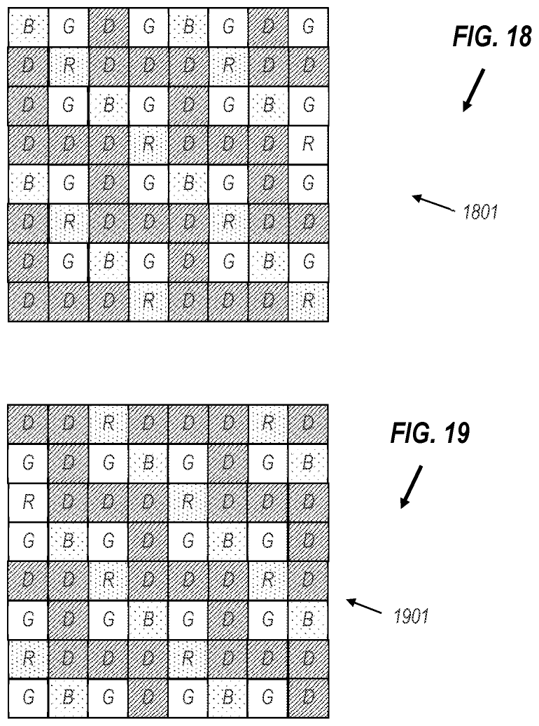

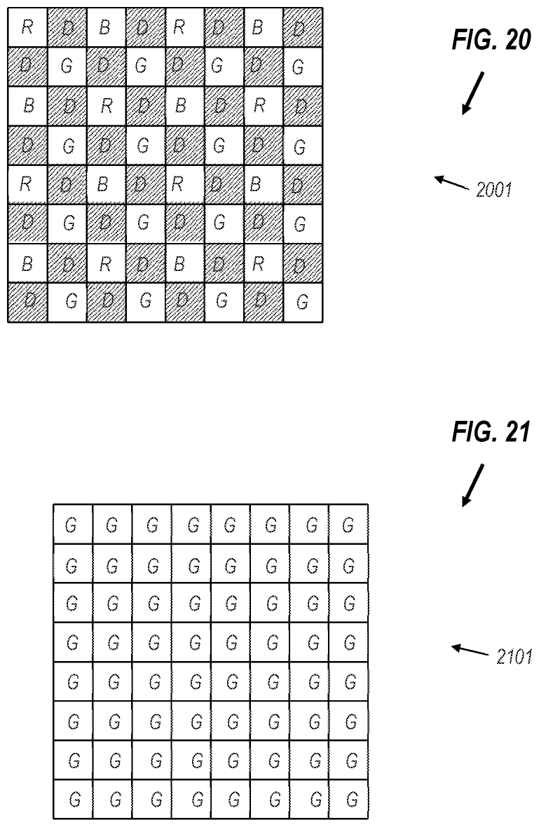

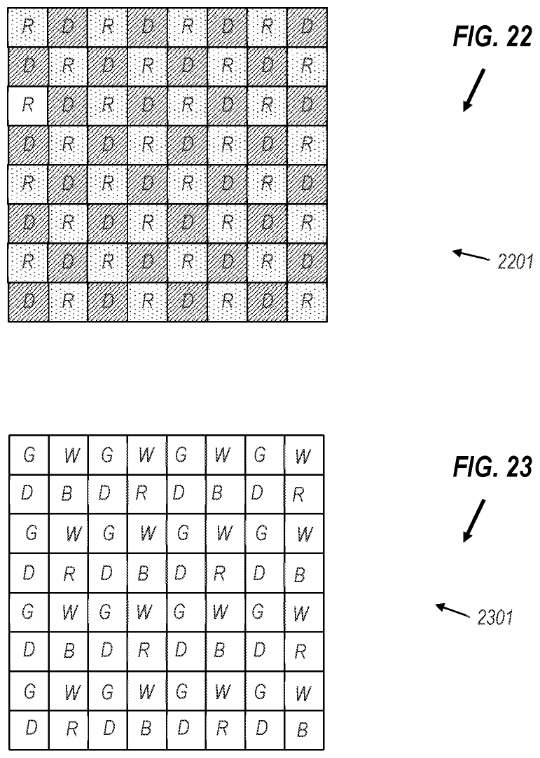

The o-pixel configuration disclosed in FIG. 17, FIG. 18, FIG. 19 and FIG. 20, each one corresponding to one cluster of the 4 families of lenslets, solves successfully the problem of pentile displays with interlacing factor two just mentioned. On the contrary to the interlacing description in [0136], this o-pixel design does not require to shift the lenslets, but o-pixels are located to produce the proper interlacing when generating the a-pixels. The configuration presented is not unique, in the sense that similar arrangements can be done with specific o-pixel shifts or applying symmetries that lead trivially with the same functionality. The number of R, G and B o-pixels remains with 1:2:1 ratio of the original pentile in the 4 cluster types, and that a-pixel distribution in the virtual image appears also with the 1:2:1 ratio, as shown in FIG. 21 for the Green a-pixels and in FIG. 22 for the Red a-pixels (and the blue a-pixels distribution is similar to the red ones, just the D squares in FIG. 22 are R and the B are D). Notice that this o-pixel design creates a pencil structure that has therefore the double number of Green pencils that Blue and Red, and additionally has two properties: first, the density of Green a-pixels in the accommodation plane is twice that of Red and Blue a-pixels; and second, pencils of any color have the same interlacing factor 2. The first property provides a double resolution for green pixels that red and blue in the virtual image, as in direct view pentile displays; while the second allows a similar scintillation for the three colors.

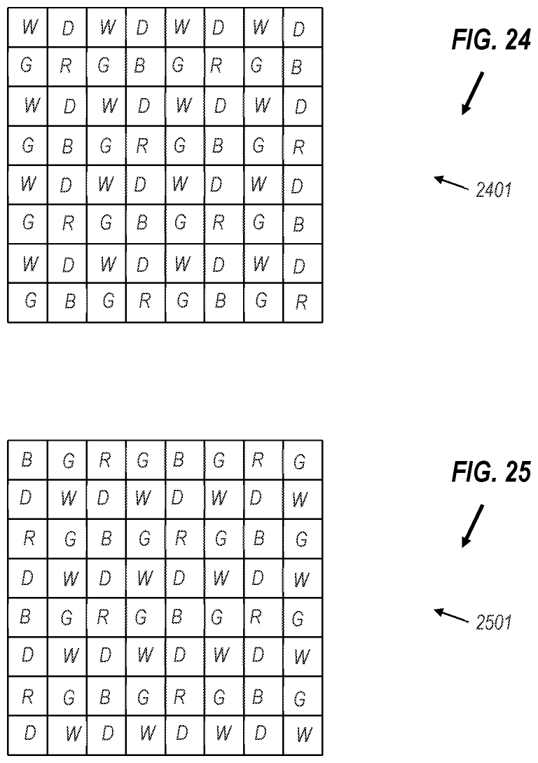

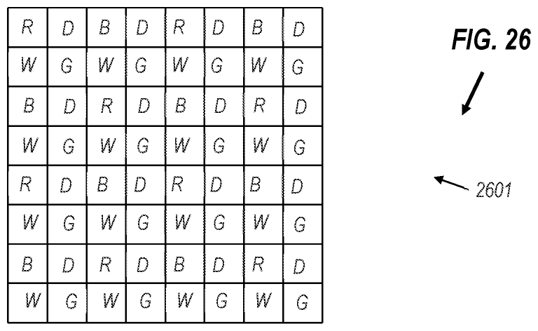

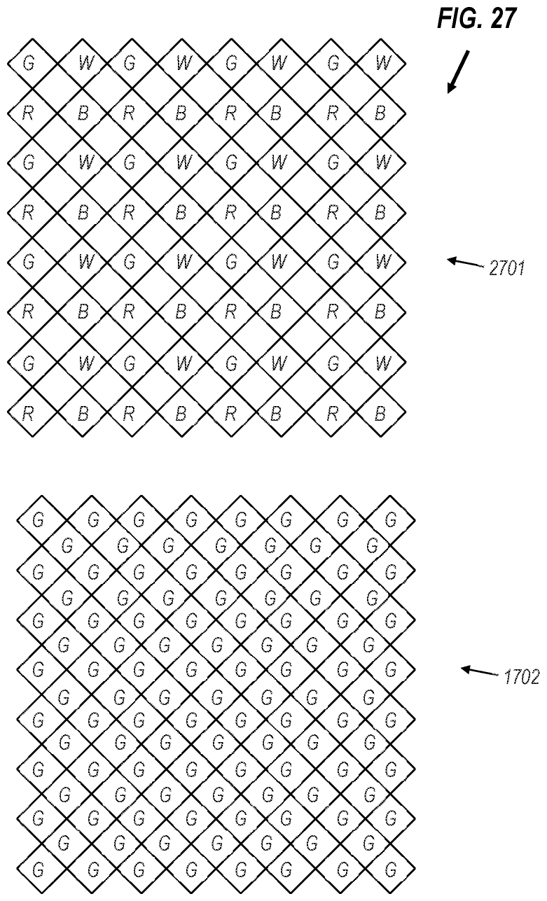

FIG. 23, FIG. 24, FIG. 25 and FIG. 26 show another o-pixel configuration for RGBW displays and square-type lenslet arrays, useful when it is required the fill factor of all colors together is about 75% (for instance, to let 25% space for the TFT transistors). Interlacing with a factor 2 leads to White and Green a-pixels fully packed the accommodation plane, as was shown in FIG. 21, while the number of Red and Blue a-pixels are a half, as was also shown in FIG. 22.

Moreover, some embodiments with square-like lenslet arrays in which polarization is being used to avoid cross-talk between adjacent clusters, as disclosed in [0432], require preferably an interlacing factor of 2^{1/2} or 8^{1/2}. The former can be achieved with an RGBW-square o-pixel display 45 deg rotated with respect to the lenslet array, while the latter would preferably use a display RGBW o-pixel arrangement 2701 as the one shown in FIG. 27, which leads to fully packed a-pixel distributions for all colors like the Green one 2702.

Interlacing by Rotation

In the interlacing description in [0136], lenslets where shifted, and in several embodiments in section [0143] the interlacing was achieved by adequate o-pixel positioning on the display. In this section we are disclosing a third option to produce interlacing, which consists in rotating the array relative to the display. This has practical interest to adjust a manufactured device, or even to dynamically modify the interlacing factor using actuators.

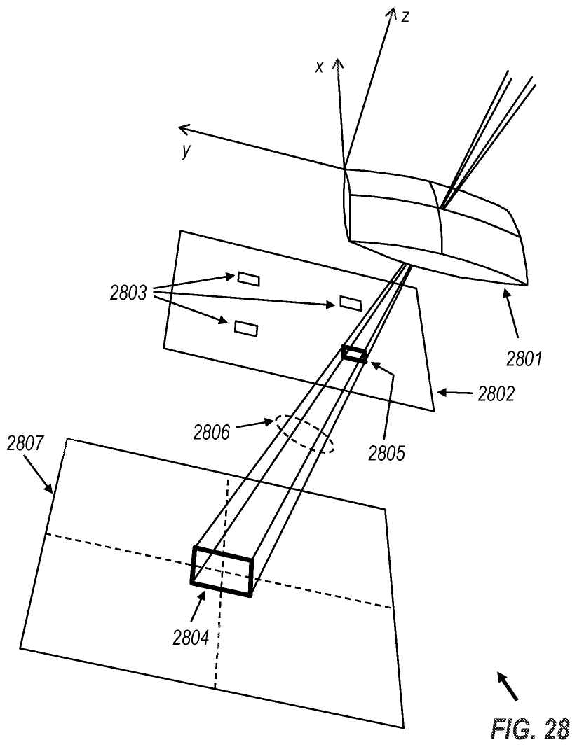

FIG. 28 shows a lenslet 2801 facing a display 2802 populated with o-pixels 2803, which are turned off. Lenslet 2801 forms a virtual image (on the waist plane 2807) of the o-plane. In particular, it generates a pencil with waist 2804 from the image of o-pixel 2805 which is turned on. Lens aperture 2801 together with waist 2804 define a pencil 2806 represented by some of its rays.

Rotating the display relative to the display is a way to convert an accommodation plane with interlaced factor 1 into an accommodation plane of a interlaced factor greater than one, as explained next. The rotation angle needed for interlacing is not unique. The minimum rotation angle α is related with the o-pixel pitch with the following formula:

α=a/k_{M} with k_{M}=int(p_{L}/p_{P}) where int(x) is the integer part of x, p_{L} is the lens pitch, p_{P} the display o-pixel pitch and a is the inverse of the interlacing factor.

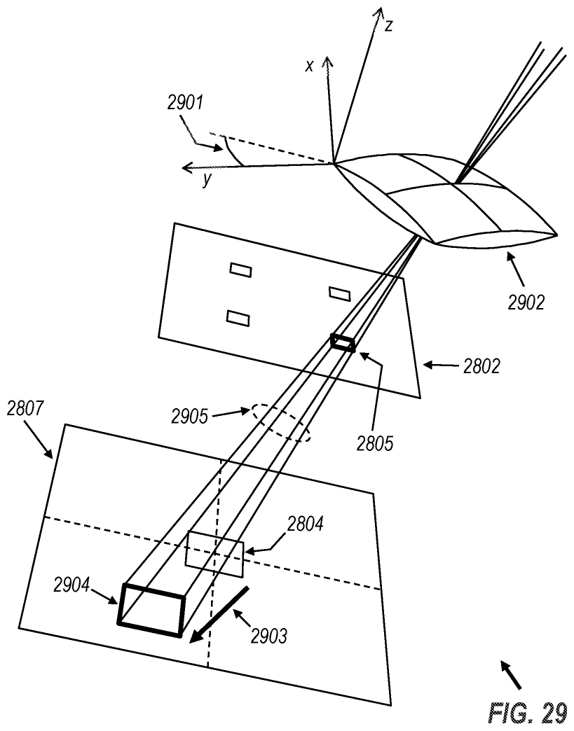

FIG. 29 shows a variation of the configuration in FIG. 28. Now, lens 2801 rotated around axis z (normal to the lens through its corner) by an angle 2901 to position 2902. Here o-plane 2802 and in particular o-pixel 2805 remain stationary. This results in a movement 2903 of waist 2804 to a new position 2904 in waist plane 2807 in which the pencil “pivots” around opixel 2805 to a new position 2904.

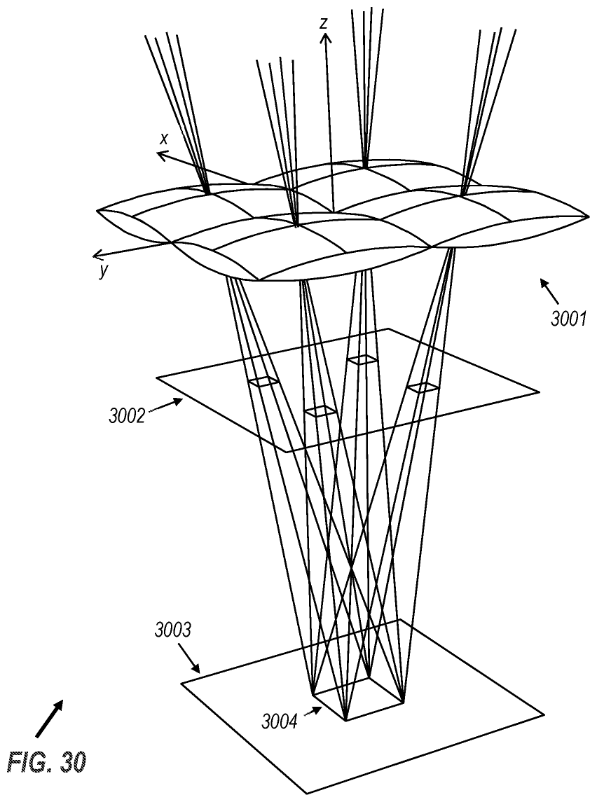

FIG. 30 shows a lenslet array 3001. Each lenslet generates a virtual image of one o-pixel of display plane 3002. All these virtual images overlap at the waist plane 3003 forming there an accommodation pixel 3004.

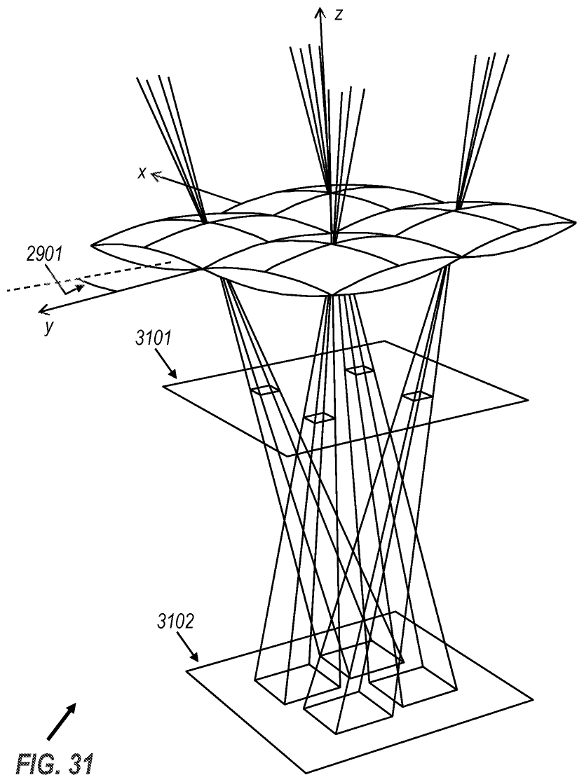

FIG. 31 shows the lenslet array of FIG. 30 rotating by an angle 2901 similar to that in FIG. 29. Also here the oplane 3101 remains stationary. The virtual images (pencil's waists) composing a-pixel 3004 spread apart in movements similar to that shown in FIG. 29 resulting in separate virtual images on waist plane 3102.

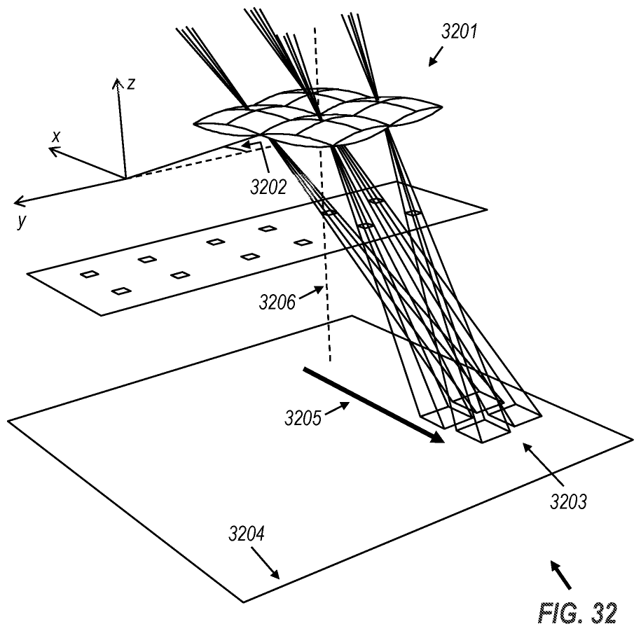

FIG. 32 shows another lenslet array 3201, now rotating by an angle 3202 around an axis z outside of it. The pencil's waists 3203 formed on the waist plane 3204 spread apart, in a process similar to that in FIG. 31, and move by a displacement 3205 relative to the vertical 3206 through the center of the lenslet array.

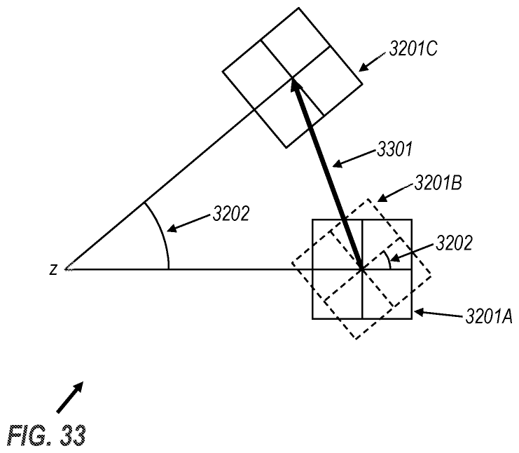

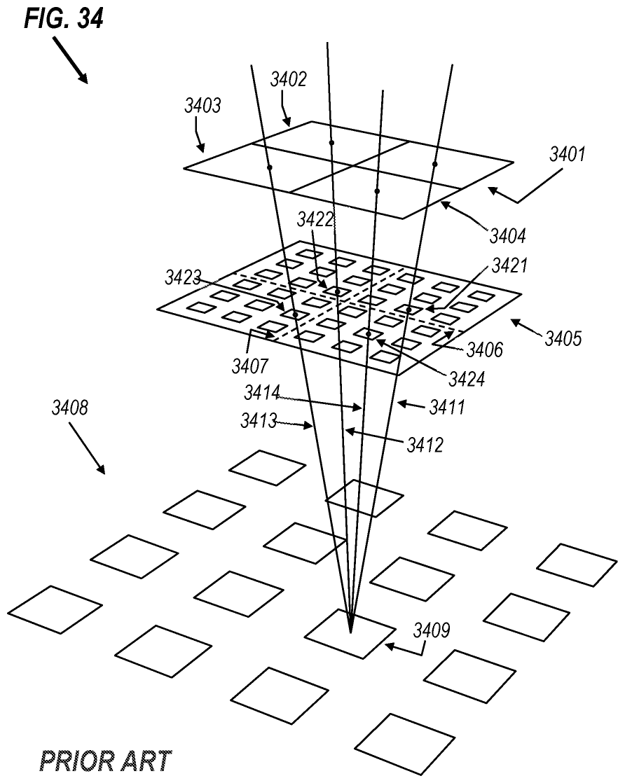

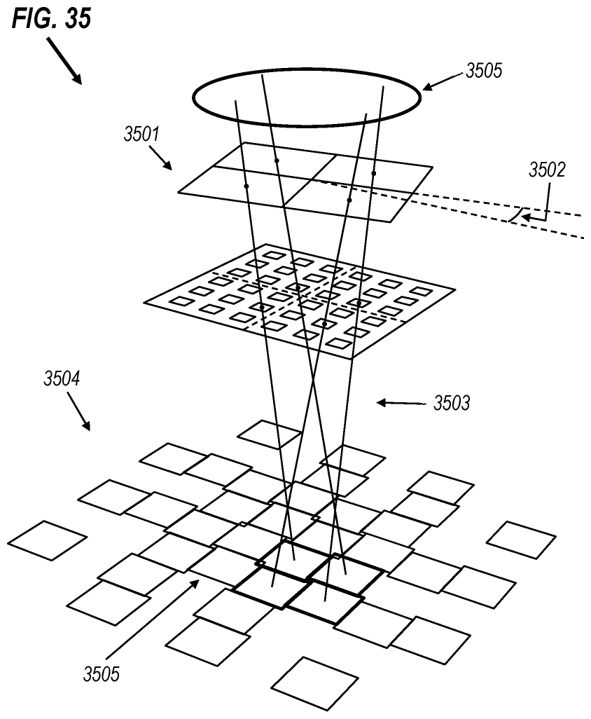

FIG. 33 shows the rotation of lenslet array 3201 of FIG. 32 but now in a top view. The lenslet array starts at position 3201A and rotates around axis z to position 3201C. Said rotation may be decomposed as a rotation in place and a translation. One may then consider that 3201A first rotates in place around its center by an angle 3202 to position 3201B. This results in a spread out of its virtual images in a process similar to that shown in FIG. 31. The rotated array 3201B now moves to its final position 3201C by a translation 3301. This results in a displacement 3205 of the virtual images as shown in FIG. 32.

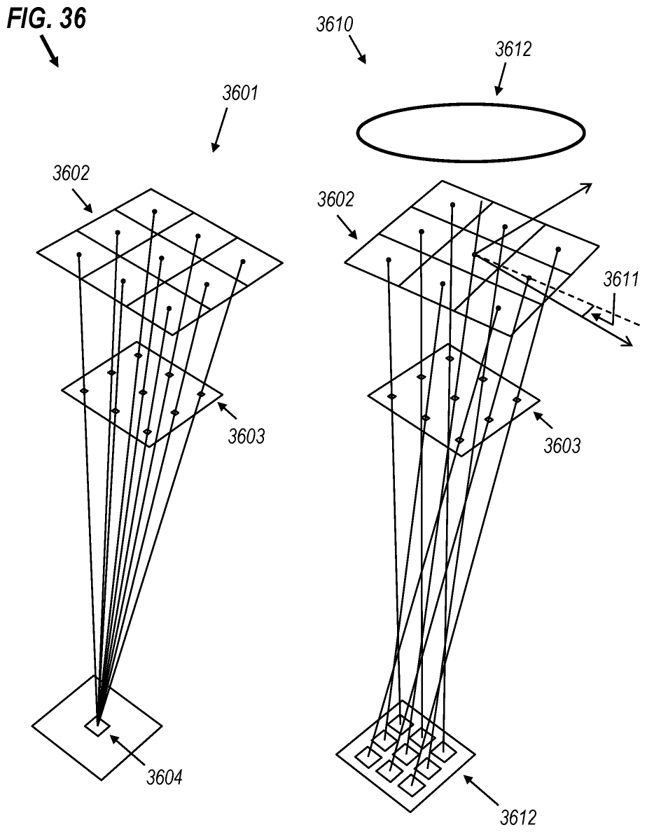

FIG. 34 shows an embodiment of the prior art. Lenslets 3401, 3402, 3403 and 3404 face a display 3405 whose o-pixels are divided into clusters along lines 3406 and 3407. There is one cluster per lenslet. The accommodation plane 3408 contains a-pixels such as 3409. Each one of these said a-pixels is the superposition of several waists (four in this diagrammatic representation) of different pencils (one pencil per cluster) through the corresponding lenslets. The a-pixel 3409 is formed by the intersection of the four pencils represented by their central rays 3411, 3412, 3413 and 3414 and is the superposition of the virtual images of opixels 3421, 3422, 3423 and 3424 through the corresponding lenses. We call this pencil configuration a coupled configuration, and corresponds to the interlacing factor equal to 1 referred to in FIG. 7 (plane 3408 is equivalent to 406)

All o-pixels lit to form the a-pixel 3409 should have the same information. This results in repeated information in display 3405.

FIG. 35 shows how a relative rotation of display with respect to the lenslet array allows to produce interlacing, converting a a-plane of interlacing factor=1 (that is, not interlaced) into an a-plane with interlacing factor>1. In general, sqrt(2), 1, 2, sqrt(3), etc are possible values of the interlacing factor depending on the array geometries and rotations angles. FIG. 35 shows this concluding that the rotation of the lenslet array of prior art in FIG. 34 increases resolution reducing the repeated information in display 3405. In this embodiment, lenslet array 3501 is rotated by a small angle 3502 around a vertical axis. This leads to a twisting 3503 of the pencils and the virtual images composing 3D pixel 3409 now split apart at the virtual image 3504, increasing resolution by this interlacing process.

In order to appreciate this increased resolution, the eye pupil 3505 of an observer must be large enough to capture light from four (in this example) lenslets.

Each o-pixel shown in FIG. 34 and FIG. 35 contains a single sub-pixel (R, G, B, or W). The increased resolution is possible if there are spaces between the o-pixels of the same color that may be filled with the interlacing process shown in FIG. 35.

Let us now consider a display as shown in FIG. 8. Let us further consider that in FIG. 34 and FIG. 35 all o-pixels are off and only the red (R) ones are on. FIG. 34 and FIG. 35 now represent coupled and interlaced configurations respectively of the red sub-opixels.

In the interlacing process, as the lens array 3501 rotates and the interlacing unfolds, the red virtual images overlapped in 3D pixel 3409 start to pull apart from each other, moving “over” the adjacent blue, white and green o-pixels that are off. This results in a virtual image that appears all red, i.e., without spaces between red o-pixels.

It is possible to do the same for the blue (B), white (W) and green (G) o-pixels resulting in virtual images that appear all blue, white and green respectively. When all o-pixels are on, the result is an image in the interlaced configuration of FIG. 35 has a resolution which is four times that in FIG. 34. Each interlaced a-pixel 3505 of the interlaced configuration is now the superposition of one red, one blue, one white and one green sub-a-pixels. The different colors (RGBW) of interlaced a-pixel 3505 leave through different lenslets of lens array 3501. The resolution increase of the interlaced configuration is got at expense of reducing the number of pencils that pass through the a-pixel (interlacing factor=2) when compared to the coupled configuration (interlacing factor=1).

FIG. 36 shows a configuration 3601 of an embodiment where part of a lenslet array 3602 composed of nine elements is paired with a display (oplane) 3603 generating a 3D pixel at position 3604 in a coupled configuration. Also shown is configuration 3610 with the lens array rotated by a small angle 3611 resulting in an image in interlaced configuration 3612. Pencils crossing lenslet elements 3602 are collected by the eye pupil 3612.

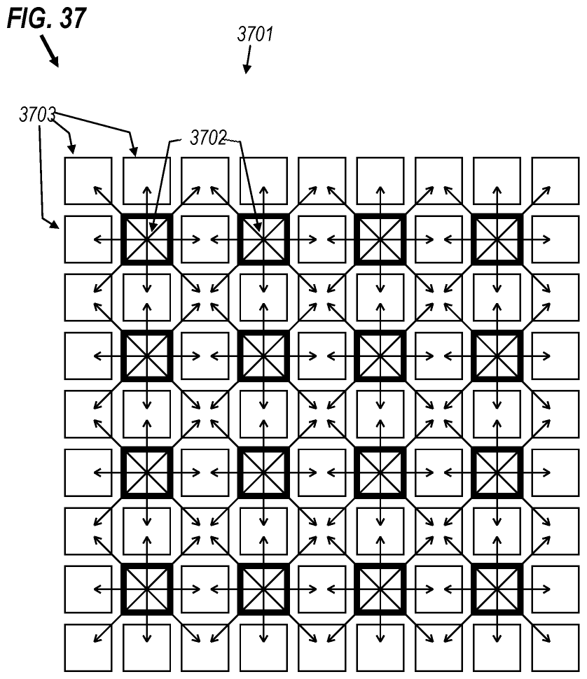

FIG. 37 shows virtual image 3701 where a-pixels 3702 are unfolded and where the virtual images 3703 of its pencils are interlaced into a constellation around them. When used with, say, OLEDs with low fill factor or LCD with low aperture ratio, said virtual images 3703 “move” onto empty spaces around a-pixels 3702 (that may result from space needed for display wiring) or onto adjacent a-pixels of a different color. This allows the use of low aperture ratio displays, where the non emitting area can be used to allocate the pixel electronics. Such approach increases the effective pixels per inch (PPI) of a given technology, and reduces the VR screendoor effect. This interlacing configuration in FIG. 37 results in a virtual image with triple resolution (in each direction). Other increases in resolution are also possible using similar methods.

2. Directional Magnification Function and Equi-Focal Lenslet Arrays

Consider an array of lenslets, each one of them approximately imaging a portion the digital display on a portion of a waist sphere of radius R_{∞} centered at the eye's sphere center. R_{∞} is much greater than the radius of the eye's sphere. Let r=(x,y) be a point of the digital display and let (θ,φ) be two spherical coordinates of the point on that sphere (that we will call the field point (θ,φ), or the field (θ,φ) for short) where the rays issuing from (x,y) are virtually imaged by the lenslet (i,j), i.e., these rays are virtually coming from the field point (θ,φ) of the sphere when they intercept the eye. Let's call θ the polar angle and φ the azimuthal angle. Let's set θ=0 as the skull's frontward direction. Then r=(x,y) depends on θ,φ,i,j through the mapping function:

$$r = ( \begin{matrix}x \\ y\end{matrix} ) = ( \begin{matrix}X ( θ , φ , i , j ) \\ Y ( θ , φ , i , j )\end{matrix} )$$

Let Δr be the change of r when the point of said sphere moves differentially from (θ,φ) to (θ+Δθ,φ+Δφ) such that tan α=sin θΔφ/Δθ. Let's call α the direction angle. We define the directional magnification m of the lenslet (i,j) as the function of (θ,φ,αi,j) given by:

$$m = \frac{1}{{R}_{∞}} \vert {r}_{θ} cos α + {r}_{φ} sin α / sin θ \vert$$

where the subindices θ,φ indicate partial derivative. This function is called directional magnification along direction α at the field point (θ,φ). Notice that this magnification definition corresponds to ray trayectories reversed from the actual ones i.e., from display to the eye, since the magnification corresponds to a ratio of a distance between points on the display surface to the distance between the field points on the waist-surface. This reverse operation is the usual one in Head Mounted Display (HMD) optics design, so this magnification m is the commonly used in commercial software as Zemax or Code V, while m⁻¹ is the one normally used in magnifying instruments as binoculars or microscopes. In the limit case when R_{∞} tends to infinity, it is preferable to use the direction focal length defined as f=mR_{∞}, which will be called directional focal length along direction α at the field point (θ,φ). The directional magnification as well as the directional focal length are called respectively radial and sagittal magnification/focal length when α=0 and α=π/2, respectively.

Preferred embodiments of this invention have lens arrays with directional magnification functions independent of the lenslet i,j (which we will call equi-focal lens arrays) provided by the mapping function of the form

$$r = ( \begin{matrix}x \\ y\end{matrix} ) = ( \begin{matrix}A ( {θ}_{,} φ ) + {x}_{c} ( i , j ) \\ B ( θ , φ ) + {y}_{c} ( i , j )\end{matrix} )$$

If all lenslets are identical (except for translation) it is trivially fulfilled that directional magnification function independent of the lenslet i,j. However, the pencils used in wide field of view designs are very different for the different lenslets. In this case, practical identical lenslets designed with an affordable number of surfaces are not able to provide good image quality and low cross talk between lenslets for all the pencils throughout the array. When the field of view is large, the lenslet close to center of the field of view operates with pencils whose central rays form moderate angles with the frontward direction, while lenlets close to the periphery typically operate with pencils whose central rays are very oblique with respect to the frontward direction. It is much more efficient to design different lenses, each one optimized for the pencils they need to work for to illuminate the pupil range, and the best global results can be achieved when those lenslets contain freeform surfaces since rotational symmetric surfaces impose undesired constraints for oblique operation. This is particularly true for lenslets far from the center of the array.

Since eye accommodates based mainly on the information projected on the fovea, the condition of Equation [0176] is only needed for those lenslets sending foveal rays virtually coming from the field points (θ,φ). Foveal rays are rays focused on to the fovea for some position of the eye pupil. They can be also characterized as those reaching the eye ball sphere within the pupil range such that their straight prolongation is away from that sphere center a distance smaller than a value between 2 and 4 mm. Therefore, for each field point of the gazeable region of the field of view we can define its corresponding foveal lenslets as those intercepted by the foveal rays of that field point.

The condition of directional magnification function being independent of the lenslet i,j (Equations [0173] and [0176]) guarantees the x−x_{c}=constant and y−y_{c}=constant lines (which may correspond to the image row and columns of opixels on the display) coincide on the sphere R_{∞} when they are imaged by the different lenslets. This ensures that the overlapping or interlacing of their corresponding partial virtual images can be done properly. Without this condition, different pitches and orientations of o-pixel image grids of the different lenslets on the waist surface would cause blurring and resolution loss. Such irregular spacing could even cause Moire type effects in the virtual image visualization. Deviations up to 10% from the exact equality of the directional magnification function for a field point among its corresponding foveal lenslets may still be acceptable, although deviations smaller than 3% are desirable, specially for the field points of the gazeable region of the field of view.

As a particular case, we are interested in lenslets whose directional magnification function is rotational symmetric, so it does not depend on azimuthal angle 9. The mapping function of these lenslets is given by:

$$r = ( \begin{matrix}x \\ y\end{matrix} ) = ( \begin{matrix}G ( θ ) cos φ + {x}_{c} ( i , j ) \\ G ( θ ) sin φ + {y}_{c} ( i , j )\end{matrix} )$$

whose directional magnification function is given by:

$$m = \frac{1}{{R}_{∞}} \sqrt{{G}_{θ}^{2} ( θ ) {cos}^{2} α + \frac{{G}^{2} ( θ )}{{sin}^{2} θ} {sin}^{2} α}$$

The radial magnification, which corresponds to α=0, is therefore given by G_{θ}/R_{∞}, while the sagittal magnification, which corresponds to α=π/2, is given by G/sin θ/R_{∞}. Notice that both magnifications coincide at θ=0.

When the lenslets are ideal optical systems with distortion free rectilinear mapping, the function G is G(θ)=f₀ tan θ. In this case, the radial magnification is given by G_{θ}/R_{∞}=1/(R_{∞} cos² θ) which is minimum at θ=0. In this invention we are interested in having a high magnification at the center of the field of view at the expense of a reduced magnification for larger values of θ, so a behavior opposite to that of rectilinear mapping. For that purpose, we will preferably chose functions G(θ) such that associated directional magnification in the radial direction multiplied by the square of the cosine of the polar angle is a decreasing function of the polar angle ratio.

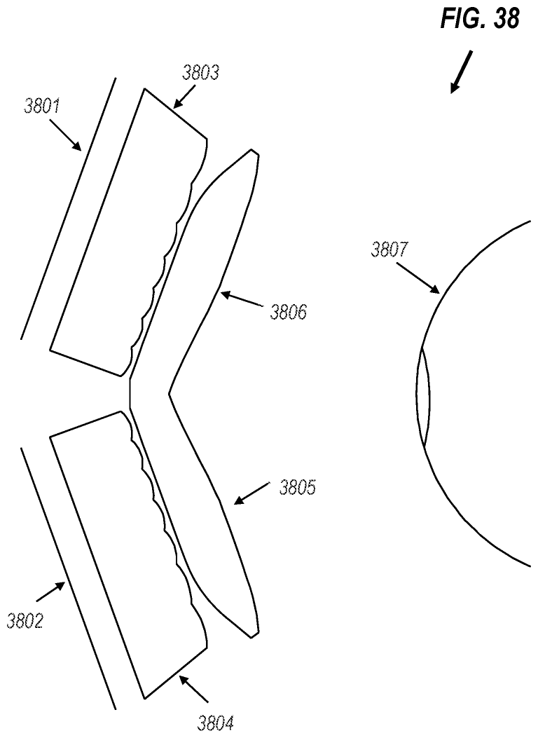

Lenlets can be designed as described herein to produce prescribed mapping functions as [0176] or [0181]. However, it is of particular interest to use additional conforming lenses intercepting the path of every ray illuminating the pupil range from the digital display, since it can act as a field lens to increase the field of view for a given display. It can also allow for a thin lenslet array and without steps from microlens to microlens. Unlike a lenslet array, a conforming lens cannot be divided in disjoint portions such that each one of them is working solely for a single channel. A conforming lens may be placed between the eye and the rest of the optical system or between lenslet arrays or even between the digital display and the rest of the optical system. A conforming lens may have at least one surface with slope discontinuities to either reduce its thickness as a Fresnel lens, or to habilitate the use two or more displays per eye, as shown in FIG. 38

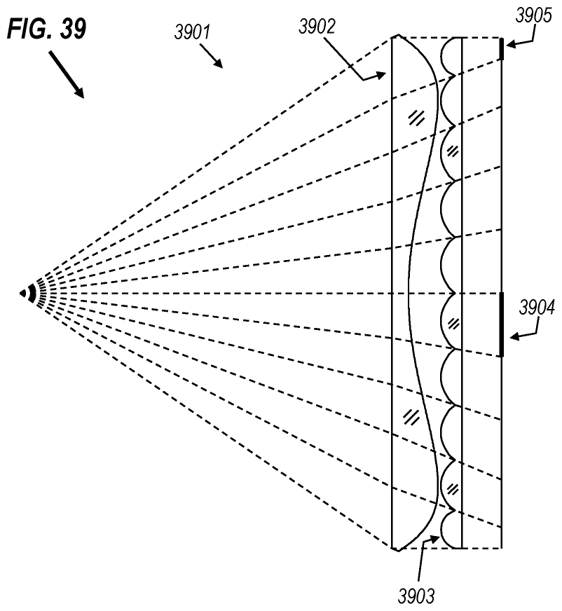

FIG. 39 shows an embodiment 3901 where a conforming lens 3902 faces a flat microlens array 3903. This combination enlarges the o-pixels per degree at the central clusters, such as 3904, and reduces it at the edges, such as 3905. This can facilitate that the design with a rather flat array presents a higher magnification values (and thus higher virtual pixels densities, in pixels per degree) at the center of the field of view and lower radial magnification values at larger polar angles, which corresponds to G(θ) being a decreasing function of the polar angle ratio θ. This matches the human eye resolution needs, since it is very high only close to the gazing direction and most of the time we gaze within ±20 degs from the frontward direction. This strategy itself can typically increase the virtual image resolution at the center of the field of view relative to the rectilinear mapping function by 1.5× or greater.

Conforming lenses are not limited to just including refractive surfaces, but can also include reflective or diffractive surfaces. Particularly, a “pancake” architecture as described by La Russa U.S. Pat. No. 3,443,858 can also be used as a conforming lens to allow the design of embodiments herein with a very large field of view and relatively small displays.

Additionally, since the equality between directional magnification functions is only required for foveal rays, the image quality or the magnification (or both), of each lenslet can be designed to be lower for pencils with only non-foveal rays, that is, rays hitting the peripheral retina, where the human eye resolution is much lower. Therefore, the virtual image resolution can be further increase by making that, for every direction angle α, the directional magnification of lenslets is maximum at its centered gazing field, which is defined by the ray joining the lenslet aperture center and whose straight prolongation passes through the center of the eyeball sphere. This strategy itself can typically increase the virtual image resolution at the center of the field of view relative to the rectilinear mapping function by 1.2× or greater.

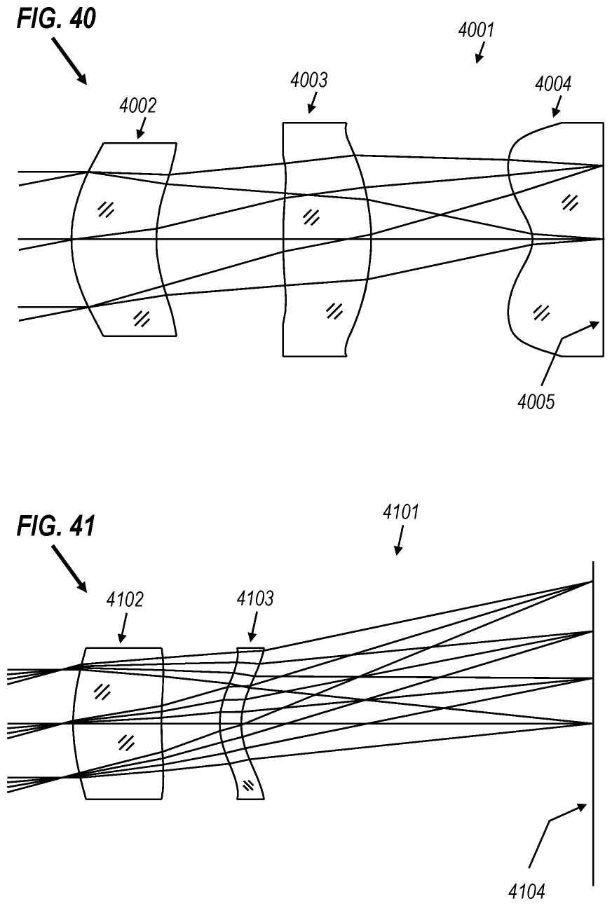

FIG. 40 shows the optic of a refractive lenslet 4001 with its preferential gazing direction parallel to the horizontal direction in the figure and designed to have maximum directional magnification at that field point. It is composed of several optical elements 4002, 4003, 4004 and designed for cluster 4005. Said optic has a decreasing radial magnification and a decreasing optical image quality depending on the polar angle. The virtual image resolution (resulting from combining optical resolution with the directional magnification) is higher for rays that will eventually reach the fovea on the eye, and gradually decreasing for rays reaching the more peripheral regions of the retina.

FIG. 41 shows another lenslet optic 4101 composed of elements 4102 and 4103 and designed for cluster 4104. Cluster 4104 may move allowing the emission of the optic to follow the eye, performing eye tracking. Said movement of the cluster may be accomplished via software addressing different sets of pixels on the display placed at 4104. Its design may also include that directional magnification and optical image quality are maximum at the centered gazing field. Furthermore, these optics may be designed to provide this performance features for different distances of the display relative to them, allowing to be used by users having hyperopia or myopia, typically in a range up to +2 diopters to −8 diopters.

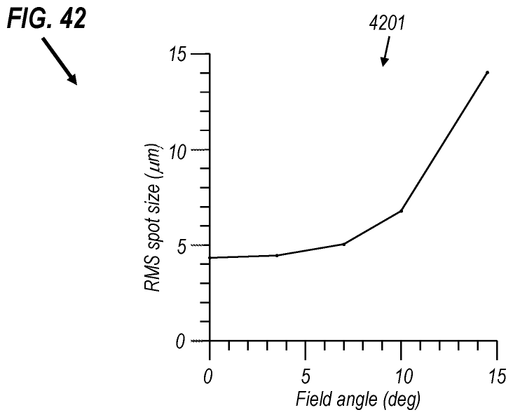

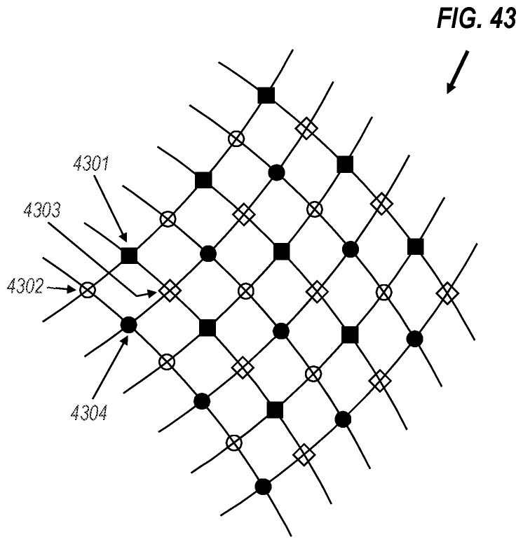

FIG. 42 shows the RMS spot diameter size 4201 on the display when rays are traced reversed from the eye of exemplary optic shown in FIG. 41 as a function of angle to the optical axis. This optic is designed to be placed right in front of the eye ball, so field angle zero coincides with its centered gazing field, so spot diameter is preferably minimum. For larger field angles, the eye ball is rotated and the angle between the eye gazing vector and the field (called peripheral angle) increases (typically being close to double the field angle), and since the human eye resolution is much lower for larger peripheral angles, the spot diameter is allowed by design to be larger without the user noticing it.

The lenses in FIG. 40 and FIG. 41 are shown in cross section as profiles of rotational symmetric surfaces, which are adequate for close-to-z-axis lenslets, while for oblique incidence, freeform optics must be designed, as described in [0413] below.

Prescribing the directional magnification function, making it different from the rectilinear mapping imply that the lenslets present distortion, which must be corrected by software so the virtual image appear undistorted, as it is usually done in virtual reality optics.

Interlacing by Rotation for an Arbitrary G(θ) Function

We disclosed in [0151] how to interlace by rotation. Calculations have been done assuming a simplified situation that corresponds to a rectilinear mapping function. However, this is perfectly applicable to an arbitrary equi-focal lenslet array as shown next. The mapping function of [0181] for a specific lenslet in a design:

$$( \begin{matrix}x \\ y\end{matrix} ) = G ( θ ) ( \begin{matrix}cos φ \\ sin φ\end{matrix} ) + ( \begin{matrix}{x}_{c} \\ {y}_{c}\end{matrix} )$$

We have omitted the indices i,j of the lenslet, as those variables are going to be re-used herein with a different meaning. Assume the opixels of the display are in a square Cartesian grid parallel to the x and y axes with pitch pₒ. Therefore, the pixel of indices (i,j) has x,y coordinates:

$$( \begin{matrix}x \\ y\end{matrix} ) = {p}_{o} ( \begin{matrix}i \\ j\end{matrix} )$$

where we have set the indices (0,0) correspond to the central pixel of the display. Therefore, inverting equation [0197], we find that the a-pixels associated to the o-pixel (i,j) for a given lenslet of center (x_{c},y_{c}) are located at:

$${θ}_{i j} ( {x}_{c} , {y}_{c} ) = {G}^{- 1} ( \sqrt{{{p}_{o} i - {x}_{c} )}^{2} + {( {p}_{o} j - {y}_{c} )}^{2}} )$$

$${φ}_{i j} ( {x}_{c} , {y}_{c} ) = atan ( \frac{{p}_{o} j - {y}_{c}}{{p}_{o} i - {x}_{c}} )$$

The condition for the a-pixels to be non interlaced implies that for any two lenslets, with centers (x_{c},y_{c}) and (x′_{c},y′_{c}), they have the same a-pixels, which means that, for each (i,j) there exist a (i′,j′) such that:

θ_{i′j′}(x′_{c},y′_{c})=θᵢⱼ(x_{c},y_{c})

φ_{i′j′}(x′_{c},y′_{c})=φᵢⱼ(x_{c},y_{c})

Notice that, from equations [0197] and [0203] it is deduced that the condition for not being interlaced is equivalent to:

$${p}_{o} ( \begin{matrix}i \\ j\end{matrix} ) - ( \begin{matrix}{x}_{c} \\ {y}_{c}\end{matrix} ) = {p}_{0} ( \begin{matrix}{i}^{′} \\ {j}^{′}\end{matrix} ) - ( \begin{matrix}{x}_{c}^{′} \\ {y}_{c}^{′}\end{matrix} )$$

So the lenslet centers must fulfill:

$$( \begin{matrix}{x}_{c} \\ {y}_{c}\end{matrix} ) - ( \begin{matrix}{x}_{c}^{′} \\ {y}_{c}^{′}\end{matrix} ) = {p}_{o} ( \begin{matrix}{i}^{″} \\ {j}^{″}\end{matrix} )$$

Where i″ and j″ are integers. Thus the x and y distances between lenslet centers must be a multiple of the o-pixel pitch pa. Since the central lens of the array (x_{c},y_{c})=(0,0), we can therefore manufacture the lenslet array with no interlacing by making:

$$( \begin{matrix}{x}_{c} \\ {y}_{c}\end{matrix} ) = {p}_{o} ( \begin{matrix}{i}^{″} \\ {j}^{″}\end{matrix} )$$

Therefore, for this election, equation [0197] can be rewritten as:

$$( \begin{matrix}i \\ j\end{matrix} ) = g ( θ ) ( \begin{matrix}cos φ \\ sin φ\end{matrix} ) + ( \begin{matrix}{i}^{″} \\ {j}^{″}\end{matrix} )$$

where g(θ)=G(θ)/pₒ. If we design the array so:

$$( \begin{matrix}{x}_{c} \\ {y}_{c}\end{matrix} ) = D ( \begin{matrix}{i}_{c} \\ {j}_{c}\end{matrix} )$$

where D=Npₒ and N, i_{c} and j_{c} are integers, and adjacent lenslets differ by 1 in i_{c} and in j_{c}. So in this case:

$$( \begin{matrix}i \\ j\end{matrix} ) = g ( θ ) ( \begin{matrix}cos φ \\ sin φ\end{matrix} ) + N ( \begin{matrix}{i}_{c} \\ {j}_{c}\end{matrix} )$$

Consider an emitting point of the o-plane (xᵢₙₜ,yᵢₙₜ) in an intermediate position different from that of centers of the grid of o-pixels. This position is related with its direction of emission (θᵢₙₜ,φᵢₙₜ) through equation [0215] as:

$$( \begin{matrix}{i}_{i n t} \\ {j}_{int}\end{matrix} ) = g ( {θ}_{int} ) ( \begin{matrix}cos {φ}_{int} \\ sin {φ}_{int}\end{matrix} ) + N ( \begin{matrix}{i}_{c} \\ {j}_{c}\end{matrix} )$$

where iᵢₙₜ=xᵢₙₜ/pₒ and jᵢₙₜ=yᵢₙₜ/pₒ are non-integer values. Let us consider now that we rotate the display an angle α, so the new coordinates of the centers of the o-pixels (x_{α},y_{α}) are related with the original (non-rotated) ones (x,y) as:

$$( \begin{matrix}x \\ y\end{matrix} ) = ( \begin{matrix}cos α & sin α \\ - sin α & cos α\end{matrix} ) ( \begin{matrix}{x}_{α} \\ {y}_{α}\end{matrix} )$$

Dividing by pₒ, we can define the values of the indices of the rotated opixels by:

$$( \begin{matrix}i \\ j\end{matrix} ) = ( \begin{matrix}cos α & sin α \\ - sin α & cos α\end{matrix} ) ( \begin{matrix}{i}_{α} \\ {j}_{α}\end{matrix} )$$

where i and j are integers, and i_{α}=x_{α}/pₒ and j_{α}=y_{α}/pₒ are, in general, non-integers. Applying equation [0216] to (i_{α}, j_{α}) and its corresponding direction (θ_{α},φ_{α}), and substituting in [0220] for lenslet with center (i_{c},j_{c}) we get:

$$( \begin{matrix}i \\ j\end{matrix} ) = g ( {θ}_{α} ) ( \begin{matrix}cos ( {φ}_{α} - α ) \\ sin ( {φ}_{α} - α )\end{matrix} ) + N ( \begin{matrix}{i}_{c , α} \\ {j}_{c , α}\end{matrix} )$$

$$where ( \begin{matrix}{i}_{c , α} \\ {j}_{c , α}\end{matrix} ) = ( \begin{matrix}cos α & sin α \\ - sin α & cos α\end{matrix} ) ( \begin{matrix}{i}_{c} \\ {j}_{c}\end{matrix} )$$

When α is small, this equation can be approximated by:

$$( \begin{matrix}{i}_{c , α} \\ {j}_{c , α}\end{matrix} ) = ( \begin{matrix}{i}_{c} + α {j}_{c} \\ - α {i}_{c} + {j}_{c}\end{matrix} )$$

So according to [0222] and [0225], the mapping of lenslet with center (i_{c},j_{c}) when the display is rotated is given by:

$$( \begin{matrix}i \\ j\end{matrix} ) = g ( {θ}_{α} ) ( \begin{matrix}cos ( {φ}_{α} - α ) \\ sin ( {φ}_{α} - α )\end{matrix} ) + N ( \begin{matrix}{i}_{c} \\ {j}_{c}\end{matrix} ) + N α ( \begin{matrix}{j}_{c} \\ - {i}_{c}\end{matrix} )$$

This equation is given as the relation between the opixel (i, j) and the direction of its corresponding a-pixel (θ_{α},φ_{α}) through lenslet (i_{c},j_{c}) when the display is rotated a. The inverted expression of [0227] is:

$${θ}_{α} = {g}^{- 1} ( \sqrt{{( i - N ( {i}_{c} + α {j}_{c} ) )}^{2} + ( j - {N ( - α {i}_{c} + {j}_{c} )}^{2} )}$$

$${φ}_{α} = α + atan ( \frac{j - N ( - α {i}_{c} + {j}_{c}}{i - N ( {i}_{c} + α {j}_{c} )} )$$

An opixel (i′, j′) is projected through another lenslet (i′_{c}, j′_{c}) as indicated by:

$$( \begin{matrix}{i}^{′} \\ {j}^{′}\end{matrix} ) = g ( {θ}_{α}^{′} ) ( \begin{matrix}cos ( {φ}_{α}^{′} - α ) \\ sin ( {φ}_{α}^{′} - α )\end{matrix} ) + N ( \begin{matrix}{i}_{c}^{′} \\ {j}_{c}^{′}\end{matrix} ) + N α ( \begin{matrix}{j}_{c}^{′} \\ - {i}_{c}^{′}\end{matrix} )$$

Let us find if there is an angle α (apart from α=0) such that the design is “perfectly coupled”, that is, if for any o-pixel (i, j) projected through lenslet (i_{c},j_{c}) there exists an o-pixel (i′, j′) which is projected through lenslet (i′_{c},j′_{c}) such that θ′_{α}=θ_{α} and φ′_{α}=φ_{α}. By subtracting equations [0227] and [0231], we get:

$$( \begin{matrix}{i}^{′} \\ {j}^{′}\end{matrix} ) = ( \begin{matrix}i \\ j\end{matrix} ) + N ( \begin{matrix}{i}_{c}^{′} - {i}_{c} \\ {j}_{c}^{′} - {j}_{c}\end{matrix} ) + N α ( \begin{matrix}{j}_{c}^{′} - {j}_{c} \\ - {i}_{c}^{′} + {i}_{c}\end{matrix} )$$

From [0233] it is clear that the condition is that Nα is an integer, and the smallest α is given by:

$$α = \frac{1}{N}$$

To obtain an interlacing factor 2 we just select:

$$α = \frac{1}{2 N}$$

From [0233] we find that the lenslet families having j′_{c}−j_{c} and i′_{c}−i_{c} even will be perfectly coupled, so 4 families appear:
Family A: i_{c}={ . . . −4,−2,0,2,4, . . . }, j_{c}={ . . . −4,−2,0,2,4, . . . }
Family B: i_{c}={ . . . −3,−1,1,3, . . . }, j_{c}={ . . . −4,−2,0,2,4, . . . }
Family C: i_{c}={ . . . −4,−2,0,2,4, . . . }, j_{c}={ . . . −3,−1,1,3, . . . }
Family D: i_{c}={ . . . −,−1,1,3, . . . }, j_{c}={ . . . −3,−1,1,3, . . . }

We can compute what is distance in between the a-pixels of the different families, to see that they are truly interlaced duplicating the a-pixel density. To make this calculation simpler, we will compute where the a-pixel of a given family would need to come from on the display to be produced by another family. That is, consider lenslets (i_{c},j_{c}) of family A (so i_{c} and j_{c} are even) and an a-pixel (θ_{α},φ_{α}) produced by o-pixel (i_{A}, j_{A}) (so i_{A}, j_{A} are integers). By [0229] with Nα=0.5:

$$( \begin{matrix}{i}_{A} \\ {j}_{A}\end{matrix} ) = g ( {θ}_{α} ) ( \begin{matrix}cos ( {φ}_{α} - α ) \\ sin ( {φ}_{α} - α )\end{matrix} ) + N ( \begin{matrix}{i}_{c} \\ {j}_{c}\end{matrix} ) + 0.5 ( \begin{matrix}{j}_{c} \\ - {i}_{c}\end{matrix} )$$

For families B, C and D, the points of the o-plane that would correspond to this a-pixel (θ,φ) would be:

$$( \begin{matrix}{i}_{B} \\ {j}_{B}\end{matrix} ) = g ( {θ}_{α} ) ( \begin{matrix}cos ( {φ}_{α} - α ) \\ sin ( {φ}_{α} - α )\end{matrix} ) + N ( \begin{matrix}{i}_{c} + 1 \\ {j}_{c}\end{matrix} ) + 0.5 ( \begin{matrix}{j}_{c} \\ - {i}_{c} - 1\end{matrix} )$$

$$( \begin{matrix}{i}_{α C} \\ {j}_{α C}\end{matrix} ) = g ( {θ}_{α} ) ( \begin{matrix}cos ( {φ}_{α} - α ) \\ sin ( {φ}_{α} - α )\end{matrix} ) + N ( \begin{matrix}{i}_{c} \\ {j}_{c} + 1\end{matrix} ) + 0.5 ( \begin{matrix}{j}_{c} + 1 \\ - {i}_{c}\end{matrix} )$$

$$( \begin{matrix}{i}_{α D} \\ {j}_{α D}\end{matrix} ) = g ( {θ}_{α} ) ( \begin{matrix}cos ( {φ}_{α} - α ) \\ sin ( {φ}_{α} - α )\end{matrix} ) + N ( \begin{matrix}{i}_{c} + 1 \\ {j}_{c} + 1\end{matrix} ) + 0.5 ( \begin{matrix}{j}_{c} + 1 \\ - {i}_{c} - 1\end{matrix} )$$

Subtracting these equations we get:

i_{αB}=i_{αA}+N

j_{αB}=j_{αA}−0.5

i_{αC}=i_{αA}+0.5

j_{αC}=j_{αA}+N

i_{αD}=i_{αA}+N+0.5

j_{αD}=j_{αA}+N−0.5

Since (i_{αA}, j_{αA}) are integers, and only integer values of i_{α} and j_{α} correspond to true pixels of the display. Equation [0247] indicates that the a-pixels of the B family will be along the same i_{α}=constant lines, but will be in between the j_{α}=constant lines of the A family. Analogously, the a-pixels of the C family will be along the same j_{α}=constant lines, but will be in between the i_{α}=constant lines of the A family, and the a-pixels of the D family will be intermediate to the A family in both dimensions. FIG. 43 shows the accommodation pixels plane and the a-pixel centers 4301 of family A, a-pixel centers 4302 of family B, a-pixel centers 4303 of family C and a-pixel centers 4304 of family D.

3. Pupil Tracking and Underfilling Strategy

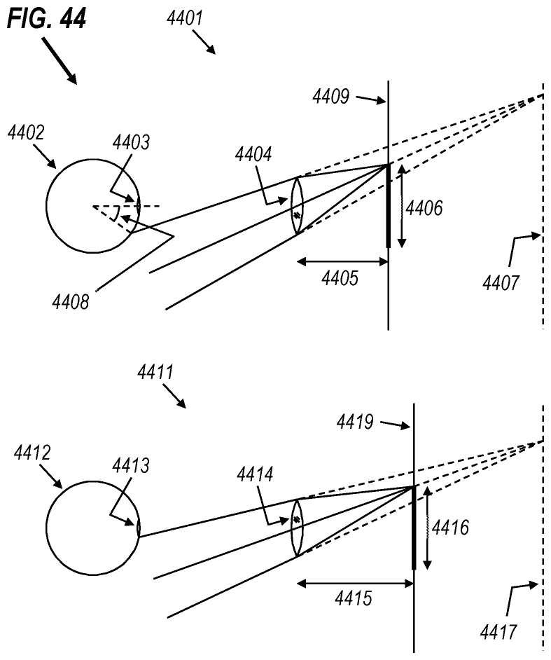

FIG. 44 shows a setup 4401 where eye 4402 with pupil 4403 looks into optical component 4404, which has a focal distance 4405 and faces a cluster with size 4406 in display 4409. The eye will see virtual image 4407 created by optical component 4404. The eye pupil 4403 may rotate inside a pupil range defined by angle 4408 (and its symmetrical counter clockwise) and the virtual image 4407 will still be visible inside said pupil range.

FIG. 44 also shows a setup 4411 where eye 4412 with pupil 4413 looks into optical component 4414, which has a focal distance 4415 and faces a cluster with size 4416 in display 4419. The eye will see virtual image 4417 created by optical component 4414. Cluster size 4416 being the same as 4406 but focal length 4415 being larger than 4405, causes the pupil range 4408 being reduced. As the focal length of optic 4404 increases, eventually pupil range 4408 will reach the dimension of the eye pupil as illustrated in setup 4411. By having a longer focal length, configuration 4411 projects towards the eye an image with a higher resolution, because the same number of pixels in the cluster is sent to the eye with a smaller angular span. However, as the eye moves it leaves the pupil range and the image is no longer visible, so there is a trade-off between resolution and pupil range. To overcome a narrower pupil range, one may perform gaze tracking and slide the cluster 4416 across display 4419 so that the moving image will follow the eye in its movement.

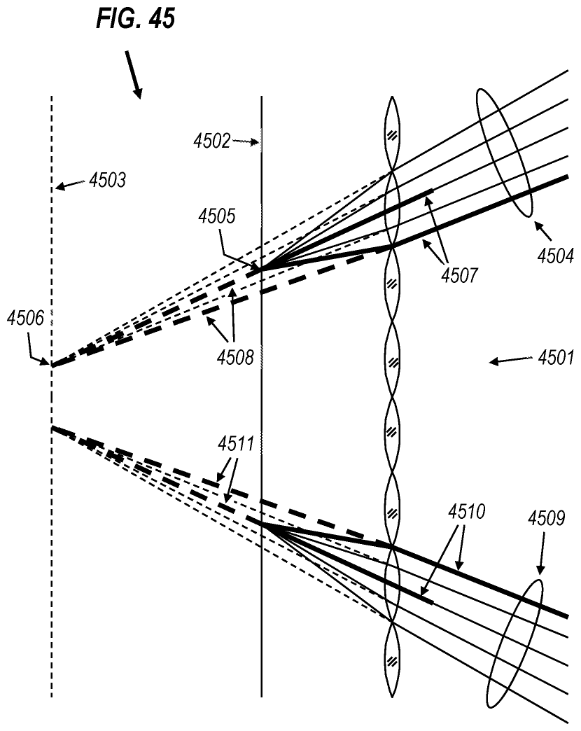

FIG. 45 shows a lens array in 4501. Each of the lenses in said array images part of object plane 4502 onto virtual image plane 4503. In particular, one of said lenses creates a pencil of rays 4504 that images point 4505 on the object plane onto point 4506 in the virtual image point. Said bundle is comprised of many light rays but, for the sake of figure simplicity, said bundle of rays is diagrammatically represented only by real rays 4507 and corresponding virtual rays 4508. Accordingly, another ray bundle 4509 is diagrammatically represented only by real rays 4510 and corresponding virtual rays 4511.

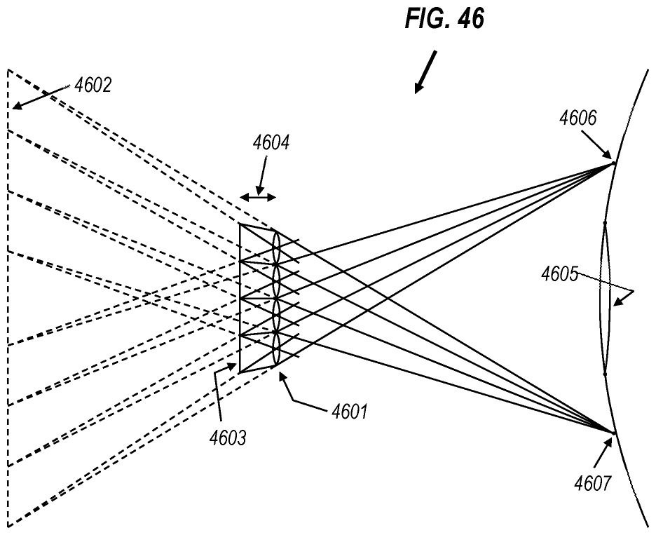

FIG. 46 shows a lens array 4601 that creates a virtual image 4602 of object plane 4603. Lens array 4601 and object plane 4603 are at a distance 4604 from each other. The virtual image 4602 will be visible by the eye pupil 4605 as long as it remains inside the pupil range extending from point 4606 to point 4607. For each lens in the lens array, this is a similar configuration to setup 4401 in FIG. 44.

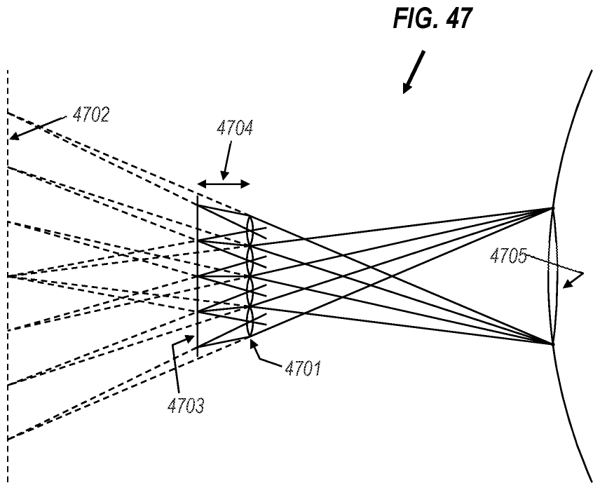

FIG. 47 shows a lens array 4701 that creates a virtual image 4702 of object plane 4703. Lens array 4701 and object plane (display) 4703 are now at a larger distance 4704 from each other than 4604 which was the case in FIG. 46. The size of display 4703 must increase to maintain the size of virtual image 4702. The pupil range of said lens array is now smaller and matches the size of pupil 4705. The larger distance 4704 between lens array and display corresponds to a larger focal distance of the lenses in the array. This results in a higher resolution image 4702. For each lens in the lens array, this is a similar configuration to setup 4411 in FIG. 44.

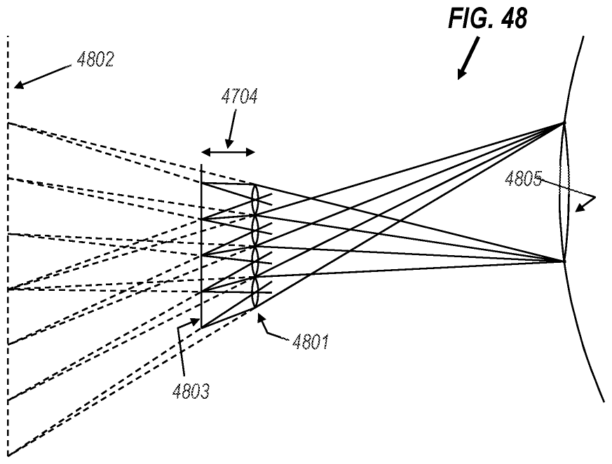

FIG. 48 shows the same configuration as FIG. 47, but now with the eye pupil at a different position 4805. Lens array 4801 creates a virtual image 4802 of display 4803. As the pupil moves from position 4705 in FIG. 47 to position 4805 in FIG. 48, the cluster of each lens moves in the display following the eye movement. This configuration, therefore, needs pupil tracking. The movement of the clusters in display 4801 is controlled by software.

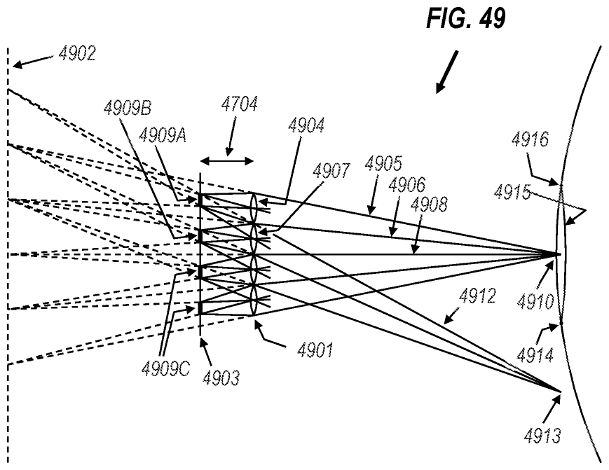

FIG. 49 shows lens array 4901 that creates a virtual image 4902 from the information shown in display 4903. This is a similar configuration that that shown in FIG. 47. However, now all pixels in display 4903 with repeated information are turned off. One such possibility is to leave on only those pixels 4909A of lens 4904 whose extreme emission directions are confined between the directions of rays 4905 and 4906 as they enter the eye pupil 4916. Accordingly, only those pixels 4909B of lens 4907 are left on, whose extreme emission directions are confined between the directions of rays 4906 and 4908 (as they enter the eye pupil 4916). The same procedure may be applied for all other lenses in the array. In this process, only areas 4909A, 4909B, 4909C of the display are left on. All other areas are off and do not emit any light. In this possible configuration, the edge rays of the pencils emitted by the different lenses in the array cross at point 4910 at the center of the eye pupil 4911. However, in other embodiments, said crossing point 4910 could be located at other positions.

All the light from lit area (cluster) 4909A of lens 4904 when deflected through lens 4907 will be emitted below edge ray 4912 and will cross the plane of the pupil 4915 below point 4913. Similarly, another lens will emit light from the lit area of the lens above it below point 4913 and will not enter into the pupil. This is because cluster 4909A does not correspond to lens 4907 but to lens 4904. Also, each lens will emit above a symmetrical point to 4913 (not shown) the light from clusters below its corresponding one. Point 4913 is located below the bottom edge 4914 of eye pupil 4911. The symmetrical to point 4913 (not shown) is located above the top edge 4916 of the eye pupil.

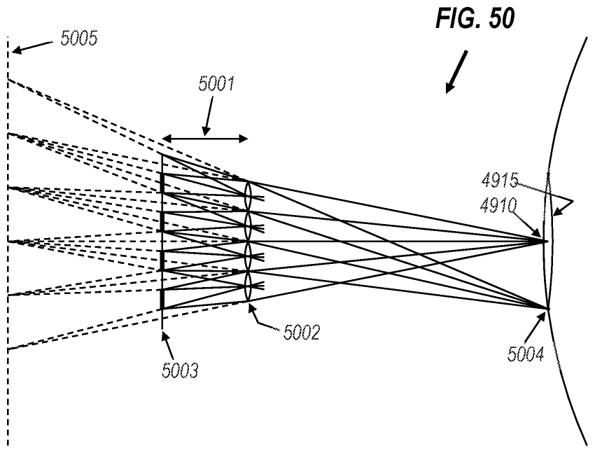

FIG. 50 shows a modification of the configuration in FIG. 49 in which the distance 5001 between lens array 5002 and display 5003 increases to the situation in which point 4913 touches the edge 4914 of the pupil 4915, and both coincide at position 5004 (same as 4914). The configuration in FIG. 50 then has a larger value of distance 5001 when compared to 4704 in FIG. 49. In order to maintain the size of the virtual image 5005, the size of display 5003 also increases. A larger distance 5001 between lens array 5002 and display 5003 is consistent with a longer focal length of the lenses in the array, which will produce a higher resolution virtual image 5005.

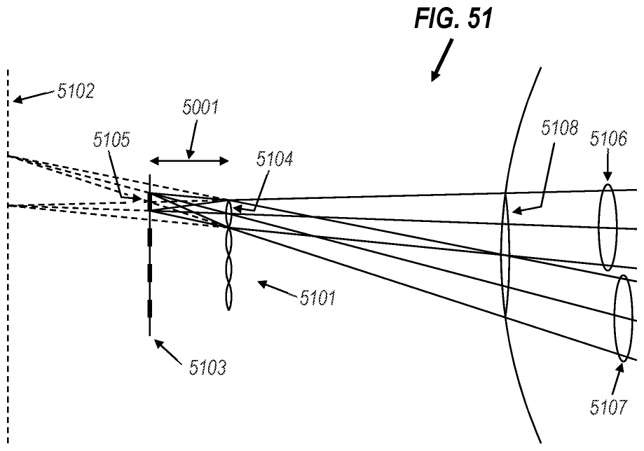

FIG. 51 shows the same configuration in FIG. 50 but highlighting the edge pencils of one lens in the array. Lens array 5101 creates a virtual image 5102 from the information show in display 5103. In particular, lens 5104 creates a virtual image of its cluster 5105 whose pencils are bound by edge pencils 5106 and 5107 entering the eye pupil 5108.

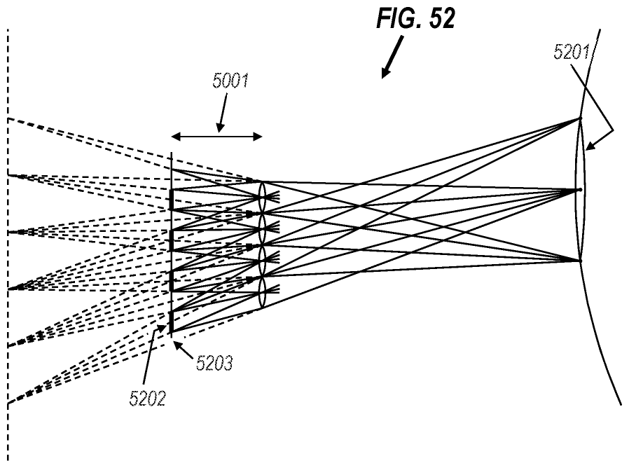

FIG. 52 shows a configuration similar to that in FIG. 50, but now for a different pupil position 5201. As the pupil moves, the lit areas 5202 in display 5203 also move to follow the pupil movement. The system performs pupil tracking.

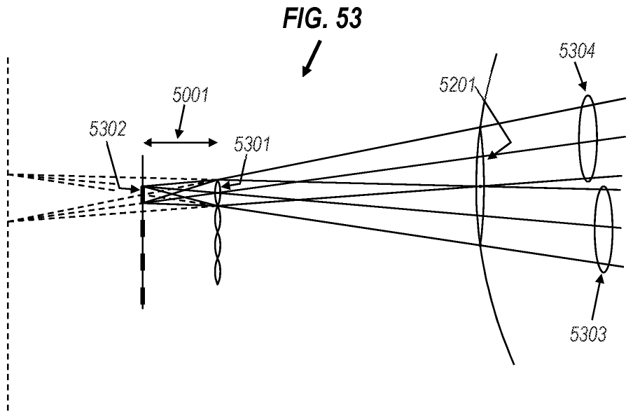

FIG. 53 shows the same situation as FIG. 51 but for the pupil position 5201 as in FIG. 52. Lens 5301 creates a virtual image of its cluster 5302 whose pencils are bound by edge pencils 5303 and 5304 entering the eye pupil 5201.

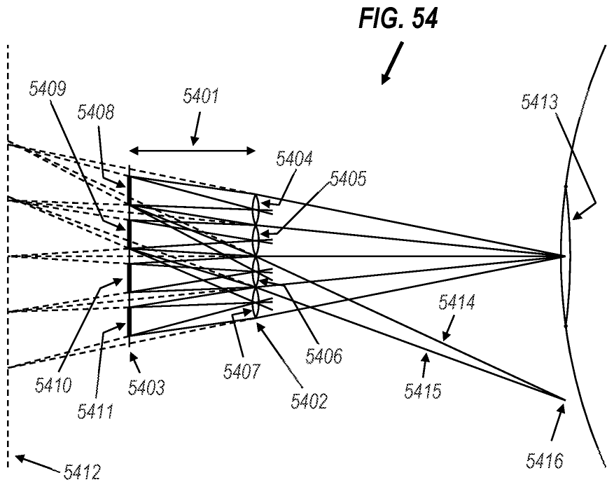

FIG. 54 shows a configuration similar to that in FIG. 50 but with an increased distance 5401 between lens array 5402 and display 5403. A larger distance 5401 between lens array 5402 and display 5403 is consistent with a longer focal length of the lenses in the array, which will produce a higher resolution virtual image 5412. Lenses 5404, 5405, 5406 and 5407 have lit areas (clusters) 5408, 5409, 5410 and 5411 respectively. If lens 5405 would transmit light emitted from 5408, it would enter the pupil 5413 in this example. In that case, two lenses 5404 and 5405 would send light into the pupil 5413 from lit area 5408 with conflicting information, and so producing cross-talk. In order to avoid that, lens 5405 must not transmit light emitted from lit area 5408. This may be achieved, in this case, using orthogonal polarization filters, which may be combined with time multiplexing strategies. Lens 5405 will transmit light from odd clusters such as its own cluster 5409 and cluster 5411, but will not transmit light from even clusters such as 5408 or 5410. Accordingly, lens 5406 will transmit light from its cluster 5410 and other even clusters such as 5408, but will not transmit light from odd clusters 5409 or 5411. Similar transmission characteristics hold for all other lenses that transmit light from every other lit area. The cross-talk condition through lens 5406 is now defined by the bottommost point of lit area 5408 and bound by ray 5414. Accordingly, the cross-talk condition through lens 5407 is defined by the bottommost point of lit area 5409 and bound by ray 5415. In this configuration there is, therefore, no cross-talk because all cross-talk light falls outside the pupil. All cross-talk light at the plane of the pupil will be below point 5416 and therefore clearly outside the pupil.

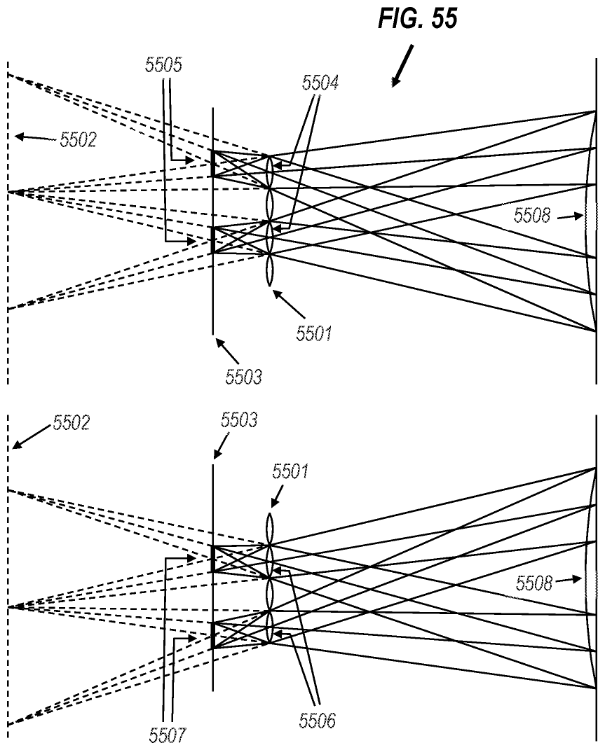

FIG. 55 shows a configuration in which a lens array 5501 generates a virtual image 5502 from the information shown in a display 5503. A set of alternate lenses 5504 substantially generates the full virtual image 5502 from the information shown in clusters 5505. Another set of different alternate lenses 5506 substantially generates the full virtual image 5502 from the information shown in clusters 5507. The light crossing said lenses 5504 and 5506 coming from clusters 5505 and 5507 respectively enters eye pupil 5508 and is visible.

Since both sets of lenses 5504 and 5506 generate overlapping virtual images 5502, said sets of lenses may be interlaced to increase the perceived resolution of virtual image 5502. Interlaced means here that the image of the green pixels of the display 5503 on the viewer's eye retina when seen through lenses 5504 are such that do not coincide with the image of the green o-pixels seen through lenses 5506, but are slightly shifted so the resolution (in pixels per degree) of the addition of the 2 images is greater than the one of any of them. The shifting is in the order of the green o-pixels diameter. Similarly with other colors.

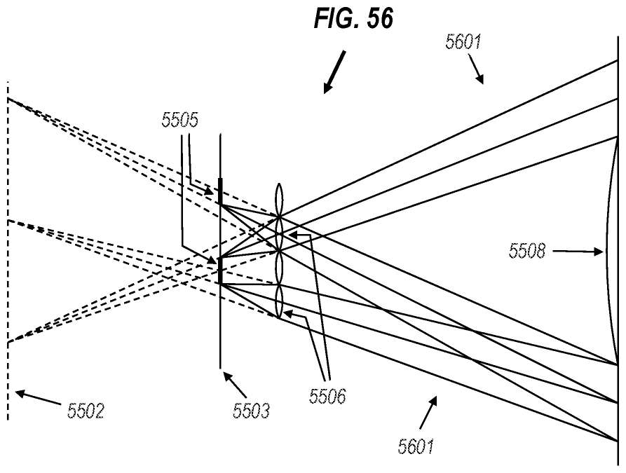

FIG. 56 shows the same configuration as FIG. 55. Pencils 5601 emitted from clusters 5505 through lenses 5506 miss the pupil 5508 and therefore are not visible. Accordingly, and referring also to FIG. 55, pencils (not shown) emitted from clusters 5507 through lenses 5504 also miss the pupil and are not visible. This is the condition of no cross-talk between lenses.

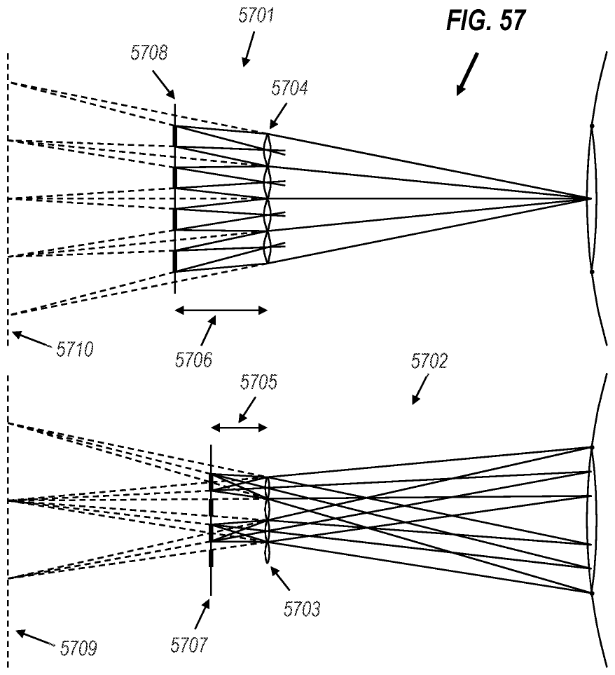

FIG. 57 shows a comparison of configuration 5701, the same as in FIG. 50 and configuration 5702, the same as in FIG. 55. One can see that configuration 5702 has smaller lenses 5703 than lenses 5704. Therefore, more lenses 5703 are needed to cover the same field of view. Configuration 5702 has a shorter distance 5705 between lenses 5703 and display 5707 when compared to a larger distance 5706 between lenses 5704 and display 5708. Configuration 5702 has lenses with a shorter focal distance and is therefore a more compact configuration than 5701. Short focal distance lenses 5703 produce a lower resolution virtual image 5709 while long focal distance lenses 5704 produce a higher resolution virtual image 5710. However, the different sets of lenses in configuration 5702 may be interlaced, increasing the perceived resolution of composite virtual image 5709.

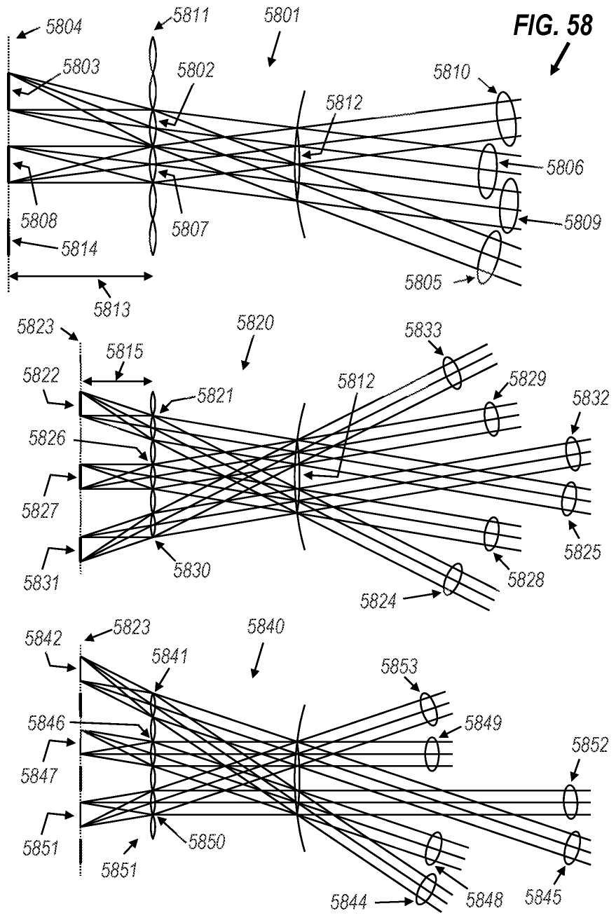

FIG. 58 shows similar configurations to those in FIG. 57 but now in the particular case in which the virtual images 5710 and 5709 are at a very large distance when compared to the overall size of the optic (in the limit case, at an infinite distance). Said virtual image planes at a very large distance are not shown in FIG. 58. Rays are shown crossing the eye pupil 5812 in an undisturbed manner. This is only for illustration purposes and to separate the different bundles. In reality said light is imaged by the eye at its retina.

Configuration 5801 includes lens 5802 that forms a virtual image at an infinite distance of cluster 5803 of display 5804. The light forming said virtual image enters eye pupil 5812 and is contained between the directions of bundles 5805 and 5806. Configuration 5801 also includes lens 5807 that forms a virtual image at an infinite distance of portion 5808 of the display 5804. The light forming said virtual image is contained between the directions of bundles 5809 and 5810. Since bundles 5806 and 5809 have the same direction, the set of two lenses 5802 and 5807 create a virtual image contained between the directions of bundles 5805 and 5810. Adding more lenses to the array 5811 concatenates portions of the virtual image, increasing its angular size. In general, some overlap of the virtual images formed by each lens may be allowed. The size of the lens 5802 or 5807 is essentially half the size of pupil 5812. Configuration 5801 has a focal length 5813.

Also shown in FIG. 58 are two views 5820 and 5840 of the same configuration. Referring to configuration 5820, lens 5821 takes light from cluster 5822 of display 5823 and forms a partial virtual image at an infinite distance. The light forming said virtual image enters eye pupil 5812 and is contained between the directions of bundles 5824 and 5825. Lens 5826 forms a partial virtual image at an infinite distance of cluster 5827 of display 5823. The light forming said virtual image enters eye pupil 5812 and is contained between the directions of bundles 5828 and 5829. The direction of bundle 5828 is parallel to that of bundle 5825. Lens 5830 forms a virtual image at an infinite distance of cluster 5831 of display 5823. The light forming said virtual image enters eye pupil 5812 and is contained between the directions of bundles 5832 and 5833. The direction of bundle 5832 is parallel to that of bundle 5829. Similarly to what happened in configuration 5801, also here lenses 5821, 5826 and 5830 form a continuous virtual image by concatenating different partial virtual images created by the different lenses. The size of the eye pupil 5812 is essentially twice the size of lenses in lens array 5811.

Referring to configuration 5840, lens 5841 takes light from cluster 5842 of display 5823 and forms a partial virtual image at an infinite distance. The light forming said virtual image enters eye pupil 5812 and is contained between the directions of bundles 5844 and 5845. Lens 5846 takes light from cluster 5847 of display 5823 and forms a partial virtual image at an infinite distance. The light forming said virtual image enters eye pupil 5812 and is contained between the directions of bundles 5848 and 5849. Lens 5850 takes light from cluster 5851 of display 5823 and forms a partial virtual image at an infinite distance. The light forming said virtual image enters eye pupil 5812 and is contained between the directions of bundles 5852 and 5853. Similarly to what happened in configuration 5801, also here lenses 5841, 5846 and 5850 form a continuous virtual image by concatenating different partial virtual images created by the different lenses. The size of the eye pupil 5812 is essentially three times the size of lenses in lens array 5851.

Referring back to configuration 5801, one may see that it has a long focal length 5813 resulting in a high resolution virtual image.

The lens array in configurations 5820 and 5840 is composed of two families of lenses: 5821, 5826, 5830 and 5841, 5846, 5850. Each one of these families creates a full virtual image. The device in configurations 5820 and 5840 has a shorter focal length 5815 than the device in configuration 5801. This results in a more compact device but the virtual images created by the two families of lenses have a corresponding lower resolution. However, said lens families may be interlaced to increase the resolution of the device.

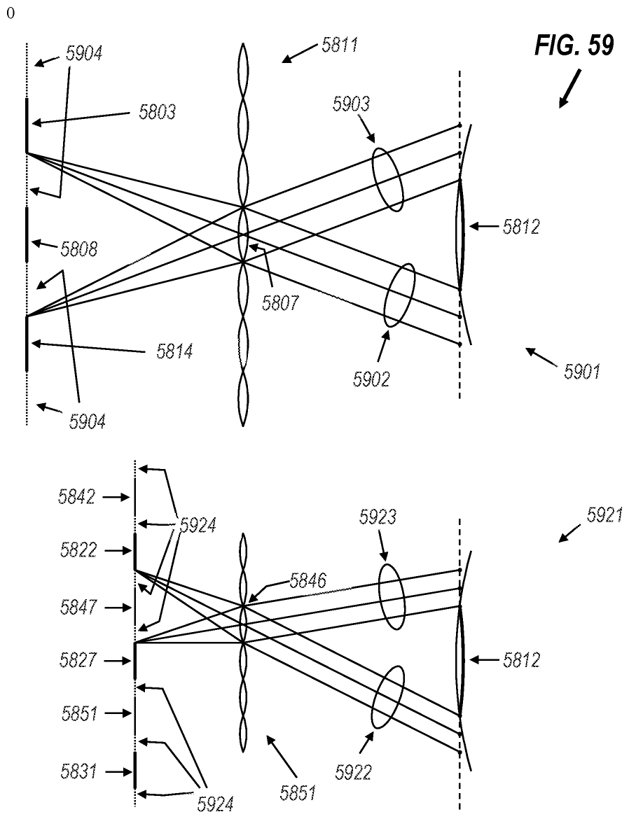

FIG. 59 shows configuration 5901, the same as configuration 5801 in FIG. 58. Light emitted from clusters 5803 and 5814 through lens 5807 will fall outside eye pupil 5812. This is called the cross-talk condition and is illustrated by bundles of rays 5902 and 5903 emitted from the edges of clusters 5803 and 5814. Areas 5904 of the display are off and do not emit any light. From configurations 5801 in FIGS. 58 and 5901 in FIG. 59 one can see that the only display light reaching the eye pupil through lens 5807 is that coming from cluster 5808. Similar conclusions may be reached for the other lenses in array 5811.

Also shown in FIG. 59 is configuration 5921, the same as configurations 5820 and 5840 in FIG. 58. Light emitted from clusters 5822 and 5827 through lens 5846 will fall outside eye pupil 5812. This cross-talk condition is illustrated by bundles of rays 5922 and 5923 emitted from the edges of clusters 5822 and 5827. Areas 5924 of the display are off and do not emit any light. From configurations 5820 and 5840 in FIGS. 58 and 5921 in FIG. 59 one can see that the only display light reaching the eye pupil through lens 5846 is that coming from cluster 5847. Similar conclusions may be reached for the other lenses in array 5851.

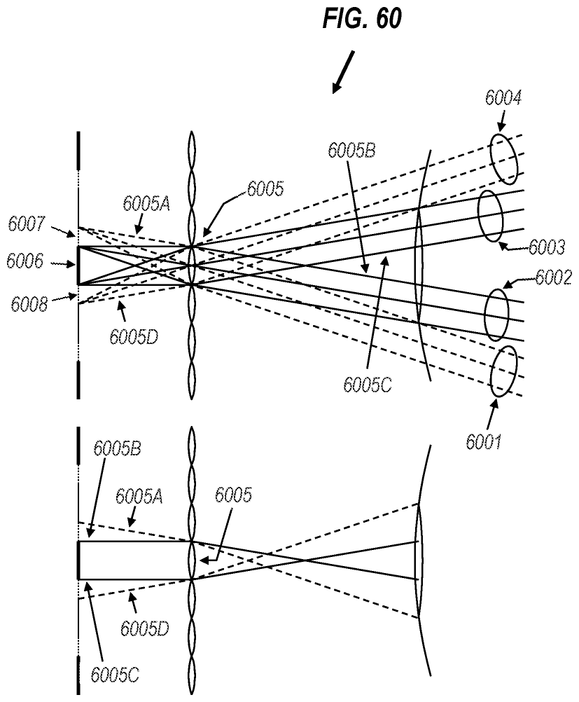

FIG. 60 shows four sets of edge rays 6001, 6002, 6003, 6004 crossing lens 6005. Said bundles 6002 and 6003 originate at the edges of cluster 6006 while bundles 6001 and 6004 originate at the edges of dark areas 6007 and 6008 respectively. From said bundles we take four representative rays, one per bundle. Those are rays 6005A, 6005B, 6005C and 6005D of bundles 6001, 6002, 6003, 6004 respectively. We name rays 6005A, 6005B, 6005C and 6005D through lens 6005 as being of A-type, B-type, C-type and D-type.

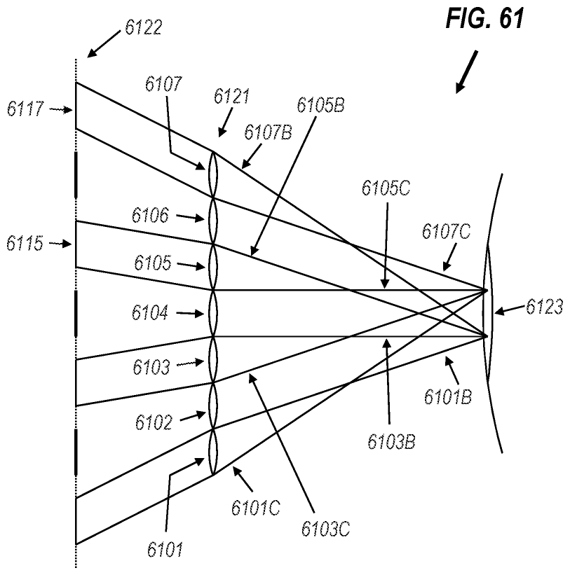

FIG. 61 shows a lens array 6121 facing a display 6122. Also shown are rays 6107B and 6107C starting at the edges of cluster 6117 and crossing the edges of lens 6107. Said lens 6107 generates fields whose directions are contained between those of rays 6107B and 6107C as they cross eye pupil 6123. Rays 6105B and 6105C starting at the edges of cluster 6115 cross the edges of lens 6105. Said lens 6105 generates fields whose directions are contained between those of rays 6105B and 6105C as they cross eye pupil 6123. Rays 6107C and 6105B are parallel so the directions of the fields through lenses 6107 and 6105 fill all directions between those of rays 6107B and 6105C as they cross eye pupil 6123. Accordingly, lens 6103 generates fields whose directions are contained between those of rays 6103B and 6103C as they cross eye pupil 6123. Also, lens 6101 generates fields whose directions are contained between those of rays 6101B and 6101C as they cross eye pupil 6123. Rays 6105C and 6103B are parallel and so are rays 6103C and 6101B. The family of lenses 6101, 6103, 6105 and 6107 generates fields in all directions between those of rays 6101C and 6107B. The other family of lenses 6102, 6104, 6106 works in a similar way and also generates a set of partial virtual images which together form a continuous full virtual image visible through pupil 6123. The two full virtual images of said two families of lenses overlap. Said two full virtual images may be interlaced to increase the perceived resolution of the embodiment.

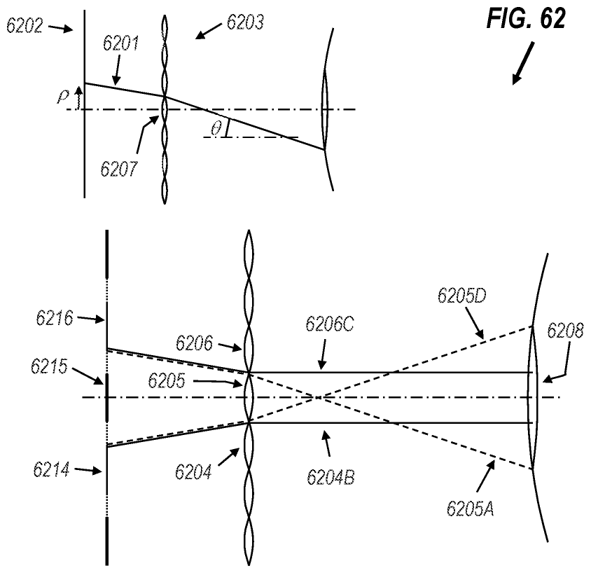

FIG. 62 shows a ray 6201 that leaves display 6202 at a height ρ, crosses lens array 6203 and emerges from it in a direction making an angle θ to the horizontal as seen by the eye. Lens 6207 may then the characterized by a mapping ρ(θ) that defines the display emission ρ coordinate for each field direction θ.

Also shown is lens 6206 with its cluster 6216 and ray 6206C from the bottom of cluster 6216 through the bottom of lens 6206. Lens 6205 with its cluster 6215, ray 6205A from the bottom of cluster 6216 through the top of lens 6205 and ray 6205D from the top of cluster 6214 through the bottom of lens 6205. Lens 6204 with its cluster 6214 and ray 6204B from the top of cluster 6214 through the top of lens 6204. Rays 6205A and 6206C have the same ρ value. Rays 6206C and 6204B have the same θ value.

Comparing FIG. 62 with FIG. 61 one may see that lenses 6204 and 6206 belong to the same family of lenses while lens 6205 belongs to a different family of lenses.

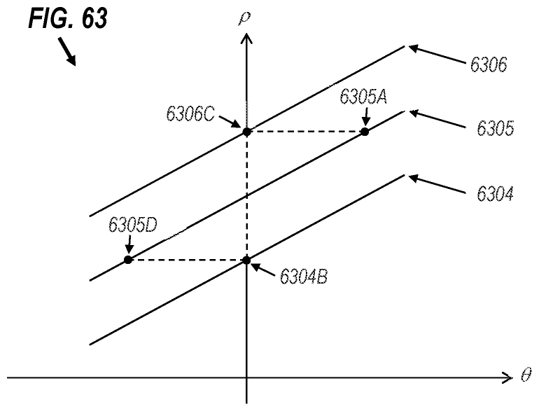

FIG. 63 shows curves 6304, 6305, 6306 representing the mappings of lenses 6204, 6205, 6206 respectively of FIG. 62. Points 6305A, 6305D, 6304B and 6306C represent, respectively, rays 6205A, 6205D, 6204B and 6206C of FIG. 62. One may see from the representation in FIG. 63 that rays 6304B and 6306C have the same θ value and are therefore parallel as also shown in FIG. 62. Rays 6305D and 6304B have the same ρ value and so do rays 6306C and 6305A as also shown in FIG. 62.

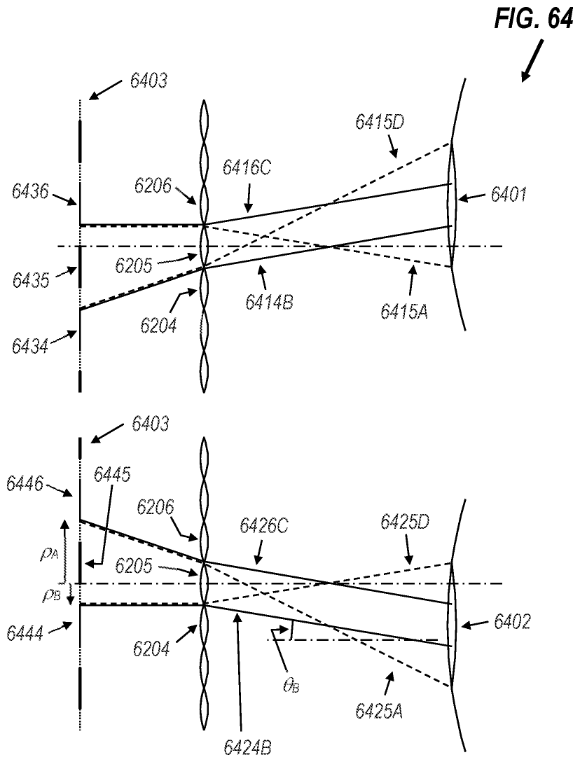

FIG. 64 shows different configurations of the embodiment in FIG. 62. When eye pupil 6208 moves to position 6401, clusters 6214, 6215 and 6216 move in display 6403 (via software) to positions 6434, 6435, 6436. Rays 6205A, 6204B, 6206C and 6205D now have trajectories 6415A, 6414B, 6416C and 6415D. Again rays 6415A and 6416C have the same ρ value on the display and so do rays 6414B and 6415D. Rays 6414B and 6416C have the same θ value. When eye pupil 6208 moves to position 6402, clusters 6214, 6215 and 6216 move in the display (via software) to positions 6444, 6445, 6446. Rays 6205A, 6204B, 6206C and 6205D now have trajectories 6425A, 6424B, 6426C and 6425D. Again rays 6425A and 6426C have the same ρ value on the display and so do rays 6424B and 6425D. Rays 6424B and 6426C have the same θ value.

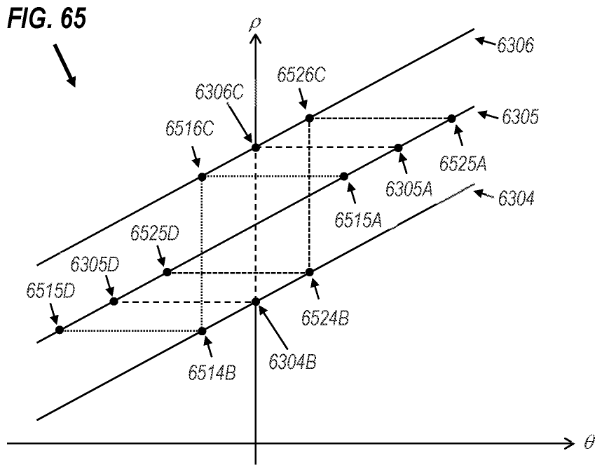

FIG. 65 shows the same diagram as in FIG. 63 but how with extra points 6515A, 6514B, 6516C and 6515D representing rays 6415A, 6414B, 6416C and 6415D; and with extra points 6525A, 6524B, 6526C and 6525D representing rays 6425A, 6424B, 6426C and 6425D. Therefore, the three dashed lines in FIG. 65 represent three different pupil positions.

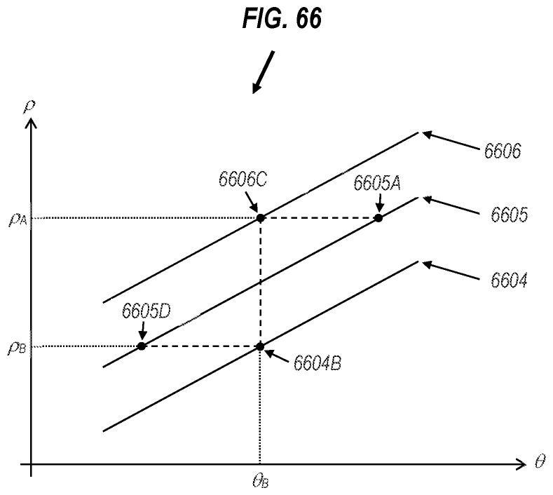

FIG. 66 shows another diagram similar to that in FIG. 63. Now, referring back to FIG. 64, assume that the mapping of lenses 6204 and 6205 are known. One may then raytrace ray 6425D from the edge of pupil 6402 through lens 6205 and determine the (θ,ρ_{B}) coordinates of ray 6425D. This corresponds to point 6605D in mapping curve 6605 of lens 6205. Also, one may raytrace ray 6425A from the other edge of pupil 6402 through lens 6205 and determine the (θ,ρ_{A}) coordinates of ray 6425A. This corresponds to point 6605A in mapping curve 6605 of lens 6205. Now, one may trace ray 6424B from display coordinate ρ_{B} through lens 6204. The direction of ray 6424B after crossing lens 6204 will define direction 6B as it crosses pupil 6402. Now ray 6426C must have the same direction θ_{B} as ray 6424B when crossing the pupil. Also, ray 6426C must reach the display at coordinate ρ_{A} and this defines point 6606C that must have coordinates (θ_{B},ρ_{A}). Mapping curve 6606 of lens 6206 must then cross point 6606C. This process defines the position of mapping curve 6606 relative to mapping curves 6604 and 6605.

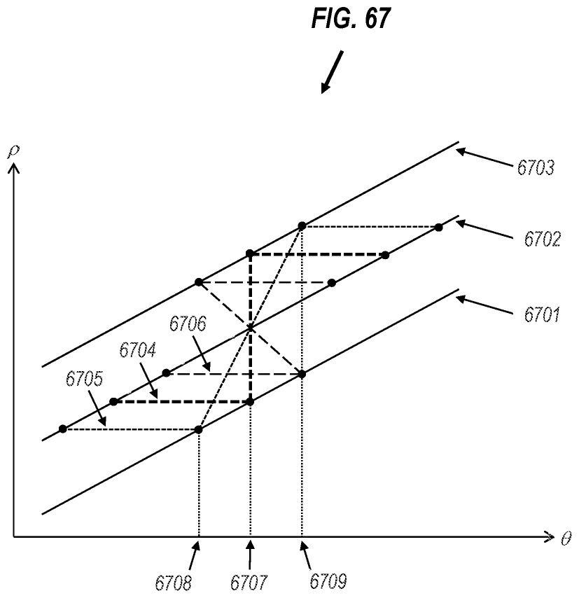

FIG. 67 shows a diagram similar to that in FIG. 66. We first refer to line 6704 which is similar to line 6605D-6604B-6606C-6605A in FIG. 66. The lens with mapping 6701 will emit light in directions below angle 6707 while the lens with mapping 6703 will emit light in directions above angle 6707. Therefore, there will be no gap between the images generated by the lenses of mappings 6701 and 6703. Also, there will be no overlaps.

We now refer to line 6705. The lens with mapping 6701 will emit light in directions below angle 6708 while the lens with mapping 6703 will emit light in directions above angle 6709. Therefore, there will be a gap between the images generated by the lenses of mappings 6701 and 6703. Said gap in the virtual image will range in directions from angle 6708 to angle 6709. This is not acceptable since this angular range would correspond to a dark area in the virtual image.

We now refer to line 6706. The lens with mapping 6701 will emit light in directions below angle 6709 while the lens with mapping 6703 will emit light in directions above angle 6708. Therefore, there will be an overlap between the images generated by the lenses of mappings 6701 and 6703. Said overlap in the virtual image will range in directions from angle 6708 to angle 6709. This is acceptable but may be not desirable.

As the pupil rotates, lines such as 6704, 6705 and 6706 will move up and down mapping curves 6701, 6702 and 6703 as was illustrated in FIG. 65. In free-form designs it must be ensured by design that, for all pupil positions, only lines such as 6704 and 6706 are present and there are no lines such as 6705 for any pupil position. In general, there will only be one pupil position for which a line such as 6704 is possible. That is the pupil position used to determine the mapping of 6606 based on the mappings of 6604 and 6605 using the method illustrated in FIG. 66.

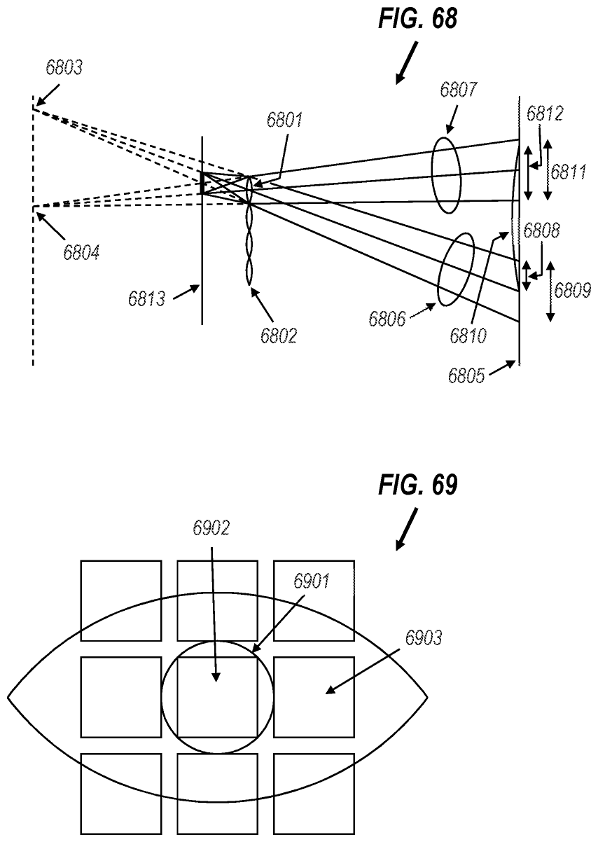

FIG. 68 highlights lens 6801 which is part of lens array 6802. Said lens creates a partial virtual image plane extending from 6803 to 6804. The light rays of said fields 6803 to 6804 constitute pencils 6806 and 6807 that cross lens 6801 and impact the pupil plane 6805 generating a pencil print on said pupil plane. In this example, the full pencil print of pencil 6806 on the pupil plane is 6809, but only a portion 6808 of said pencil falls inside pupil 6810. Also, the full pencil print of beam 6807 on the pupil plane is 6811, but only a portion 6812 of said pencil falls inside pupil 6810. The power carried by the rays of the pencil may be adjusted by software by adjusting the power of the corresponding o-pixel on display 6813. In so doing, the amount of light power entering the pupil is made independent of the portion of pencil print intercepted by the pupil to a certain extent.

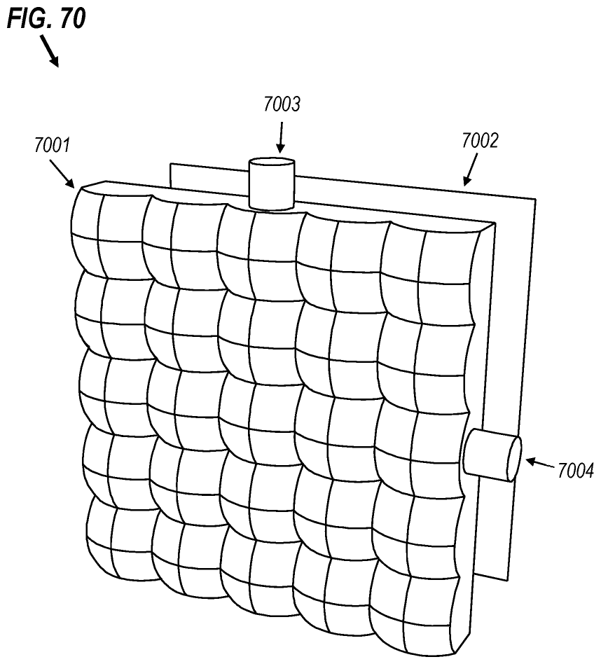

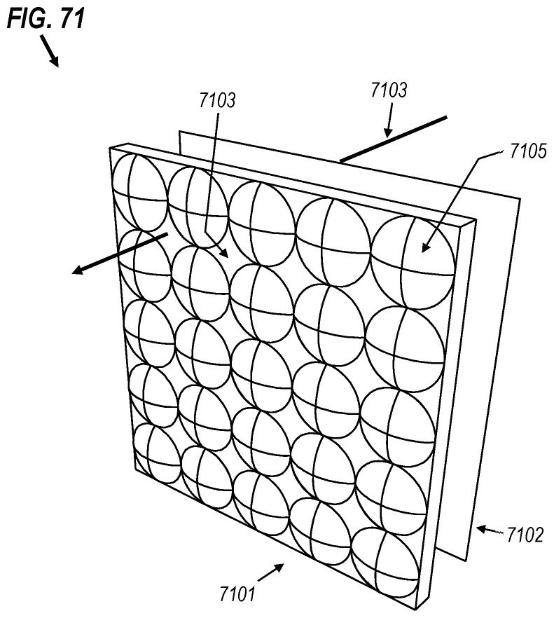

FIG. 69 shows the underfilling design of a square-like lesnlet array with highest possible resolution for a given pupil diameter 6901. In three-dimensions, this union of all inner pencil prints on the pupil plane (that is, those pencils produced by o-pixels that belong to clusters illuminating the eye through its corresponding lenslets) approximately occupy square 6902 inside the pupil, while the outer lit pencils (that is, those produced by o-pixels that belong to clusters illuminating the eye through lenslets different from its corresponding ones) occupy the areas outside the pupil, as 6903. This design is the one with highest resolution because 6902 and 6903 are both tangent to the pupil, and lower resolution designs reduce the square areas allowing for pupil diameter variations without producing crosstalk. The ratio of the cluster side to the cluster-plus-half dark corridor in this highest resolution design is 0.55, which is lower than the value obtained by a 2D calculation (which can fully illuminate the pupil), which goves 0.66.

FIG. 70 shows microlens array 7001 paired with display 7002. Also shown are actuators 7003 and 7004, preferably piezoelectric, that may move the lens array in the vertical and horizontal directions. These movements, synchronized with the display content, can be used to minimize scintillations in perceived image brightness when the eye moves and intersects different pencils, in which some pencils leave the eye pupil while others enter the eye pupil. Said configuration may also be used to interlace different partial virtual images which are generated by time-multiplexing the real images on the display 7002 and synchronizing these partial images with the lens array positions resulting in a perceived higher resolution image.

A similar effect can be achieved by introducing a synchronized beam steering element in the optical path, which slightly deflects the light. Diffractive or diffractive ones can be used, as those described in the literature using LC materials, or a birefringent tapered plate, so the taper angle can be designed for the different refractive indices of ordinary and extraordinary rays to make o-pixels of different polarizations to be emitted in slightly different directions, causing a proper image interlacing.

FIG. 71 shows a microlens array 7101 facing a transparent display 7102. There are gaps 7103 between microlenses that allow incoming light such as 7104 to pass through, providing a see-through configuration for Mixed Reality applications assuming the display is transparent (and may be pixel-free) at least in the area behind the gaps. Lenses 7105 image their respective clusters on display 7102 creating a virtual image. This combination allows a virtual image to be superimposed on the real world view.

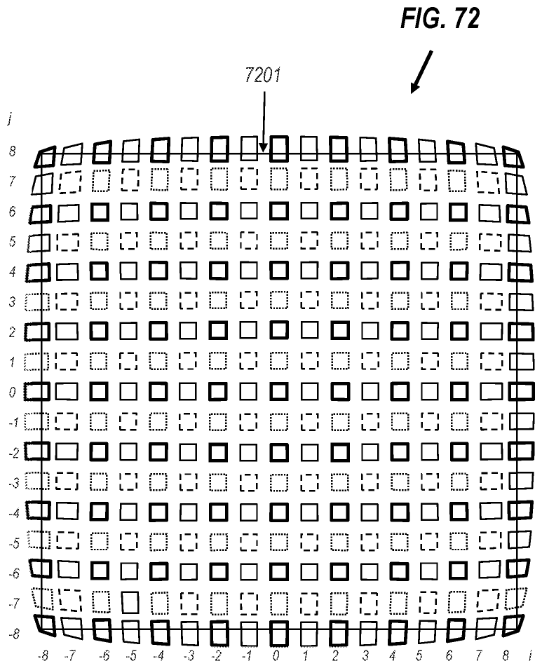

FIG. 72 shows display 7201 of a preferred embodiment showing the clusters of different lens families. There are four families identified with different line types. Those portions of each cluster that fall outside the display will not appear. In this exemplary configuration the clusters have quadrant symmetry and the eye is assumed to be looking forward. The diagram in FIG. 72 corresponds to the extension to three-dimensional geometry of display 6122 and its clusters in FIG. 61.

Display 7201 is paired with a lens array. There is one lens over each cluster shown.

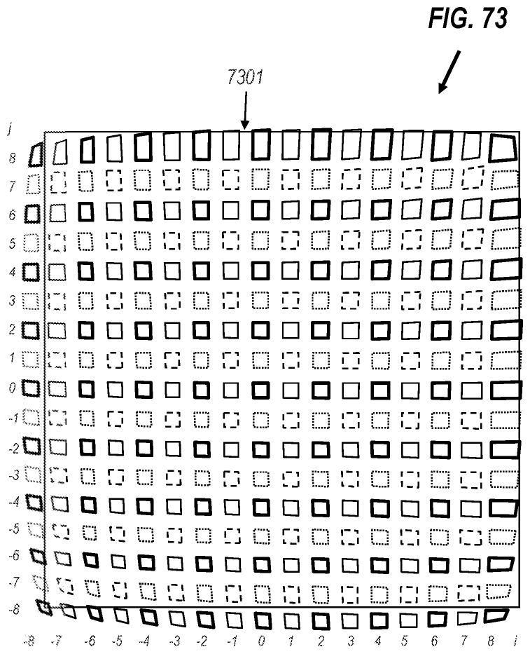

FIG. 73 shows a diagram similar to that in FIG. 72. It shows clusters of different lens families on display 7301. Those portions of each cluster that fall outside the display will not appear. In this exemplary configuration the clusters have moved following the eye movement in a configuration with eye tracking. The diagram in FIG. 73 corresponds to the extension to three-dimensional geometry of display 6403 in FIG. 64 as the eye pupil moves and the system performs eye tracking.

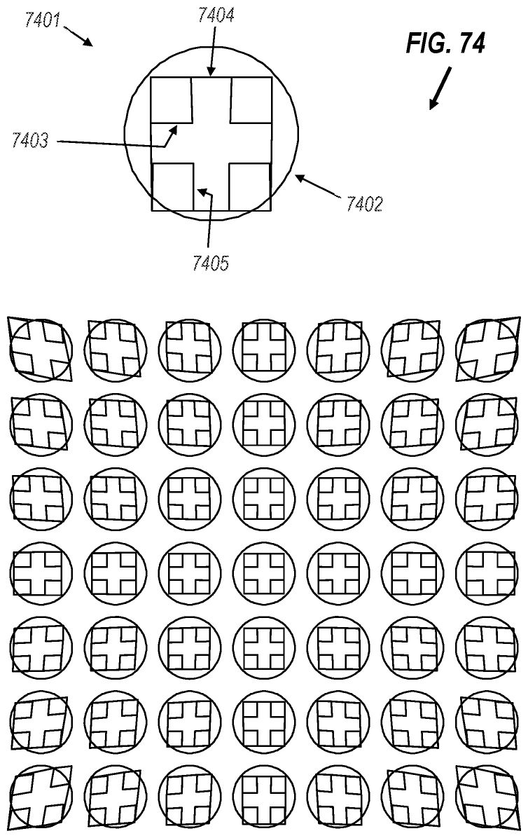

FIG. 74 shows a matrix of some diagrams. One diagram (shown in greater detail in 7401) corresponds to the extension to three-dimensional geometry of the pencil print impacts on the plane of the pupil 6805 generated by lens 6801 in FIG. 68. A different diagram corresponds to the extension to three-dimensional geometry of the pencil print impacts on the pupil plane 6805 generated by a different lens in array 6802 in FIG. 68. The set of diagrams in FIG. 74 all belong to the same family of lenses, paired with corresponding family of display clusters, as shown in FIG. 72.

The eye pupil has a periphery 7402 that corresponds to pupil size 6810 in FIG. 68. Each pencil will have a pencil (or beam) print 7403 that corresponds the pencil prints of pencils 6806 or 6807 on the plane of the pupil 6805 as illustrated in FIG. 68. Cluster beam print 7404 is the convex hull of all pencil prints (the exterior boundary of the sum of all pencil beam prints), or the beam print of the whole cluster on the plane of the pupil.

It may be seen that some pencil prints such as 7403 fall completely inside pupil 7402. However, other pencil prints such as 7405 may fall partially outside the pupil 7402. If this happens, the brightness of the corresponding display o-pixel which feeds that pencil must be increased to compensate the lost power not entering the pupil. This software adjustment of o-pixel brightness is a function of the pupil size and pupil position.

4. The G(θ)=sin(θ) Case

This section discloses a design example of a system using underfilling strategy with foveal variable magnification given by the function G(θ)=sin(θ) (see section starting in [0169]), and also using interlacing strategy with k=2. The optics includes a continuous lens (called conforming lens) common to all channels and an array of lenslets, each one of them corresponding to a single channel. The lenslet array is made up of two arrays of microlenses. As always, each lenslet has a corresponding cluster. This cluster plus all the optics associated to it (its lenslet and the conforming lenses) form a channel. In order to simplify the explanation we will assume that the virtual image surface is at infinity and we will refer only to the 2D geometry problem. Interlacing with degree k=2 implies that there are two channel families each one of them imaging its clusters into the full Field of View. Extension to 3D geometry is straightforward.

Conforming Lens Calculation

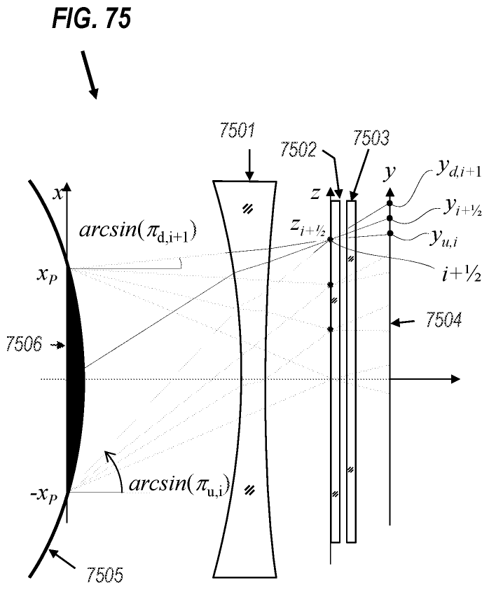

Let's start with the calculations of the conforming lens mapping functions. FIG. 75 shows a cross section of the conforming lens. This lens is formed by a curved lens 7501 plus two flat dielectric slabs 7502 and 7503. The eye globe 7505 and its pupil 7506 are shown on the left hand side. The role of the flat slabs will be clarified later.

Let y(x, p) and q(x, p) be the spatial coordinate and its cosine director at the digital display 7504 of the ray arriving at a point x on the eye pupil with angle θ=arcsin(p). We look for a conforming lens such that y(x, p)=(p+P₀(x))F, where F is a constant and P₀(x) is an arbitrary function of x. Conservation of etendue implies dxdp=dydq, so

$$\vert \begin{matrix}{y}_{x} & {y}_{p} \\ {q}_{x} & {q}_{p}\end{matrix} \vert = F ( {P}_{0 x} {q}_{p} - {q}_{x} ) = 1 .$$

This is a first order Partial Differential Equation in the function q(x,p), whose solution can be found by the methods of characteristics by solving Lagrange-Charpit related equations. The solution is given by q(x, p)=−x/F+Q₀(y(x, p)) where Q₀(y) is an arbitrary function of y. This equation together with the expression of y(x, p) give the 2 mapping functions from the space x,p into the space y,q. These equations can also be written as p=y/F−P₀(x) and q=−x/F+Q₀(y).

With this result we can calculate the Hamilton's characteristic function of this lens l(x,y), i.e., l(x,y) is the optical path length from the entry point x up to the exit point y along the ray linking both points. Then lₓ(x,y)=−p and l_{y}(x,y)=q. Using the last expression for p and q we get: lₓ(x,y)=P₀(x)−y/F and l_{y}(x,y)=−x/F+Q₀(y), whose integrations gives the Hamilton's characteristic function of this lens: l(x,y)=P₀(x)+Q₀(y)−xy/F, where P₀(x) and Q₀(y) are arbitrary functions of x and y respectively whose derivatives are P₀(x) and Q₀(y).

### Conforming Lens Example

Let's choose P₀(x)=x/G₁ and Q₀(y)=y/G₂. Then the mapping functions p=y/F−P₀(x) and q=−x/F+Q₀(y) become p=y/F−x/G₁ and q=−x/F+y/G₂, which can be written as

$$( \begin{matrix}p \\ q\end{matrix} ) = ( \begin{matrix}- {G}_{1}^{- 1} & {F}^{- 1} \\ {F}^{- 1} & {G}_{2}^{- 1}\end{matrix} ) ( \begin{matrix}x \\ y\end{matrix} ) ,$$

and so

$$( \begin{matrix}y \\ q\end{matrix} ) = ( \begin{matrix}F / {G}_{1} & F \\ F / ( {G}_{1} {G}_{2} ) - 1 / F & F / {G}_{2}\end{matrix} ) ( \begin{matrix}x \\ p\end{matrix} ) .$$

The Hamilton's characteristic function is l(x,y)=x²/(2G₁)+y²/(2G₂)−xy/F+l₀, where l₀ is an arbitrary constant.

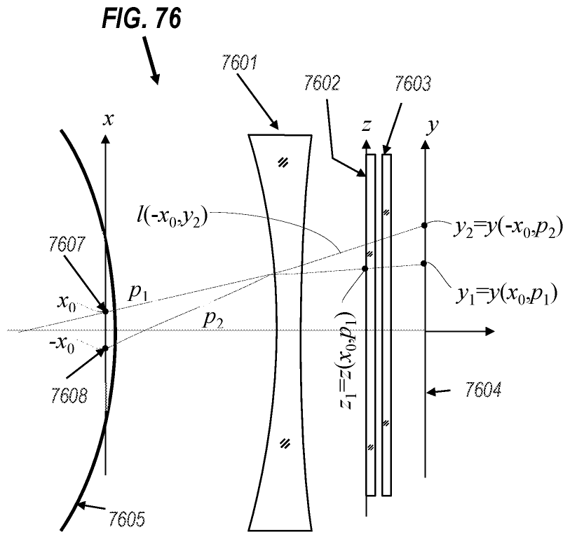

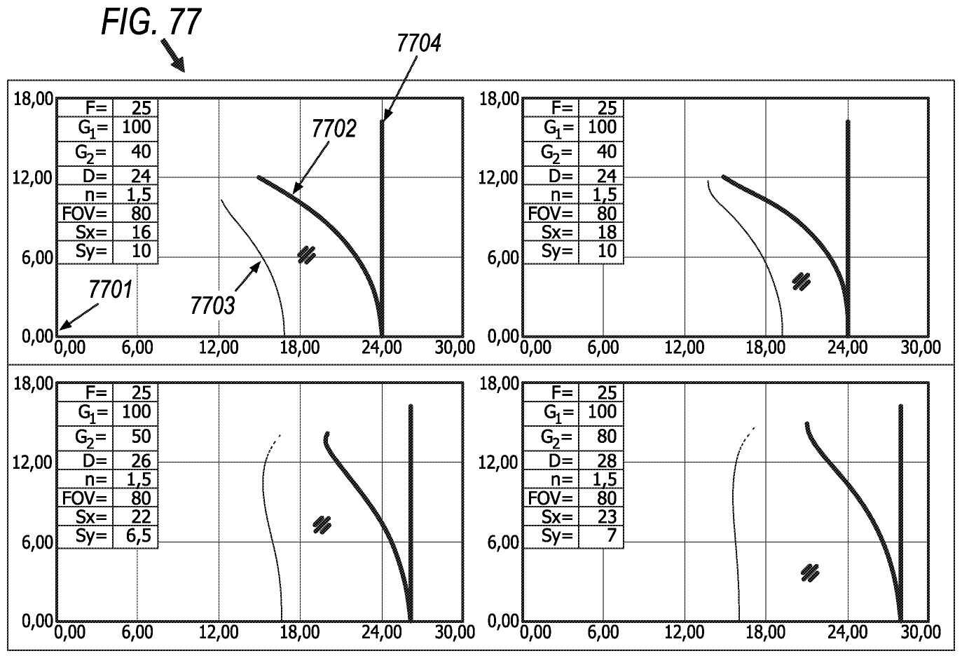

A 2-surfaces lens 7601 performing the mapping referred in [0307] at least in the neighborhood of x=0 (point 7607 at x=x₀ and point 7608 at x=−x₀) can be designed with an Simultaneous Multiple Surface (SMS) technique (see FIG. 76) and using the lens characteristic function l(x,y) in [0309] for the optical path length. The two dielectric slabs 7602 and 7603 thicknesses and positions as well as the constants G₁, G₂, and F as well as the refractive indices are assumed to be prescribed. FIG. 77 shows some design examples done with the SMS method. The dielectric thickness of the slabs is 0 in these examples. The center of the eye pupil is the coordinate origin 7701. The 2 surfaces of the lens are 7702 and 7703, and the plane of the display is at 7704. Lens' refractive index is 1.5.

Once the lens is designed, the function z(x,p) in the conforming lens system can be calculated by tracing back from the point y(x,p) along the ray with direction cosine q(x,p). If the refractive index is n, the total slabs thickness is T and D is the distance of the axis z to the axis y (see FIG. 75), then z(x,p)−y(x,p)=−(D−T)q(x,p)/\sqrt{1−q²(x,p)}−Tq(x,p)/\sqrt{n²−q²(x,p)}≈−(D−T(1−n⁻¹))q(x, p), where the rightmost expression is an approximation valid only for small values of q. Observe that because the slabs are flat, the direction cosine r of a rays at the z-axis is the same as the direction cosine at the y-axis, i.e. r=q. Then, using these expressions and Eq. [0308] we can obtain (z,r) as functions of (x,p). These 2 functions, z(x,p), and r(x,p), are linear if the preceding approximation is valid, i.e., when q is small.

In this approximated case

$$( \begin{matrix}z \\ r\end{matrix} ) = ( \begin{matrix}1 & - d \\ 0 & 1\end{matrix} ) ( \begin{matrix}F / {G}_{1} & F \\ F / ( {G}_{1} {G}_{2} ) - 1 / F & F / {G}_{2}\end{matrix} ) ( \begin{matrix}x \\ p\end{matrix} ) ,$$

where d=D−T(1−n⁻¹).

Total Mapping Functions

Let's substitute each flat dielectric slab 7502 and 7503 of FIG. 75 by a microlens array of similar thickness. The purpose of the flat slabs is to emulate macroscopically the behavior of the lenslet array. This lenslet array is made up of several microlens arrays (2 in our example). The thickness of each slab coincides with the average thickness of the microlens array that is being emulated. The set of microlens arrays have corresponding lenses so all together they constitute an array of lenslets, where each one of the lenslets has one microlens on every microlens array. Obviously, the mapping achieved when the slabs are substituted by the microlens arrays will be different from the mapping achieved without such substitution. The former case will be called the total mapping and the later is called conforming lens mapping. The purpose of the lenslet arrays remains as a “local tuning” of the conforming lens mapping. As a result, there are no big discontinuities in the lenslet arrays. Otherwise, at least one microlens array would look as a Fresnel lens with sharp discontinuities in the lens profile from one microlens to its neighbor. The total mapping functions yᵢ(x,p), qᵢ(x,p) give the departing point y of a ray and its direction cosine q at departure from the display, as a functions of the point and direction cosine of arrival x,p, when the 2 flat slabs of the conforming lens configuration have been substituted by the lenslet array. “i” is the lenslet index. We shall distinguish two families of lenslets: odd and even lenslets, depending on the value of i. These families correspond to the 2 families of channels needed in a interlacing strategy with k=2. Each one of the families will image its clusters into the full FOV so when a single eye sees simultaneously channels of both families the images produced by the different families overlap in the retina. In the interlacing strategy, the overlapping is such that the o-pixels of one family overlap with dark regions (or other color o-pixels) of the clusters of the other family, and vice versa, thus doubling (when k=2) the density of o-pixels of imaged on the retina. In 3D geometry k=2 may multiply by 4 the density of o-pixels imaged on the retina.

The goal for the total mapping (i.e., the mapping generated by the system when lenslet array substitutes the flat slabs of the initial conforming lens configuration) is to get this mapping function=yᵢ(p)≡fp+icₒ, where f and cₒ are constants and i is the lenslet number.

Again, conservation of etendue implies dxdp=dydq, so

$$\vert \begin{matrix}{y}_{x} & {y}_{p} \\ {q}_{x} & {q}_{p}\end{matrix} \vert = \vert \begin{matrix}0 & f \\ {q}_{x} & {q}_{p}\end{matrix} \vert = - {q}_{x} f = 1.$$

This equation gives a condition on the other function giving the total mapping which can be expressed as qᵢ(x,p)≡−x/f+A(p), where A(p) is an arbitrary function of p.

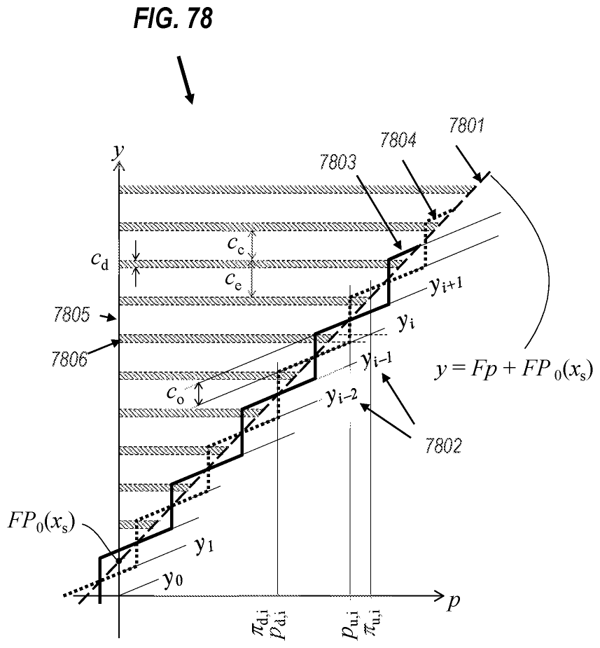

Note that the conforming lens mapping (i.e., the whole system with flat slabs instead of the lenslet array) is given by the equations in [0304]) one of which is y=Fp+FP₀(x). FIG. 78 shows this function 7801 in the p, y plane for x=xₛ. Some total mapping functions yᵢ(p) 7802 are also shown. Each one of these total mapping functions has its own angular span extending from p_{d,i} up to p_{u,i}. This is the angular span of the light sent by the lenslet from its cluster to the pupil. By joining the different segments corresponding to the odd lenslets on one side or the even lenslets on the other we can build the total mapping function for each lens family. The solid line 7803 is the total mapping function of one family of lenslets (odd or even), and the dotted line 7804 is the mapping for the other family. This type of diagram is similar to that shown in FIG. 63, FIG. 65, FIG. 66, and FIG. 67.

Let's analyze a regular cluster structure where all the clusters 7805 of the display have the same size, as well as the dark corridors 7806: c_{c} is the width of a cluster and c_{d} the one of the dark corridor between clusters so the pitch is cₑ=c_{c}+c_{d} (see FIG. 78). Solutions with different cluster sizes are discussed later in [0350]. For the regular solution, 2cₑ/c_{c}=F/f and cₑ=c_{c}/2+cₒ. Since cₑ>c_{c}, then F>2f.

The y coordinate of the edges of the dark region i+½ (this is the dark region between cluster i and cluster i+1), y_{u,i} and y_{d,i+1} are, when P₀(xₛ)=0, y_{u,i}=icₑ+c_{c}/2 and y_{d,i+1}=(i+1)cₑ−c_{c}/2.

Each cluster edge defines 2 angular boundaries of the lenslet span: The upper edge of the dark region i+½ defines the smallest emission angle of the cluster i+1, (p_{d,i+1}) and the greatest emission angle of the cluster i without cross-talk (π_{u,i}). Then, y_{d,i+1}=fP_{d,i+1}+(i+1)cₒ and y_{d,i+1}=fπ_{u,i}+icₒ. (see mapping in [0315]) The lower edge of the dark region i+½ defines the greatest emission angle of the cluster i. (p_{u,i}) and the smallest emission angle of the cluster i+1 without cross-talk (π_{d,i+1}). Then, y_{u,i}=fp_{u,i}+icₒ and y_{u,i}=fπ_{d,i+1}+(i+1)cₒ.

Summarizing these results and referring all of them to the cluster i, we get π_{u,i}/cₒ=i/(F−f)+f⁻¹, π_{d,i}/cₒ=i/(F−f)−f⁻¹, p_{u,i}/cₒ=(i+1)/(F−f) and p_{d,i}/cₒ=(i−1)/(F−f).

Observe that the clusters of the same family (odd or even) tile completely the FOV since p_{d,i+2}=p_{u,i}. The angular emission span of the lenslets change with the lenslet position but it is constant if it is expressed as a difference of the coordinate p at both edges, i.e., Δp=p_{u,i}−p_{d,i}=2cₒ/(F−f), and it is Δπ=π_{u,i}−π_{d,i}=2cₒ/f when the dark regions at both sides are also included. For both angular spans the midpoint is cₒi/(F−f).

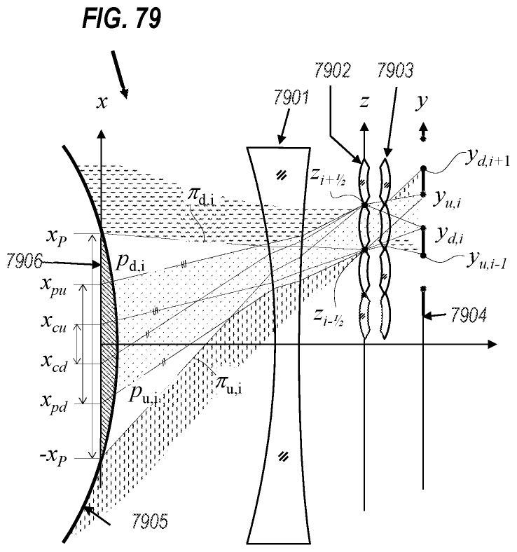

Let's call z to the coordinate on the exit plane of the lenslet array. FIG. 79 shows the trajectories of these edge rays from the cluster i of the digital display 7901, passing through the first 7903 and second 7902 microlenses of a lenslet i and passing later through the conforming lens 7901 to be directed to the eye 7905 and more precisely to the eye pupil 7906.

Eye Pupil Size

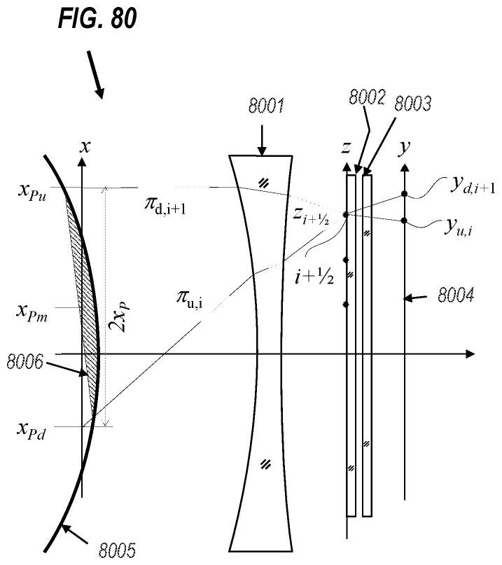

The preceding results determine the maximum size of the eye pupil free of cross-talk illumination. Consider the 2 rays issuing from a point of the z-axis with coordinate z_{i+1/2}, such that they reach the pupil with angles p=π_{d,i+1} and π_{u,i} (see FIG. 80). Using the equation in [0312] the next expression is got (pupil extends from −x_{P}<x<x_{P}), 2x_{P}=(π_{u,i}−π_{d,i+1})/(G₁⁻¹+F⁻²(d⁻¹−G₂⁻¹)⁻¹).

Observe that π_{d,i+1}−π_{u,i} does not depend on i, since π_{d,i+1}−π_{u,i}=Δπ−Δp, so neither the eye pupil location (−x_{P}<x<x_{P}) does. Replacing π_{d,i+1}−π_{u,i} and π_{d,k+1}+π_{u,k} we get.

$${x}_{P} = \frac{{c}_{o}}{2} F ( 1 - \frac{d}{{G}_{2}} ) ( \frac{2}{f} - \frac{1}{F - f} ) / ( ( 1 - \frac{d}{{G}_{2}} ) \frac{F}{{G}_{1}} + \frac{d}{F} ) ,$$

$${z}_{k + 1 / 2} = {c}_{o} F ( 1 - \frac{d}{{G}_{2}} ) \frac{k + \frac{1}{2}}{F - f}$$

In a similar way it is possible to calculate the lenslet exit aperture size Δz=(z_{i+1/2}−z_{i-1/2})=(1−d/G₂) F Δp/2. The y_{i+1/2} corresponding to this z_{i+1/2}, according to the Conforming lens mapping (x=0) (Eq. in [0308] and [0312]), is the mid-point of the dark region i+½, i.e., y_{i+1/2}=(y_{d,i+1}+y_{u,i})/2=cₑ(i+½)

Lenslet Spot Size on the Pupil

The edges of the lenslet i spot on the pupil plane are given by the coordinates xₚᵤ and x_{pd} (see FIG. 79). These are the points of interception of the rays issuing from the lenslet exit aperture edges (z_{i±1/2}) and reaching the x-plane with p=p_{d,1}, p=_{d,i+1}.

These coordinates can be calculated with the mapping functions from z to x plane as follows:

xₚᵤ: can be calculated using Eq. in [0312], [0321] and [0326] for z=z_{i+1/2}. The value obtained is xₚᵤ=x_{P}/[2F/(3f)−1] which results independent of i.

x_{pd}: can also be calculated using Eq. in [03129], [0321] and [0326] but for z=z_{i-1/2} The resulting value is x_{pd}=−xₚᵤ.

In order to capture inside the pupil all the light sent by any lenslet from its corresponding cluster we need this spot be smaller than the pupil size. i.e., xₚᵤ<x_{P}, which implies F/f>3, or, what is the same, Δπ/Δp>2.

Another interesting points are the intersections with the x-axis (x_{cu} and x_{cd}) of the rays issuing from z=z_{k±1/2} with directions p=p_{u,i} and p=p_{d,i}, respectively (see FIG. 79). Their calculation use the same equations as the calculations of xₚᵤ and x_{pd}. The result is x_{cu}=−x_{cd}=xₚᵤ/3. Then the intersection diameter (2x_{cu}) is ⅓ of the spot diameter (2xₚᵤ) and its size and position is independent of the particular lenslet i producing the spot.

Non-Centered Eye-Pupil

Let's recall the fixed parameters of the design, i.e., the parameters not depending on the eye pupil position (within the pupil range). These are: z_{i+1/2}, F, f, cₒ, and consequently (Eq. in [0318]) c_{c}, cₑ. On the contrary, the y coordinate of the edges of the dark region i+½ (this is the dark region between cluster i and cluster i+1), y_{u,i} and y_{d,i+1} slide accordingly to the pupil position because they depend on the value of P₀(xₛ). The center of the pupil x=xₛ determines P₀(xₛ) as shown in the equation in [0304]. In the Conforming lens example [0306]. P₀(xₛ)=xₛ/G₁, and in the example of [0313] xₛ=0, i.e., the pupil was centered. In this section we will analyze the performance of the design of previous section with non-centred pupils, ie, for xₛ≠0

The total mapping functions (Equations in [0315], [0316]) remain identical to the centered eye pupil case since the optics has not moved. Nevertheless, the edges of the clusters have changed because the eye tracking control has provided the information about the pupil position and the contents to be displayed in the display are modified accordingly. This means that the straight lines yᵢ(p) 7802 shown in FIG. 78 remain the same. The y coordinate determining cluster edges and dark corridors are shifted a constant amount of −F·P₀(xₛ). Consequently and due to the linear relationships of total mapping functions, any direction cosine boundary is shifted −F·P₀(xₛ)/If. Henceforth we will continue with the example where P₀(xₛ)=xₛ/G₁.

Summarizing the previous results and referring all of them to the cluster i, we have now

$${y}_{d , i} = {c}_{o} \frac{iF - f}{F - f} - \frac{F {x}_{s}}{{G}_{1}} , {y}_{u , i} = {c}_{o} \frac{iF + f}{F - f} - \frac{F {x}_{s}}{{G}_{1}}$$

$${π}_{u , i} = {c}_{o} ( \frac{i}{F - f} + \frac{1}{f} ) - \frac{{Fx}_{s}}{{fG}_{1}} , {π}_{d , i} = {c}_{o} ( \frac{i}{F - f} - \frac{1}{f} ) - \frac{{Fx}_{s}}{{fG}_{1}}$$

$${p}_{u , 1} = {c}_{o} \frac{i + 1}{F - f} - \frac{{Fx}_{s}}{{fG}_{1}} , {p}_{d , i} = {c}_{o} \frac{i - 1}{F - f} - \frac{F {x}_{s}}{{fG}_{1}}$$

Observe that again the clusters of the same family tile completely the FOV since p_{d,i+2}=p_{u,i}.

By applying the mapping functions to the rays issuing from a corner between lenslets z_{i+1/2}, such that they reach the pupil with angles p=π_{d,i+1} and p=π_{u,i} it is possible to calculate the coordinates x_{Pu} and x_{Pd} of the points where they reach the pupil

$$\frac{{x}_{Pu}}{( 1 - \frac{d}{{G}_{2}} ) F} = \frac{{c}_{o} \frac{( i + \frac{1}{2} )}{F - f} - {π}_{d , i + 1}}{( 1 - \frac{d}{{G}_{2}} ) \frac{F}{{G}_{1}} + \frac{d}{F}} , \frac{{x}_{Pd}}{( 1 - \frac{d}{{G}_{2}} ) F} = \frac{{c}_{o} \frac{( i + \frac{1}{2} )}{F - f} - {π}_{u , i}}{( 1 - \frac{d}{{G}_{2}} ) \frac{F}{{G}_{1}} + \frac{d}{F}}$$

The pupil size is again x_{Pu}−x_{Pd}=2x_{P}, which is independent of the lenslet number i and independent of the direction cosine shift. The pupil midpoint x_{Pm}=(x_{Pu}+x_{Pd})/2 is also independent of i (see FIG. 80)

The lenslet spot falls between xₚᵤ and x_{pd} which must be between the pupil edges x_{Pu} and x_{Pd}. Calculation of xₚᵤ and x_{pd}: Apply the first of [0312] to z=z_{i±1/2} (using Eq. in [0327]) and p=p_{d,i} or p=p_{u,k} (using Eq. in [0342]), and solve it for x. The resulting xₚᵤ and x_{pd} are independent of i.

$${x}_{pu} = {x}_{Pm} + \frac{{x}_{P}}{\frac{2 F}{3 f} - 1} , {x}_{pd} = {x}_{Pm} - \frac{{x}_{P}}{\frac{2 F}{3 f} - 1}$$

In order to capture inside the pupil all the light sent by the lenslet from its corresponding cluster we need this spot be smaller than the pupil size, i.e., F/f>3.

Non Regular Clusters

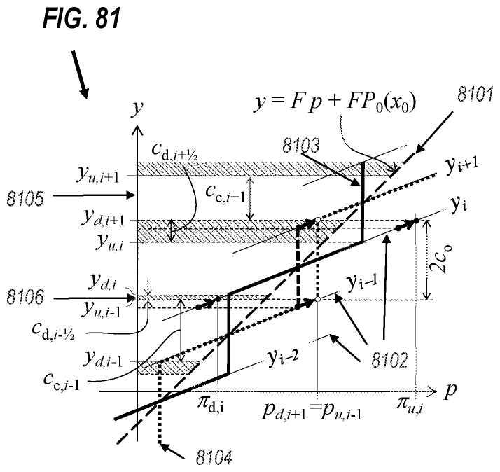

Irregularities in the cluster and corridor sizes may be caused by irregularities in the mapping functions (for instance when cₒ in Eq [0315] depends on i). This case is not considered here. We are going to consider the case in which the sizes of clusters (and dark corridors) are not the same but the mapping functions (Equation in [0315]) are still equi-spaced straight lines (lines 8102 in the example of FIG. 81). A greater emission angle of the cluster i−1 (p_{u,i-1}) must coincide with a smaller emission angle of the cluster i+1 (p_{d,i+1}) for a complete FOV tiling of one of the channel's family without overlapping. A lenslet channel comprises a cluster and all the optics through which the cluster emits. In the example of FIG. 81, the transition angle p_{d,i+1}=p_{u,i-1} (for the channel family whose mapping function is the dotted line 8104) has been shifted to the right relative to the regular arrangement shown in FIG. 78. This shift causes a narrowing of the (dotted) cluster i+1 (8105) whose width is c_{c,i+1} and that of the dark corridor i−½ (8105), (width c_{d,i-1/2}) and the expansion of the (dotted) cluster i−1 width c_{c,i-1} and that of the dark corridor i+½, c_{d,i+1/2}. The smallest emission angle of the cluster i without cross-talk (π_{d,i}) as well as the greatest emission angle of the cluster i without cross-talk (π_{u,i}) are also shifted to the right. These 2 shifts are the only changes affecting the other family of channels (those whose mapping function is the solid line 8104). The remaining clusters and corridors stay the same.

Any set of boundary y coordinates {y_{u,i}, y_{d,i}} can be realized provided that for any i the following conditions are fulfilled: (1) y_{d,i-1}<y_{u,i-1}<y_{d,i}<y_{u,i}, and (2) y_{d,i+1}−y_{u,i-1}=2cₒ.

The first condition establishes that any cluster or corridor must have a positive length and the second one ensures the full tiling of the FOV by any of the 2 channel families. We can have more room to accomplish this 2^{nd} condition by designing lenslets with mapping functions (Eq in [0315]) that have non regular constant term (i.e., different than i·cₒ) so the straight lines yᵢ(p) in FIG. 81 are not evenly spaced.

Using the freedom to choose the set of cluster boundaries {y_{u,i}, y_{d,i}} we can modify the regular arrangement of FIG. 78 to fine tune the edges of the pupil in FIG. 80.

5. Preferable G(θ) for a Prescribed Conforming Lens

There may be geometrical constraints that impose restrictions to the conforming lens shape and thickness, making its design as described in [0300] not adequate always. For that reason, it is of interest to estimate the function G(θ) for a given rotational symmetric conforming lens that allows to obtain a step-free lenslet array. To illustrate said calculation we will consider using eye tracking with underfilling strategy and interlacing factor 2, but the procedure is not restricted to this conditions. We will consider that the design must illuminate the eye pupil when looking frontward (which we will refer to with subindex 0) and when looking at the edge of the pupil range (which we will refer to with subindex 20). In the radial direction (α=0), the mapping function can be written as:

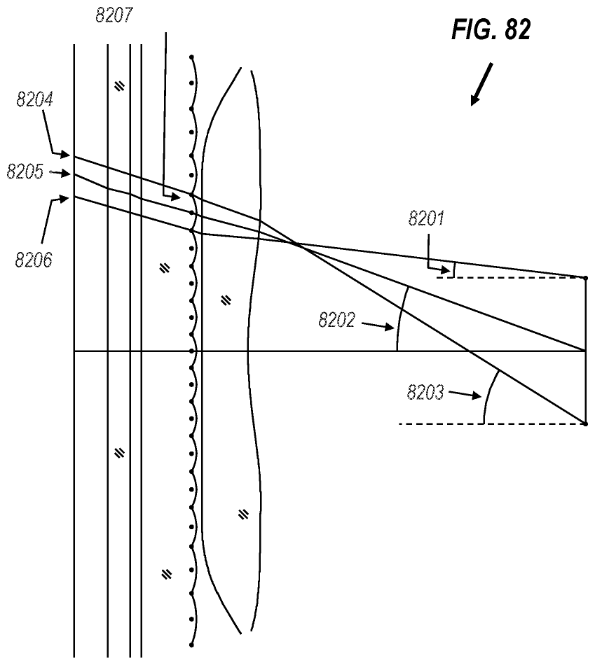

ρ=G(θ)+cₖ

where G(θ) is a function and cₖ is a constant, both to be determined. We call θₖ to angle 8202 shown in FIG. 82, defined on the ray trajectory that reaches the center of the pupil range that comes from the center of the aperture on lenslet k before passing through the conforming lens. Tracing that ray through the conforming lens and dummy flats (z=constant refractive planes) with the intended thicknesses of the lens arrays (two in the example of FIG. 82), we can find the height ρ=P(θₖ) of the point of intersection on the display 8205 (since the conforming lens is known P is therefore a known function). The condition that the array is flat can be well approximated by imposing that:

P(θₖ)=G(θₖ)+cₖ

From Equation [0359] cₖ is found, and thus the mapping can be rewritten as:

ρ=P(θₖ)+G(θ)−G(θₖ) (3)

We consider here the case in which θₖ₊₁−θₖ=Δ=constant, so all lenslets has the same angular aperture Δ. As already shown in [0249], for the lenslets at the central part of the field of view (i.e., for k≤kₜ, that transition value kₜ still to be found). the tiling of the a-plane that limits corresponds to the position of the pupil looking frontwards, while for k>kₜ is the pupil located at the rim of the pupil range which limits. Therefore, k≤kₜ, we have, first, the conditions of no cross talk with adjacent clusters, which is:

ρ_{B0,k+1}=P(θₖ)+G(α_{max0,k})−G(θₖ)

ρ_{T0,k-1}=P(θₖ)+G(α_{min0,k})−G(θₖ)

where α_{min0.k}, α_{max0.k}, ρ_{B0,k+1} and ρ_{T0,k-1} to ray angles 8201 and 8203 from the pupil edges and the heights 8204 and 8206 of the rim of the clusters of the adjacent lenslets in FIG. 82. Notice these values can be found by rays tracing though the conforming lens. Secondly, the ray tiling condition in lenslets k+1 and k−1 is given by:

ρ_{B0,k+1}=P(θₖ₊₁)+G(α_{med0,k})−G(Gₖ₊₁)

ρ_{T0,k-1}=P(θₖ₋₁)+G(α_{med0,k})−G(Gₖ₋₁)

where α_{med0.k} is the angle at which the tiling is produced. Subtracting [0364] from [0363] and [0367] from [0366]:

ρ_{B0,k+1}−ρ_{T0,k-1}=G(α_{max0,k})−G(α_{min0,k})

ρ_{B0,k+1}−ρ_{T0,k-1}=P(θₖ₊₁)−P(θₖ₋₁)−(G(θₖ₊₁)−G(θₖ₋₁))

Subtracting again [0369] and [0370] we obtain:

(G(α_{max0,k})−G(α_{min0,k}))+(G(θₖ₊₁)−G(θₖ₋₁))=P(θₖ₊₁)−P(θₖ₋₁)

Considering θₖ is intermediate to α_{max0,k} and α_{min0,k}, equation [0372] can be approximated by:

G′(θₖ)(α_{max0,k}−α_{min0,k})+G′(θₖ)(θₖ₊₁−θₖ₋₁)=P′(θₖ)(θₖ₊₁−θₖ₋₁)

Since θₖ₊₁−θₖ₋₁=2Δ, we have:

$${G}^{′} ( {θ}_{k} ) = \frac{1}{1 + \frac{{α}_{max 0 , k} - {α}_{min 0 , k}}{2 Δ}} {P}^{′} ( {θ}_{k} ) for k \leq {k}_{t}$$

Therefore, for k≤kₜ G′ is proportional to P′. Analogously for k>kₜ, we arrive at:

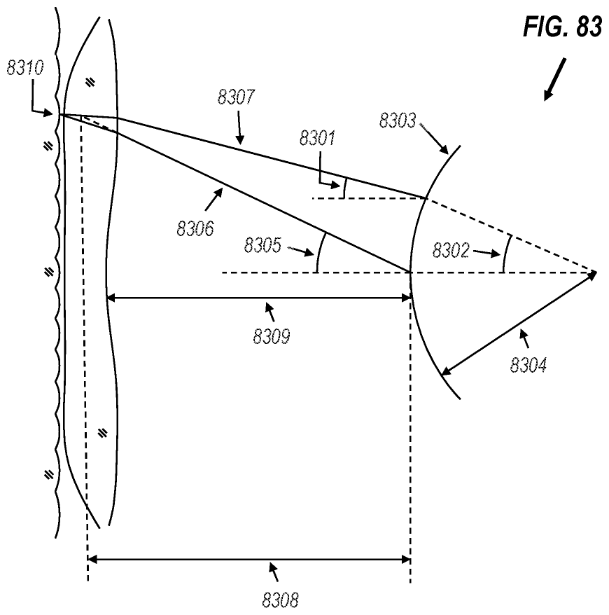

G′(αₖ)(α_{max20,k}−α_{min20,k})+G′(θₖ)(θₖ₊₁−θₖ₋₁)=P′(θₖ)(θₖ₊₁−θₖ₋₁)

where αₖ is angle 8301 in FIG. 83, an intermediate value to α_{max20,k} and α_{min20,k}. Calling L, R, θ₂₀ to 8309, 8304 and 8302, respectively, these values are linked by:

(L−R tan θ₂₀)tan αₖ≈L tan θₖ

So we can estimate:

$${α}_{k} = atan ( \frac{L}{L - R tan 20} tan {θ}_{k} ) )$$

Assuming that, for k>kₜ, αₖ<θₖ_{ₜ}, then, from equations [0376] we can write:

$${G}^{′} ( {α}_{k} ) = \frac{1}{1 + \frac{{α}_{max 0 , k} - {α}_{min 0 , k}}{2 Δ}} {P}^{′} ( atan ( \frac{L}{L - R tan 20} tan {θ}_{k} ) )$$

Therefore, combining [0378] and [0384]:

$${G}^{′} ( {θ}_{k} ) = {P}^{′} ( {θ}_{k} ) - \frac{{α}_{max 20 , k} - {α}_{min 20 , k}}{2 Δ + {α}_{max 0 , k} - {α}_{min 0 , k}} {P}^{′} ( atan ( \frac{L}{L - R tan 20} tan {θ}_{k} ) )$$

Let us define:

$${G}^{′} ( θ ) = min \{ \frac{1}{1 + \frac{{α}_{max 0 ( θ )} - {α}_{min 0 ( θ )}}{2 Δ}} {P}^{′} ( θ ) , {P}^{′} ( θ ) , {P}^{′} ( ( θ ) ) - \frac{{α}_{max 20 ( θ )} - {α}_{min 20 ( θ )}}{2 Δ + {α}_{max 0 ( θ )} - {α}_{min 0 ( θ )}} {P}^{′} ( atan ( \frac{L}{L - R tan 20} tan {θ}_{k} ) ) \}$$

And then from G(θ)=∫₀^{θ}G′( [symbol] )d [symbol] we obtain an estimate for the function G we were searching for.

kₜ can be estimated as

$${k}_{t} = floor ( \frac{{θ}_{int}}{Δ} )$$

where θᵢₙₜ is the angle at which the two expressions inside the bracket in [0388]) are equal.

6. Mapping Implementation and Display Image Segmentation

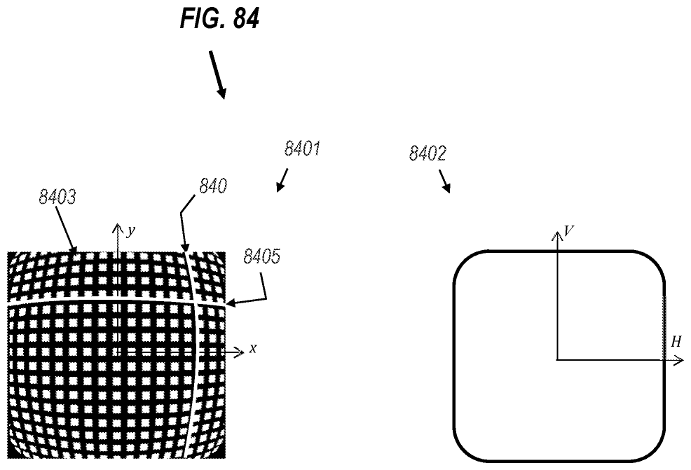

The mapping functions gives display coordinates r=(x,y) as a function of the coordinates on an a-pixel surface or a waist surface, such as (θ,φ) (see section starting in [0169]). In this section we will use generic coordinates (H,V) instead of (θ,φ) and we will call virtual screen to the surface in the image space. FIG. 84 shows the physical display 8401 (left) and the (H,V) surface or virtual screen 8402 (right). When a viewer sees directly a plane (x,y) at a certain distance L far enough from the viewer and the coordinates (H,V) are the horizontal and vertical angles then the mapping is rectilinear, that is, as tan H/x=tan V/y=L=constant. However, conventional Virtual Reality (VR) optics image the display on the VR screen with some distortion, so the mapping between display and VR screen is approximately such that H/x=V/y=constant. The interlacing underfilled strategy establishes a slightly more complex mapping that is going to be explained here. There are several options for this strategy. For simplicity of the explanation, we are going to introduce next the one referred to as “non-overlapping”.

Underfilling strategy results in some o-pixels on the display being off, no matter the real or virtual image. In particular, the o-pixels of the black corridors of 8401 in FIG. 84 left. The o-pixels of the squarish white ones regions 8403 are the ones which may by lit. Each one of these white “islands” correspond to a cluster, which is characterized by a couple of integers i,j. Each lenslet has its own cluster. The lenslet is also characterized by the same i,j. The left hand side borders of these white regions lie in h(x,y)=constant curves 8404 such that the constant is an integer number i. The right hand side borders also lie in h(x,y)=constant curves but now the constant=i+m where 0<m<1. In general m may be a function of h. In the same way the lower and upper borders of the white regions lie in v(x,y)=j and v(x,y)=j+n curves 8405 respectively with 0<n<1. In general n may be a function of v. We are going to assume that the indices i,j∈{−N/2, . . . ,−1,0,1, . . . N/2}. The functions h(x,y) and v(x,y) depend on the eye pupil position which will be denoted by p, explicitly h(x,y,p) and v(x,y,p). So, the set of the o-pixels belonging to a specific cluster depends on p. An o-pixel may belong to a black corridor for a given position of the pupil p and may belong to a cluster for another pupil position.

Each lenslet imposes a continuous mapping between the x,y and the H,V coordinates. This mapping is given by the functions (H,V)=(Aᵢⱼ(x,y), Bᵢⱼ(x,y)). The same mapping can also be expressed in terms of the functions h and v, as (H,V)=(Hᵢⱼ(h,v), Vᵢⱼ(h,v)). Observe that Hᵢⱼ(h,v) and Vᵢⱼ(h,v) are only defined for the cluster i,j, i.e. when i≤h≤i+m and j≤v≤j+n. Observe also that Aᵢⱼ(x,y), Bᵢⱼ(x,y) are not dependent of the pupil position p but Hᵢⱼ(h,v), Vᵢⱼ(h,v) are dependent in general.

In an interlaced strategy, the lenslets (and their clusters) can be classified in k² families where k is the interlacing degree. For instance when k=2 and there is a square configuration of lenslets, then the 4 families are (00) i,j odd; (10) i odd, j even; (01) i even, j odd; and (11) i, j even. The mapping of anyone of the families, for instance (01) can be written as (H,V)=(α₀₁(x,y), β₀₁(x,y)) where the functions α₀₁(x,y)=Aᵢⱼ(x,y) and β₀₁(x,y)=Bᵢⱼ(x,y) if (x,y) belongs to the cluster ij and this cluster belongs to the family 01. α₀₁(x,y) and β₀₁(x,y) are called the mapping functions of the lenslet family MF=01. The image space of any function α_{MF}(x,y) and β_{MF}(x,y) is the whole virtual screen while its object space is formed by the points (x,y) belonging to the clusters of the family MF. The functions α_{MF}(x,y) and β_{MF}(x,y) can also be written as functions of h and v when p is known α_{MF}(x,y)= [symbol] _{MF}(h(x,y,p),v(x,y,p)) and B_{MF}(x,y)= [symbol] _{MF}(h(x,y,p),v(x,y,p)).

For a given lenslet design, the functions h(x,y,p), v(x,y,p), m(h), n(v), and α_{MF}(x,y), β_{MF}(x,y) are known. Then, for the mapping implementation in the rendering engine software, given (x,y, p) the calculation to obtain the values of H,V in these 5 steps:

1. Calculate h=h(x,y,p) and v=v(x,y,p).

2. Is there a couple i,j such that i≤h≤i+m and j≤v≤j+n.? If not turn off the pixel at x,y.

3. Find the lenslet family MF containing the lenslet associated to the cluster i,j.

4. Calculate (H,V)=(α_{MF}(x,y), β_{MF}(x,y)).

5. Find the brightness corresponding to (H,V) and turn on the pixel (x,y) with that brightness.

Continuity and overlapping of the partial virtual images in the virtual screen. For a correct tessellation of the partial virtual images of every lenslet into a common virtual image, the lenslet mapping functions [symbol] _{MF}(h,v) and [symbol] _{MF}(h,v) have to fulfill that [symbol] _{MF}(i+m,v)= [symbol] _{MF}(i+k,v), [symbol] _{MF}(i+m,v)= [symbol] _{MF}(i+k,v) and [symbol] _{MF}(h,j+n)= [symbol] _{MF}(h,j+k), [symbol] _{MF}(h,j+n)= [symbol] _{MF}(h,j+k). Remember that k is the interlacing degree. These last equations establish the conditions on the tiling of the image regions of the VR screen of the different lenslets of the family MF. This tiling must give a continuous image on the VR screen from the set of clusters of the family MF. In order to allow some tolerance for the position of theses image regions it is advisable to allow for some overlap of that partial virtual images. The contours of the display clusters will be dimmed smoothly and slightly extended to overlap slightly its neighbor virtual images. This overlap is preferably limited so at least 80% of the waists of pencils containing foveal rays and that are associated to objects pixels belonging to clusters do not overlap angularly from the center of the eye pupil. Let's 2Δ be the width of the overlapping regions in the variables h or v. Assume that Δ<<1. The new calculation process of H,V is

1. Calculate h=h(x,y,p) and v=v(x,v,p).

2. Find the couple i,j such that i−Δ≤h≤i+m+Δ and j−Δ≤v≤j+n+Δ.? If there is no solution, then turn the x,y pixel off.

3. Find the lenslet family MF containing the lenslet i,j.

4. Calculate (H,V)=(α_{MF}(x,y), β_{MF}(x,y)). The functions Hᵢⱼ(h,v) and Vᵢⱼ(h,v) are now defined for a cluster i,j, slightly bigger than in the preceding case when there was no overlapping of partial virtual images. Now they are defined for i−Δ≤h≤i+m+Δ and j−Δ≤v≤j+n+Δ.

5. Find the brightness corresponding to (H,V) and turn on the pixel (x,y) with that brightness times the weighting function w(h,v). This weighting function w(h,v) is w(h,v)=c(h)·d(v) where c(h) and d(v) can be calculated with the following routine: Set c(h)=1, if i+Δ≤h≤i+m−Δ. If i−Δ≤h≤i+Δ then c(h)=(1−(h−i)/Δ)/2. If i+m−Δ≤h≤i+m+Δ then c(h)=(1−(h−i−m)/Δ)/2. Set c(h)=0 otherwise. Set d(v)=1 if j−Δ≤v≤j+n+Δ. If j−Δ≤v≤j+Δ then d(v)=(1−(v−j)/Δ)/2. If j+n−Δ≤v≤j+n+Δ then d(v)=(1−(v−j−n)/Δ)/2. Set d(v)=0 otherwise.

This strategy smoothly dims the contours of the clusters. For this strategy to be correct the mapping functions [symbol] _{MF}(h,v) and [symbol] _{MF}(h,v) have to fulfill that [symbol] _{MF}(h+m,v)= [symbol] _{MF}(h+k,v), [symbol] _{MF}(h+m,v)= [symbol] _{MF}(h+k,v) for any couple h,v in the corridors i+m−Δ≤h≤i+m+Δ, i+k−Δ≤h≤i+k+Δ and [symbol] _{MF}(h,v+n)= [symbol] _{MF}(h,v+k), [symbol] _{MF}(h,v+n)= [symbol] _{MF}(h,v+k), for the corridors j+n−Δ≤v≤j+n+Δ, j+k−Δ≤v≤j+k+Δ. This condition ensures that the weighting functions do sum 1 at any point of the overlapping regions. This condition on the mapping functions is more restrictive than the one found when there is no tolerance allowance for the tiling, which establishes the same equations but only for the curves h=i+m, h=i+k and v=j+n, v=j+k, which are in the middle of the abovementioned corridors.

A more practical condition for the overlapping case is to require that:

1. [symbol] _{MF}(h+m,v)= [symbol] _{MF}(h+k,v), [symbol] _{MF}(h+m,v)= [symbol] _{MF}(h+k,v) and [symbol] _{MF h}(h+m,v)= [symbol] _{MF h}(h+k,v), [symbol] _{MF h}(h+m,v)= [symbol] _{MF h}(h+k,v) only for the curves h=i+m, h=i+k, where the subindex h denotes partial derivative of the function with respect to h, i.e., ∂( )/∂h.

2. [symbol] _{MF}(h,v+n)= [symbol] _{MF}(h,v+k), [symbol] _{MF}(h,v+n)= [symbol] _{MF}(h,v+k) and [symbol] _{MF v}(h,v+n)= [symbol] _{MF v}(h,v+k), [symbol] _{MF v}(h,v+n)= [symbol] _{MF v}(h,v+k) only for the curves v=j+n, v=j+k, where the subindex v denotes partial derivative of the function with respect to v, i.e., ∂( )/∂v.

This approximation assumes that the functions [symbol] _{MF} and [symbol] _{MF} can be approximated by its linear expansion for the points of the corridors. The approximation works for Δ small enough.

7. Lenslet Design

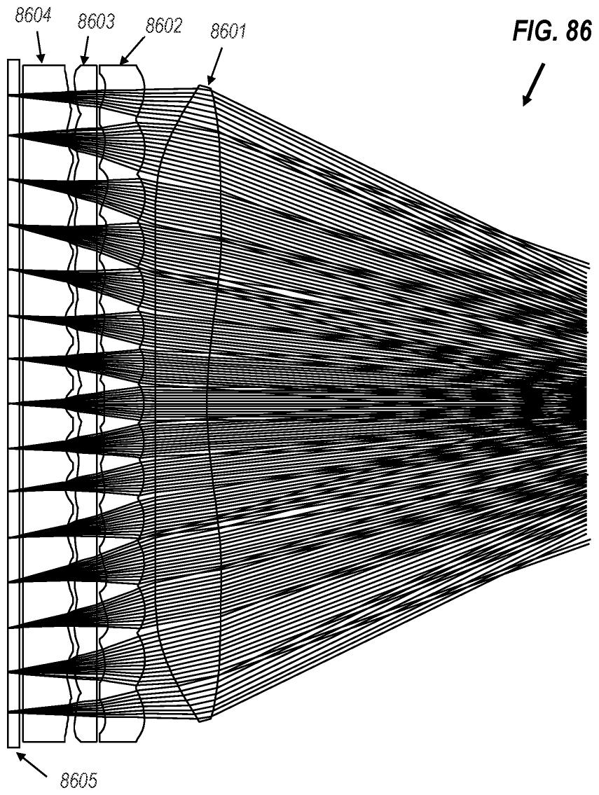

The number of freeform surfaces required to perform the optical design of the lenslets depend on the specific design parameters targeted: FOV, interlacing factor, virtual image resolution, displays o-pixel size, virtual image resolution versus polar angle θ, etc. We disclose next an exemplary design, whose diagonal cross section in shown in FIG. 86. It comprises 4 optical elements: a rotational symmetric conforming aspheric lens 8601 and three minilens arrays, 8602 with freeform refractive surfaces on both sides, and 8603 and 8604 with freeform refractive surfaces only on one side. FIG. 86 shows also the trajectories of the rays contained in that cross section that correspond to different pupils positions, each one gazing one minilens through the conforming lens.

The design performs interlacing factor 2, eye tracking and underfilling strategy. The selected materials for this example are POG01 for the two arrays closer to the eye and POG12 for the element closer to the display, both UV curable resins used by Süss MicroTec.

This design has been done for a 1.78″ diagonal OLED RGBW square o-pixel microdisplay with about 3.2k×3.2k resolution (so the full-color pixel is about 10 microns). It achieves a FOV-H=FOV-V=80 degs with an eye relief of 15 mm and a thickness of less than 9 mm, and eyebox of 16 mm (this includes ±25 deg eye rotations and ±2 mm eye shift), weighting (the optics) only 4 grams per eye.

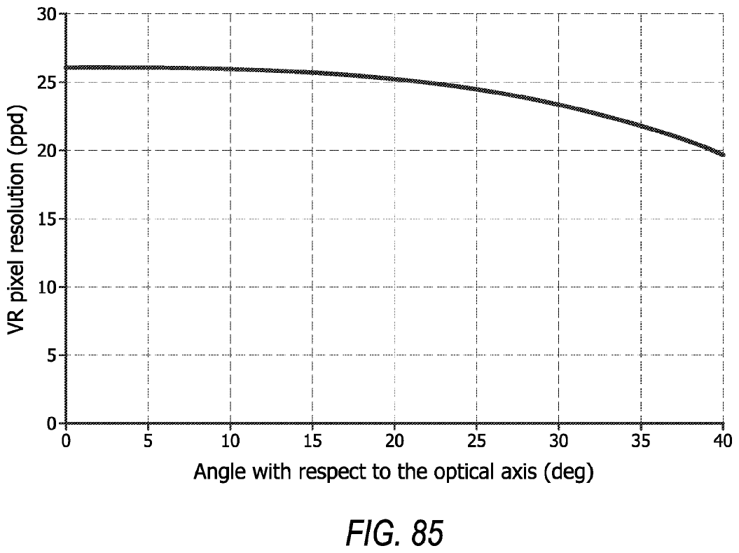

The lens designs are done taking into account the variable directional magnification desired, the eye rotations and the human vision angular acuity function. The lenslets have been specifically designed with a G(θ) function such that the resulting VR pixel radial resolution (proportional to G(θ)) matches with high accuracy the curve shown in FIG. 85 for all lenslets. As figure shows, the resolution at the center of the FOV reaches more than 25 pixels per degree (ppd), and it remains nearly constant inside a centered 30 deg full angle cone, in which 86% eye saccades are in (Bahill 1975). This is very different from standard distortion-free optics, where the radial VR resolution increases as 1/cos² θ, so the product of the radial resolution of this design times cos² θ is a decreasing function.

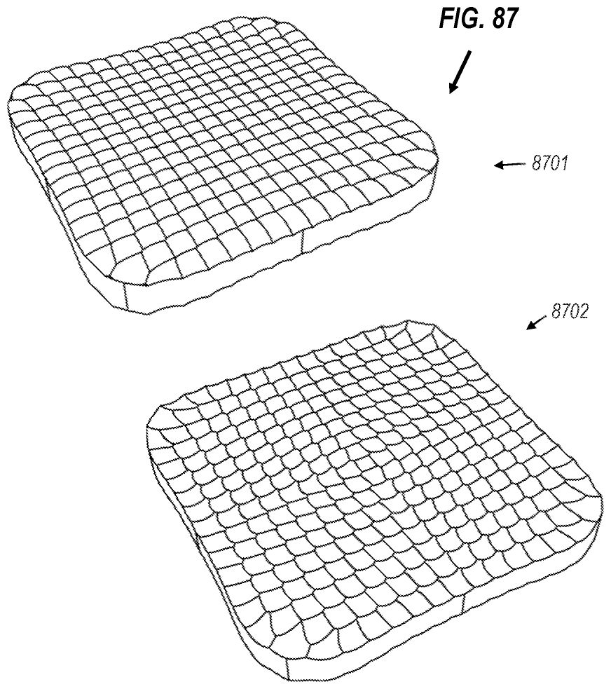

The design is done considering that cross-talk between the different channels must be avoided for the eye located in any position within the pupil range. Additionally, the surface shapes are constrained so the piece-wise continuous intersection curve between one lens surface and its adjacent ones is contained in the clear aperture, so it can be manufactured easier, without presenting steps between surfaces. FIG. 87 shows as an example the image of the double-sided minilens array, wherein it can be seen that the intersection between adjacent freeform surfaces on the side closest to the eye 8701, whose freeform surfaces are convex, and the opposite side 8702, whose freeform surfaces are concave.

The design of the freeform surfaces may be done by multiparameter optimization with adequate constraints using commercial design software as Code V or Zemax. Apart from the symmetries of the arrays in this example, most lenses in one octant are different on the others. Each lens is designed with plane symmetry with respect to a plane containing the frontward axis (z-axis). An efficient implementation of the design algorithm may incorporate the possibility of designing only the lenslets along a diagonal (of indices (i,i), i≥0) and obtaining the rest (which are at different radial distances front the z-axis) by interpolation of the diagonal lenslets parameters. The optimization may be carried out with the following expression for the freeform surfaces:

$$z ( x , y ) = \frac{{cr}^{2}}{1 + \sqrt{1 - ( 1 + k ) {c}^{2} {r}^{2}}} + {\sum }_{j = 1}^{N} {c}_{j} {x}^{m} {y}^{n}$$

$$where$$

$$m = ( {t}^{2} + t - 2 j ) / 2$$

$$n = ( - {t}^{2} + t + 2 j - 2 ) / 2$$

$$t = ceiling ( \frac{- 1 + \sqrt{1 + 8 j}}{2} )$$

and ceiling(x) gives the smallest integer greater than or equal to x. For a polynomial of degree d, the maximum monomial index N is given by N=(d+1)(d+2)/2. Next tables show the resulting parameters for exemplary lenslets along the diagonal of indices (0,0), (3,3), and (6,6). The parameters not shown in the tables are 0.

TABLE 1
Data for lenslet (0, 0)

| | Surface 1 | Surface 2 | Surface 3 | Surface 4 |
|---|---|---|---|---|
| Local coordinate | (x, y, z) | (x, y, z) | (x, y, z) | (x, y, z) |
| system | | | | |
| Origin | (0, 0, 0) | (0, 0, 1.79) | (0, 0, | (0, 0, |
| | | | 2.98534542472871) | 3.40471146240791) |
| X-axis direction | (1, 0, 0) | (1, 0, 0) | (1, 0, 0) | (1, 0, 0) |
| Y-axis direction | (0, 1, 0) | (0, 1, 0) | (0, 1, 0) | (0, 1, 0) |
| Z-axis direction | (0, 0, 1) | (0, 0, 1) | (0, 0, 1) | (0, 0, 1) |
| | Surface 1 | Surface 2 | Surface 3 | Surface 4 |
| Term | Value [mm] | Value [mm] | Value [mm] | Value [mm] |
| Y Radius (1/c) | Infinity | Infinity | Infinity | Infinity |
| K conic constant (k) | −1.0000000000000000 | −1.0000000000000000 | −1.0000000000000000 | −1.0000000000000000 |
| [C2] X | 0.0000000000000000 | 0.0000000000000000 | 0.0000000000000000 | 0.0000000000000000 |
| [C3] Y | 0.0000000000000000 | 0.0000000000000000 | 0.0000000000000000 | 0.0000000000000000 |
| [C4] X2 | 0.3582643943365400 | 0.1569130963323260 | −0.2981299456208540 | −0.8245428591937230 |
| [C5] XY | 0.0000000000000000 | 0.0000000000000000 | 0.0000000000000000 | 0.0000000000000000 |
| [C6] Y2 | 0.3582643943365400 | 0.1569130963323260 | −0.2981299456208540 | −0.8245428591937230 |
| [C7] X3 | 0.0000000000000000 | 0.0000000000000000 | 0.0000000000000000 | 0.0000000000000000 |
| [C8] X2Y | 0.0000000000000000 | 0.0000000000000000 | 0.0000000000000000 | 0.0000000000000000 |
| [C9] XY2 | 0.0000000000000000 | 0.0000000000000000 | 0.0000000000000000 | 0.0000000000000000 |
| [C10] Y3 | 0.0000000000000000 | 0.0000000000000000 | 0.0000000000000000 | 0.0000000000000000 |
| [C11] X4 | −0.0430194009407165 | −0.3681036455480040 | 0.1616269639718650 | −0.0198658257953159 |
| [C12] X3Y | 0.0000000000000000 | 0.0000000000000000 | 0.0000000000000000 | 0.0000000000000000 |
| [C13] X2Y2 | −0.0860388018814329 | −0.7362072910960080 | 0.3232539279437310 | −0.0397316515906318 |
| [C14] XY3 | 0.0000000000000000 | 0.0000000000000000 | 0.0000000000000000 | 0.0000000000000000 |
| [C15] Y4 | −0.0430194009407165 | −0.3681036455480040 | 0.1616269639718650 | −0.0198658257953159 |
| [C16] X5 | 0.0000000000000000 | 0.0000000000000000 | 0.0000000000000000 | 0.0000000000000000 |
| [C17] X4Y | 0.0000000000000000 | 0.0000000000000000 | 0.0000000000000000 | 0.0000000000000000 |
| [C18] X3Y2 | 0.0000000000000000 | 0.0000000000000000 | 0.0000000000000000 | 0.0000000000000000 |
| [C19] X2Y3 | 0.0000000000000000 | 0.0000000000000000 | 0.0000000000000000 | 0.0000000000000000 |
| [C20] XY4 | 0.0000000000000000 | 0.0000000000000000 | 0.0000000000000000 | 0.0000000000000000 |
| [C21] Y5 | 0.0000000000000000 | 0.0000000000000000 | 0.0000000000000000 | 0.0000000000000000 |
| [C22] X6 | 0.3038732034053800 | 3.3603641097345900 | −1.4341727274861500 | −0.5115011142231930 |
| [C23] X5Y | 0.0000000000000000 | 0.0000000000000000 | 0.0000000000000000 | 0.0000000000000000 |
| [C24] X4Y2 | 0.9116196102161390 | 10.0810923292038000 | −4.3025181824584500 | −1.5345033426695800 |
| [C25] X3Y3 | 0.0000000000000000 | 0.0000000000000000 | 0.0000000000000000 | 0.0000000000000000 |
| [C26] X2Y4 | 0.9116196102161390 | 10.0810923292038000 | −4.3025181824584500 | −1.5345033426695800 |
| [C27] XY5 | 0.0000000000000000 | 0.0000000000000000 | 0.0000000000000000 | 0.0000000000000000 |
| [C28] Y6 | 0.3038732034053800 | 3.3603641097345900 | −1.4341727274861500 | −0.5115011142231930 |
| [C29] X7 | 0.0000000000000000 | 0.0000000000000000 | 0.0000000000000000 | 0.0000000000000000 |
| [C30] X6Y | 0.0000000000000000 | 0.0000000000000000 | 0.0000000000000000 | 0.0000000000000000 |
| [C31] X5Y2 | 0.0000000000000000 | 0.0000000000000000 | 0.0000000000000000 | 0.0000000000000000 |
| [C32] X4Y3 | 0.0000000000000000 | 0.0000000000000000 | 0.0000000000000000 | 0.0000000000000000 |
| [C33] X3Y4 | 0.0000000000000000 | 0.0000000000000000 | 0.0000000000000000 | 0.0000000000000000 |
| [C34]X2 Y5 | 0.0000000000000000 | 0.0000000000000000 | 0.0000000000000000 | 0.0000000000000000 |
| [C35] XY6 | 0.0000000000000000 | 0.0000000000000000 | 0.0000000000000000 | 0.0000000000000000 |
| [C36] Y7 | 0.0000000000000000 | 0.0000000000000000 | 0.0000000000000000 | 0.0000000000000000 |
| [C37] X8 | −0.5538208980991410 | −9.8303806535748800 | 3.2611146226732300 | 1.0413772996375900 |
| [C38] X7Y | 0.0000000000000000 | 0.0000000000000000 | 0.0000000000000000 | 0.0000000000000000 |
| [C39] X6Y2 | −2.2152835923965600 | −39.3215226142995000 | 13.0444584906929000 | 4.1655091985503600 |
| [C40]X5 Y3 | 0.0000000000000000 | 0.0000000000000000 | 0.0000000000000000 | 0.0000000000000000 |
| [C41] X4Y4 | −3.3229253885948500 | −58.9822839214493000 | 19.5666877360394000 | 6.2482637978255400 |
| [C42] X3Y5 | 0.0000000000000000 | 0.0000000000000000 | 0.0000000000000000 | 0.0000000000000000 |
| [C43] X2Y6 | −2.2152835923965600 | −39.3215226142995000 | 13.0444584906929000 | 4.1655091985503600 |
| [C44] XY7 | 0.0000000000000000 | 0.0000000000000000 | 0.0000000000000000 | 0.0000000000000000 |
| [C45] Y8 | −0.5538208980991410 | −9.8303806535748800 | 3.2611146226732300 | 1.0413772996375900 |
| [C46] X9 | 0.0000000000000000 | 0.0000000000000000 | 0.0000000000000000 | 0.0000000000000000 |
| [C47] X8Y | 0.0000000000000000 | 0.0000000000000000 | 0.0000000000000000 | 0.0000000000000000 |
| [C48] X7Y2 | 0.0000000000000000 | 0.0000000000000000 | 0.0000000000000000 | 0.0000000000000000 |
| [C49] X6Y3 | 0.0000000000000000 | 0.0000000000000000 | 0.0000000000000000 | 0.0000000000000000 |
| [C50] X5Y4 | 0.0000000000000000 | 0.0000000000000000 | 0.0000000000000000 | 0.0000000000000000 |
| [C51] X4Y5 | 0.0000000000000000 | 0.0000000000000000 | 0.0000000000000000 | 0.0000000000000000 |
| [C52] X3Y6 | 0.0000000000000000 | 0.0000000000000000 | 0.0000000000000000 | 0.0000000000000000 |
| [C53] X2Y7 | 0.0000000000000000 | 0.0000000000000000 | 0.0000000000000000 | 0.0000000000000000 |
| [C54] XY8 | 0.0000000000000000 | 0.0000000000000000 | 0.0000000000000000 | 0.0000000000000000 |
| [C55] Y9 | 0.0000000000000000 | 0.0000000000000000 | 0.0000000000000000 | 0.0000000000000000 |
| [C56] X10 | 0.4045224629666420 | 9.0016985582163200 | −1.9412823421868000 | −0.1005492850672140 |
| [C57] X9Y | 0.0000000000000000 | 0.0000000000000000 | 0.0000000000000000 | 0.0000000000000000 |
| [C58] X8Y2 | 2.0226123148332100 | 45.0084927910816000 | −9.7064117109339800 | −0.5027464253360680 |
| [C59] X7Y3 | 0.0000000000000000 | 0.0000000000000000 | 0.0000000000000000 | 0.0000000000000000 |
| [C60] X6Y4 | 4.0452246296664200 | 90.0169855821632000 | −19.4128234218680000 | −1.0054928506721400 |
| [C61] X5Y5 | 0.0000000000000000 | 0.0000000000000000 | 0.0000000000000000 | 0.0000000000000000 |
| [C62] X4Y6 | 4.0452246296664200 | 90.0169855821632000 | −19.4128234218680000 | −1.0054928506721400 |
| [C63] X3Y7 | 0.0000000000000000 | 0.0000000000000000 | 0.0000000000000000 | 0.0000000000000000 |
| [C64] X2Y8 | 2.0226123148332100 | 45.0084927910816000 | −9.7064117109339800 | −0.5027464253360680 |
| [C65] XY9 | 0.0000000000000000 | 0.0000000000000000 | 0.0000000000000000 | 0.0000000000000000 |
| [C66] Y10 | 0.4045224629666420 | 9.0016985582163200 | −1.9412823421868000 | −0.1005492850672140 |

TABLE 2
Data for lenslet (3, 3)

| | Surface 1 | Surface 2 | Surface 3 | Surface 4 |
|---|---|---|---|---|
| Local | (x, y, z) | (x, y, z) | (x, y, z) | (x, y, z) |
| coordinate | | | | |
| system | | | | |
| Origin | (3.5178424281166, | (3.67695526217005, | (3.88908729652601, | (4.03050865276332, |
| | 3.5178424281166, | 3.67695526217005, | 3.88908729652601, | 4.03050865276332, |
| | 0.) | 1.7182102558451) | 2.96692601431854) | 3.29258184748104) |
| X−axis | (−0.7071067811865476, | (−0.7071067811865476, | (−0.7071067811865476, | (−0.7071067811865476,− |
| direction | −0.7071067811865476, | −0.7071067811865476, | −0.7071067811865476, | 0.7071067811865476, |
| | 0.) | 0.) | 0.) | 0.) |
| Y−axis | (−0.7071067811865476, | (−0.7071067811865476, | (−0.7071067811865476, | (−0.7071067811865476, |
| direction | 0.7071067811865476, | 0.7071067811865476, | 0.7071067811865476, | 0.7071067811865476, |
| | 0.) | 0.) | 0.) | 0.) |
| Z−axis | (0., 0., 1.) | (0., 0., 1.) | (0., 0., 1.) | (0., 0., 1.) |
| direction | | | | |
| | Surface 1 | Surface 2 | Surface 3 | Surface 4 |
| Term | Value [mm] | Value [mm] | Value [mm] | Value [mm] |
| Y Radius (1/c) | Infinity | Infinity | Infinity | Infinity |
| K conic constant (k) | −1.0000000000000000 | −1.0000000000000000 | −1.0000000000000000 | −1.0000000000000000 |
| [C2] X | 0.0000000000000000 | 0.0000000000000000 | 0.0000000000000000 | 0.0000000000000000 |
| [C3] Y | −0.0146944819115911 | −0.1944033273262070 | 0.0540575231118306 | −0.1747924380457680 |
| [C4] X2 | 0.3552383234347820 | 0.1603342828495940 | −0.1209585633787890 | −0.4808885056148180 |
| [C5] XY | 0.0000000000000000 | 0.0000000000000000 | 0.0000000000000000 | 0.0000000000000000 |
| [C6] Y2 | 0.3123268781787350 | 0.1270798440524380 | −0.1215731784062160 | −0.3638564380199560 |
| [C7] X3 | 0.0000000000000000 | 0.0000000000000000 | 0.0000000000000000 | 0.0000000000000000 |
| [C8] X2Y | 0.0277592071688834 | 0.3082927097226680 | −0.1270367297069470 | 0.1257865867379610 |
| [C9] XY2 | 0.0000000000000000 | 0.0000000000000000 | 0.0000000000000000 | 0.0000000000000000 |
| [C10] Y3 | 0.0085149954788109 | 0.1770780833499290 | −0.0413325445585547 | 0.1449473879852140 |
| [C11] X4 | 0.0370820945998109 | 0.1220070085917360 | 0.0217707972935597 | 0.0617357362535757 |
| [C12] X3Y | 0.0000000000000000 | 0.0000000000000000 | 0.0000000000000000 | 0.0000000000000000 |
| [C13] X2Y2 | 0.0601209528602164 | 0.1631703738033110 | 0.0231983252408654 | 0.0625053967745372 |
| [C14] XY3 | 0.0000000000000000 | 0.0000000000000000 | 0.0000000000000000 | 0.0000000000000000 |
| [C15] Y4 | 0.0283842925481968 | 0.0833770715773893 | 0.0182925102305812 | 0.0737414256463390 |
| [C16] X5 | 0.0000000000000000 | 0.0000000000000000 | 0.0000000000000000 | 0.0000000000000000 |
| [C17] X4Y | −0.0048193878100129 | 0.0000000000000000 | 0.0000000000000000 | 0.0000000000000000 |
| [C18] X3Y2 | 0.0000000000000000 | 0.0000000000000000 | 0.0000000000000000 | 0.0000000000000000 |
| [C19] X2Y3 | −0.0067670848836634 | 0.0000000000000000 | 0.0000000000000000 | 0.0000000000000000 |
| [C20] XY4 | 0.0000000000000000 | 0.0000000000000000 | 0.0000000000000000 | 0.0000000000000000 |
| [C21] Y5 | −0.0064687224635927 | 0.0000000000000000 | 0.0000000000000000 | 0.0000000000000000 |
| [C22] X6 | 0.0084305452335796 | 0.0000000000000000 | 0.0000000000000000 | 0.0000000000000000 |
| [C23] X5Y | 0.0000000000000000 | 0.0000000000000000 | 0.0000000000000000 | 0.0000000000000000 |
| [C24] X4Y2 | 0.0101699998238034 | 0.0000000000000000 | 0.0000000000000000 | 0.0000000000000000 |
| [C25] X3Y3 | 0.0000000000000000 | 0.0000000000000000 | 0.0000000000000000 | 0.0000000000000000 |
| [C26] X2Y4 | 0.0025907412792105 | 0.0000000000000000 | 0.0000000000000000 | 0.0000000000000000 |
| [C27] XY5 | 0.0000000000000000 | 0.0000000000000000 | 0.0000000000000000 | 0.0000000000000000 |
| [C28] Y6 | −0.0067010929824185 | 0.0000000000000000 | 0.0000000000000000 | 0.0000000000000000 |
| [C29] X7 | 0.0000000000000000 | 0.0000000000000000 | 0.0000000000000000 | 0.0000000000000000 |
| [C30] X6Y | 0.0062900773524513 | 0.0000000000000000 | 0.0000000000000000 | 0.0000000000000000 |
| [C31] X5Y2 | 0.0000000000000000 | 0.0000000000000000 | 0.0000000000000000 | 0.0000000000000000 |
| [C32] X4Y3 | 0.0213436017917351 | 0.0000000000000000 | 0.0000000000000000 | 0.0000000000000000 |
| [C33] X3Y4 | 0.0000000000000000 | 0.0000000000000000 | 0.0000000000000000 | 0.0000000000000000 |
| [C34]X2 Y5 | 0.0095275388200322 | 0.0000000000000000 | 0.0000000000000000 | 0.0000000000000000 |
| [C35] XY6 | 0.0000000000000000 | 0.0000000000000000 | 0.0000000000000000 | 0.0000000000000000 |
| [C36] Y7 | 0.0095412387334905 | 0.0000000000000000 | 0.0000000000000000 | 0.0000000000000000 |
| [C37] X8 | 0.0000000000000000 | 0.0000000000000000 | 0.0000000000000000 | 0.0000000000000000 |
| [C38] X7Y | 0.0000000000000000 | 0.0000000000000000 | 0.0000000000000000 | 0.0000000000000000 |
| [C39] X6Y2 | 0.0000000000000000 | 0.0000000000000000 | 0.0000000000000000 | 0.0000000000000000 |
| [C40]X5 Y3 | 0.0000000000000000 | 0.0000000000000000 | 0.0000000000000000 | 0.0000000000000000 |
| [C41] X4Y4 | 0.0516612994351340 | 0.0000000000000000 | 0.0000000000000000 | 0.0000000000000000 |
| [C42] X3Y5 | 0.0000000000000000 | 0.0000000000000000 | 0.0000000000000000 | 0.0000000000000000 |
| [C43] X2Y6 | 0.0000000000000000 | 0.0000000000000000 | 0.0000000000000000 | 0.0000000000000000 |
| [C44] XY7 | 0.0000000000000000 | 0.0000000000000000 | 0.0000000000000000 | 0.0000000000000000 |
| [C45] Y8 | 0.0199065411604771 | 0.0000000000000000 | 0.0000000000000000 | 0.0000000000000000 |
| [C46] X9 | 0.0000000000000000 | 0.0000000000000000 | 0.0000000000000000 | 0.0000000000000000 |
| [C47] X8Y | 0.0000000000000000 | 0.0000000000000000 | 0.0000000000000000 | 0.0000000000000000 |
| [C48] X7Y2 | 0.0000000000000000 | 0.0000000000000000 | 0.0000000000000000 | 0.0000000000000000 |
| [C49] X6Y3 | 0.0000000000000000 | 0.0000000000000000 | 0.0000000000000000 | 0.0000000000000000 |
| [C50] X5Y4 | 0.0000000000000000 | 0.0000000000000000 | 0.0000000000000000 | 0.0000000000000000 |
| [C51] X4Y5 | 0.0000000000000000 | 0.0000000000000000 | 0.0000000000000000 | 0.0000000000000000 |
| [C52] X3Y6 | 0.0000000000000000 | 0.0000000000000000 | 0.0000000000000000 | 0.0000000000000000 |
| [C53] X2Y7 | 0.0000000000000000 | 0.0000000000000000 | 0.0000000000000000 | 0.0000000000000000 |
| [C54] XY8 | 0.0000000000000000 | 0.0000000000000000 | 0.0000000000000000 | 0.0000000000000000 |
| [C55] Y9 | 0.0000000000000000 | 0.0000000000000000 | 0.0000000000000000 | 0.0000000000000000 |
| [C56] X10 | 0.0000000000000000 | 0.0000000000000000 | 0.0000000000000000 | 0.0000000000000000 |
| [C57] X9Y | 0.0000000000000000 | 0.0000000000000000 | 0.0000000000000000 | 0.0000000000000000 |
| [C58] X8Y2 | 0.0000000000000000 | 0.0000000000000000 | 0.0000000000000000 | 0.0000000000000000 |
| [C59] X7Y3 | 0.0000000000000000 | 0.0000000000000000 | 0.0000000000000000 | 0.0000000000000000 |
| [C60] X6Y4 | 0.0000000000000000 | 0.0000000000000000 | 0.0000000000000000 | 0.0000000000000000 |
| [C61] X5Y5 | 0.0000000000000000 | 0.0000000000000000 | 0.0000000000000000 | 0.0000000000000000 |
| [C62] X4Y6 | 0.0000000000000000 | 0.0000000000000000 | 0.0000000000000000 | 0.0000000000000000 |
| [C63] X3Y7 | 0.0000000000000000 | 0.0000000000000000 | 0.0000000000000000 | 0.0000000000000000 |
| [C64] X2Y8 | 0.0000000000000000 | 0.0000000000000000 | 0.0000000000000000 | 0.0000000000000000 |
| [C65] XY9 | 0.0000000000000000 | 0.0000000000000000 | 0.0000000000000000 | 0.0000000000000000 |
| [C66] Y10 | 0.0000000000000000 | 0.0000000000000000 | 0.0000000000000000 | 0.0000000000000000 |

TABLE 3
Data for lenslet (6, 6)

| | Surface 1 | Surface 2 | Surface 3 | Surface 4 |
|---|---|---|---|---|
| Local | (x, y, z) | (x, y, z) | (x, y, z) | (x, y, z) |
| coordinate | | | | |
| system | | | | |
| Origin | (7.50206999301921, | (7.70746391493337, | (7.91959594928933, | (7.99030662740799, |
| | 7.50206999301921, | 7.70746391493337, | 7.91959594928933, | 7.99030662740799, |
| | 0.) | 1.7182102558451) | 2.96692601431854) | 3.29258184748104) |
| X-axis | (−0.7071067811865476, | (−0.7071067811865476, | (−0.7071067811865476, | (−0.7071067811865476, |
| direction | −0.7071067811865476, | −0.7071067811865476, | −0.7071067811865476, | −0.7071067811865476, |
| | 0.) | 0.) | 0.) | 0.) |
| Y-axis | (−0.7071067811865476, | (−0.7071067811865476, | (−0.7071067811865476, | (−0.7071067811865476, |
| direction | 0.7071067811865476, | 0.7071067811865476, | 0.7071067811865476, | 0.7071067811865476, |
| | 0.) | 0.) | 0.) | 0.) |
| Z-axis | (0., 0., 1.) | (0., 0., 1.) | (0., 0., 1.) | (0., 0., 1.) |
| direction | | | | |
| | Surface 1 | Surface 2 | Surface 3 | Surface 4 |
| Term | Value [mm] | Value [mm] | Value [mm] | Value [mm] |
| Y Radius (1/c) | Infinity | Infinity | Infinity | Infinity |
| K conic constant (k) | −1.0000000000000000 | −1.0000000000000000 | −1.0000000000000000 | −1.0000000000000000 |
| [C2] X | 0.0000000000000000 | 0.0000000000000000 | 0.0000000000000000 | 0.0000000000000000 |
| [C3] Y | −0.1896246781356700 | −0.1888697816500000 | 0.1291551015727990 | 0.1896181006502610 |
| [C4] X2 | 0.3338678063725760 | 0.1705908837777130 | −0.1589230997700000 | −0.4381828451119380 |
| [C5] XY | 0.0000000000000000 | 0.0000000000000000 | 0.0000000000000000 | 0.0000000000000000 |
| [C6] Y2 | 0.2588915078673730 | 0.2247033954474250 | −0.2011935902554980 | −0.3234880155220040 |
| [C7] X3 | 0.0000000000000000 | 0.0000000000000000 | 0.0000000000000000 | 0.0000000000000000 |
| [C8] X2Y | 0.0192376011192996 | 0.3658822091059160 | −0.1789731932860860 | 0.1171350535709850 |
| [C9] XY2 | 0.0000000000000000 | 0.0000000000000000 | 0.0000000000000000 | 0.0000000000000000 |
| [C10] Y3 | −0.0227397061489987 | 0.0551127661573902 | −0.0718817526363431 | −0.0056487960238479 |
| [C11] X4 | 0.0427655122126318 | 0.2029729965963340 | −0.0176471307300746 | 0.0757283945794785 |
| [C12] X3Y | 0.0000000000000000 | 0.0000000000000000 | 0.0000000000000000 | 0.0000000000000000 |
| [C13] X2Y2 | 0.0335614392309824 | −0.0176706681825348 | 0.2408323144138950 | 0.1685760193563840 |
| [C14] XY3 | 0.0000000000000000 | 0.0000000000000000 | 0.0000000000000000 | 0.0000000000000000 |
| [C15] Y4 | 0.0194180274948182 | 0.0092683738956693 | 0.0291508314231756 | 0.0591621049044810 |
| [C16] X5 | 0.0000000000000000 | 0.0000000000000000 | 0.0000000000000000 | 0.0000000000000000 |
| [C17] X4Y | −0.0105402435438967 | 0.0000000000000000 | 0.0000000000000000 | 0.0000000000000000 |
| [C18] X3Y2 | 0.0000000000000000 | 0.0000000000000000 | 0.0000000000000000 | 0.0000000000000000 |
| [C19] X2Y3 | −0.0107372192357715 | 0.0000000000000000 | 0.0000000000000000 | 0.0000000000000000 |
| [C20] XY4 | 0.0000000000000000 | 0.0000000000000000 | 0.0000000000000000 | 0.0000000000000000 |
| [C21] Y5 | −0.0071968332052934 | 0.0000000000000000 | 0.0000000000000000 | 0.0000000000000000 |
| [C22] X6 | 0.0091201137375592 | 0.0000000000000000 | 0.0000000000000000 | 0.0000000000000000 |
| [C23] X5Y | 0.0000000000000000 | 0.0000000000000000 | 0.0000000000000000 | 0.0000000000000000 |
| [C24] X4Y2 | 0.0150738201231043 | 0.0000000000000000 | 0.0000000000000000 | 0.0000000000000000 |
| [C25] X3Y3 | 0.0000000000000000 | 0.0000000000000000 | 0.0000000000000000 | 0.0000000000000000 |
| [C26] X2Y4 | 0.0086364142997895 | 0.0000000000000000 | 0.0000000000000000 | 0.0000000000000000 |
| [C27] XY5 | 0.0000000000000000 | 0.0000000000000000 | 0.0000000000000000 | 0.0000000000000000 |
| [C28] Y6 | 0.0046700959345480 | 0.0000000000000000 | 0.0000000000000000 | 0.0000000000000000 |
| [C29] X7 | 0.0000000000000000 | 0.0000000000000000 | 0.0000000000000000 | 0.0000000000000000 |
| [C30] X6Y | 0.0000615318937557 | 0.0000000000000000 | 0.0000000000000000 | 0.0000000000000000 |
| [C31] X5Y2 | 0.0000000000000000 | 0.0000000000000000 | 0.0000000000000000 | 0.0000000000000000 |
| [C32] X4Y3 | −0.0006103167269625 | 0.0000000000000000 | 0.0000000000000000 | 0.0000000000000000 |
| [C33] X3Y4 | 0.0000000000000000 | 0.0000000000000000 | 0.0000000000000000 | 0.0000000000000000 |
| [C34JX2 Y5 | −0.0005091014317416 | 0.0000000000000000 | 0.0000000000000000 | 0.0000000000000000 |
| [C35] XY6 | 0.0000000000000000 | 0.0000000000000000 | 0.0000000000000000 | 0.0000000000000000 |
| [C36] Y7 | −0.0026997171626168 | 0.0000000000000000 | 0.0000000000000000 | 0.0000000000000000 |
| [C37] X8 | 0.0000000000000000 | 0.0000000000000000 | 0.0000000000000000 | 0.0000000000000000 |
| [C38] X7Y | 0.0000000000000000 | 0.0000000000000000 | 0.0000000000000000 | 0.0000000000000000 |
| [C39] X6Y2 | 0.0000000000000000 | 0.0000000000000000 | 0.0000000000000000 | 0.0000000000000000 |
| [C40]X5 Y3 | 0.0000000000000000 | 0.0000000000000000 | 0.0000000000000000 | 0.0000000000000000 |
| [C41] X4Y4 | −0.0000708927267999 | 0.0000000000000000 | 0.0000000000000000 | 0.0000000000000000 |
| [C42] X3Y5 | 0.0000000000000000 | 0.0000000000000000 | 0.0000000000000000 | 0.0000000000000000 |
| [C43] X2Y6 | 0.0000000000000000 | 0.0000000000000000 | 0.0000000000000000 | 0.0000000000000000 |
| [C44] XY7 | 0.0000000000000000 | 0.0000000000000000 | 0.0000000000000000 | 0.0000000000000000 |
| [C45] Y8 | 0.0008099456271799 | 0.0000000000000000 | 0.0000000000000000 | 0.0000000000000000 |
| [C46] X9 | 0.0000000000000000 | 0.0000000000000000 | 0.0000000000000000 | 0.0000000000000000 |
| [C47] X8Y | 0.0000000000000000 | 0.0000000000000000 | 0.0000000000000000 | 0.0000000000000000 |
| [C48] X7Y2 | 0.0000000000000000 | 0.0000000000000000 | 0.0000000000000000 | 0.0000000000000000 |
| [C49] X6Y3 | 0.0000000000000000 | 0.0000000000000000 | 0.0000000000000000 | 0.0000000000000000 |
| [C50] X5Y4 | 0.0000000000000000 | 0.0000000000000000 | 0.0000000000000000 | 0.0000000000000000 |
| [C51] X4Y5 | 0.0000000000000000 | 0.0000000000000000 | 0.0000000000000000 | 0.0000000000000000 |
| [C52] X3Y6 | 0.0000000000000000 | 0.0000000000000000 | 0.0000000000000000 | 0.0000000000000000 |
| [C53] X2Y7 | 0.0000000000000000 | 0.0000000000000000 | 0.0000000000000000 | 0.0000000000000000 |
| [C54] XY8 | 0.0000000000000000 | 0.0000000000000000 | 0.0000000000000000 | 0.0000000000000000 |
| [C55] Y9 | 0.0000000000000000 | 0.0000000000000000 | 0.0000000000000000 | 0.0000000000000000 |
| [C56] X10 | 0.0000000000000000 | 0.0000000000000000 | 0.0000000000000000 | 0.0000000000000000 |
| [C57] X9Y | 0.0000000000000000 | 0.0000000000000000 | 0.0000000000000000 | 0.0000000000000000 |
| [C58] X8Y2 | 0.0000000000000000 | 0.0000000000000000 | 0.0000000000000000 | 0.0000000000000000 |
| [C59] X7Y3 | 0.0000000000000000 | 0.0000000000000000 | 0.0000000000000000 | 0.0000000000000000 |
| [C60] X6Y4 | 0.0000000000000000 | 0.0000000000000000 | 0.0000000000000000 | 0.0000000000000000 |
| [C61] X5Y5 | 0.0000000000000000 | 0.0000000000000000 | 0.0000000000000000 | 0.0000000000000000 |
| [C62] X4Y6 | 0.0000000000000000 | 0.0000000000000000 | 0.0000000000000000 | 0.0000000000000000 |
| [C63] X3Y7 | 0.0000000000000000 | 0.0000000000000000 | 0.0000000000000000 | 0.0000000000000000 |
| [C64] X2Y8 | 0.0000000000000000 | 0.0000000000000000 | 0.0000000000000000 | 0.0000000000000000 |
| [C65] XY9 | 0.0000000000000000 | 0.0000000000000000 | 0.0000000000000000 | 0.0000000000000000 |
| [C66] Y10 | 0.0000000000000000 | 0.0000000000000000 | 0.0000000000000000 | 0.0000000000000000 |

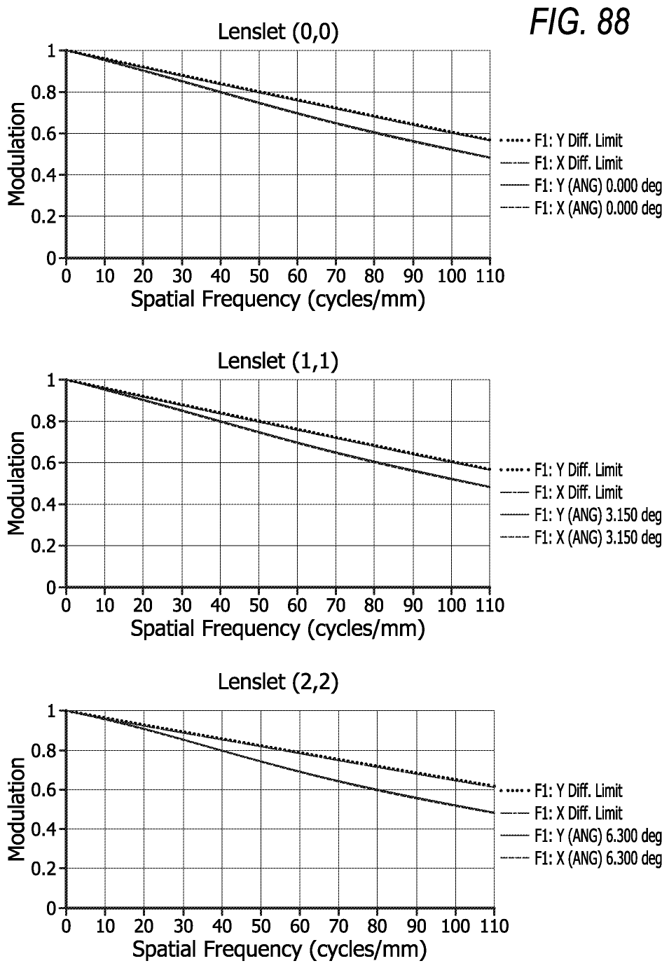

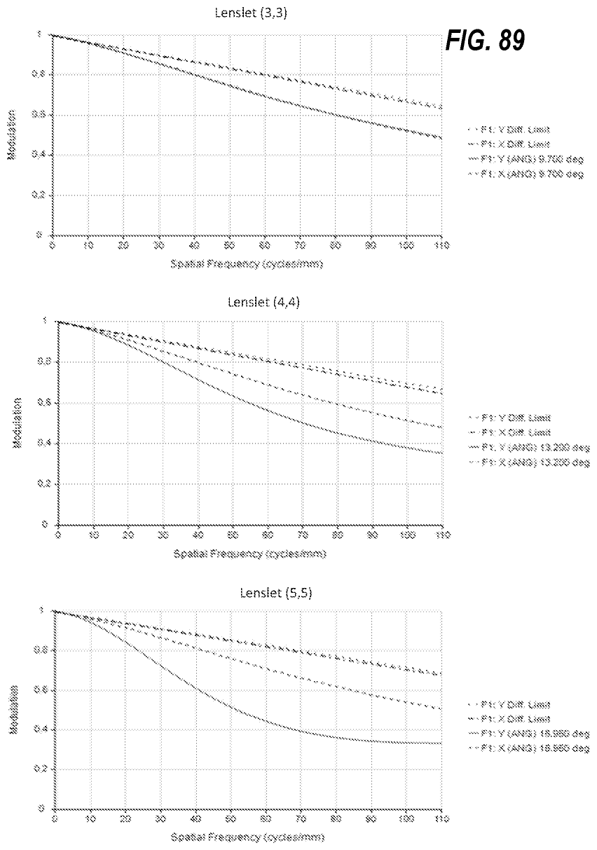

FIG. 88 and FIG. 89 show the polychromatic DMTF analysis for the three selected lenslets for their corresponding centered gazing field, which is the field associated to a ray trajectory passing through a lenslet exit aperture center and whose straight prolongation passes through the center of the eye ball sphere. This situation is the most demanding, since that field point is focused on the fovea, where the human acuity is maximum. In that condition, the resolution is limited by the Nyquist frequency of the VR display pixels which, due to the interlacing factor 2, such spatial frequency is translated to the double the native Nyquist frequency of the display, becoming 100 cycles/mm (i.e. 5 microns o-pixel pitch). When the eye is not gazing a given field, that is, the angle between the field and the gazing direction is different from zero, the human eye acuity is much lower, and so is the angular frequency that the optics needs to resolve.

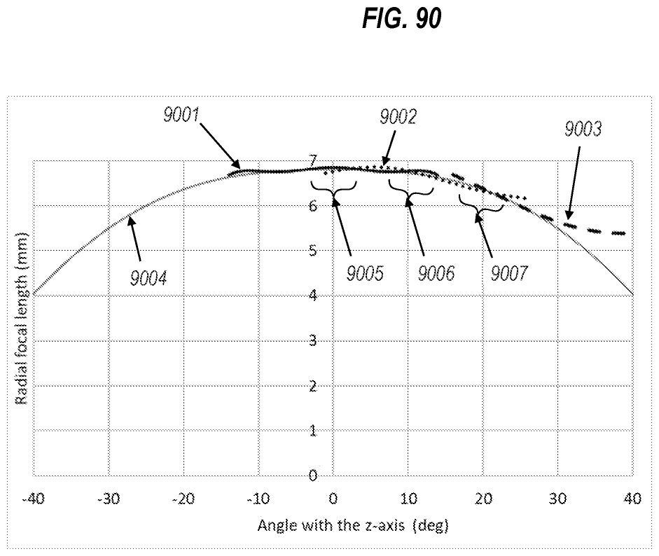

FIG. 90 shows, as an example, the values of the radial focal length as a function of the polar angle (for the azimuthal angle θ or π) of the three selected lenslets (curves 9001 for (0,0), 9002 for (3,3) and 9003 for (6,6)) for the field points coming from the static pupil range. The fields. As can be seen, it can be seen it follows the prescribed value 9004 of function G′(θ) with good accuracy (better than ±3%) for foveal rays, which are portions 9005, 9006 and 9007 of said curves, each portion centered on its corresponding centered gazing field.

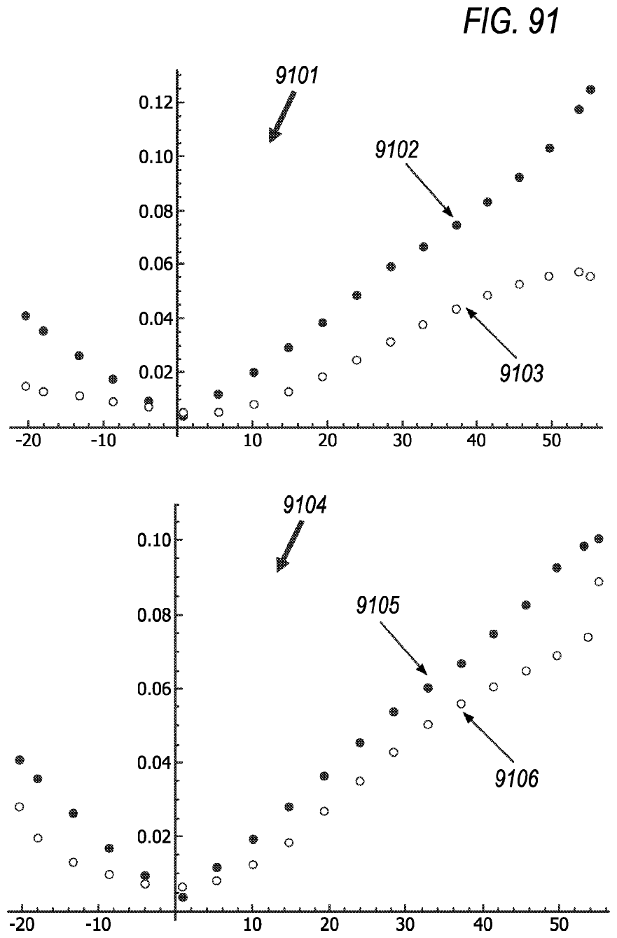

As mentioned before, our design takes into account the eye rotations and the human vision angular acuity function, in order to make the best use of the degrees of freedom available and not having a lens that works better than needed in some circumstances compromising the performance in other circumstances. FIG. 91 shows, as an example, the analysis of the (4,4) lens of the previous design. The abscissa axis indicates the angle between the optical axis of the eye lens and the field point (that is, the “peripheral angle”) for different pupil positions along the plane of symmetry of the lenslet. The vertical axis in 9101 shows, in mm, the values 9103 of the RMS of the radial component of the spot diameter compared with the threshold values 9102 the human eye can detect, computed using the average human eye resolution curve and translated to the display plane with the lenslet directional magnification function. Since the points 9103 are below 9102 ones, it means the human eye see in all situations the image as if it were sharp. Analogously, 9104 shows the values 9106 of the RMS of the sagittal component of the spot diameter compared with the threshold values 9105 the human eye can detected, and again 9106 point are below 9105 ones.

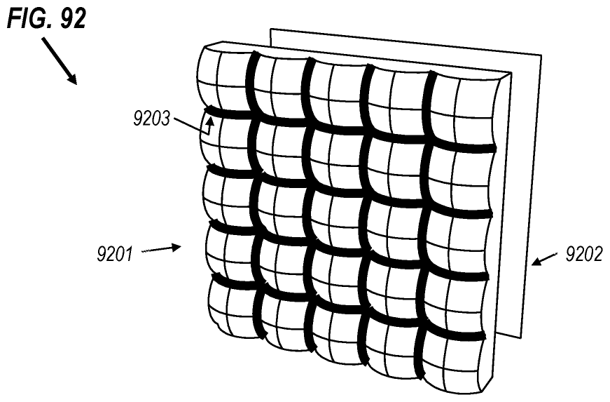

Lens manufacturing can be done by replication on glass substrates by UV curing process with mold manufacturing with diamond turning. PMMA, Zeonex E48R. PC and EP-5000 are also candidate material that could have been used for this design, which can also be conformed by a thermal embossing process. If the edges of said microlenses are nor perfect and occupy a certain non negligible area (specially in the surface closest to the eye) they can produce undesirable scattering. To avoid such effect said edges may be covered by a mask. FIG. 92 shows a generic microlens array 9201 facing a display 9202 with mask 9203. In the overfilling strategy, which is not case described in this example, this mask may cause an uneven distribution of luminance on the scene, creating a rather periodical structure coming from the image of the out of mask. In this case, the brightness of the display may be adjusted in real time as a function of the pupil position to compensate that distribution, so the user will then see a scene without such structure.

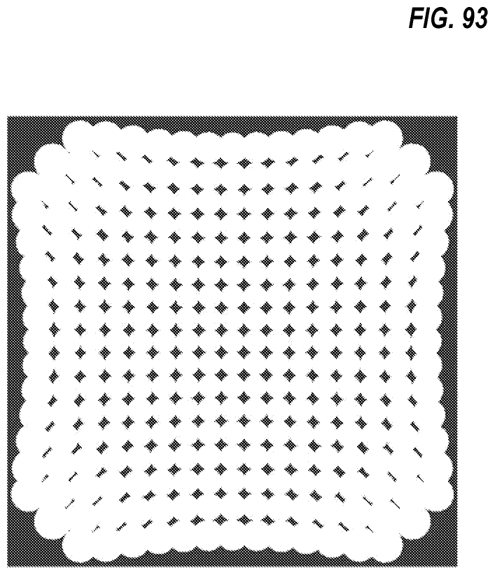

Apart from manufacturing aspects, the imaging performance of these designs may be improved if a mask blocks the light from the corners of quasi-rhomboidal apertures the minilenses, which are usually their poorest performance portions. An example of such a mask to limit the aperture of the freeform surface close to the eye is shown in FIG. 93. This mask is for a squarish FOV design, and if can be placed in front of the first array on in between the first and the second if the lenses are made, for instance, by hot embossing a PMMA sheet. Alternatively, the mask can be deposit on the surface of the substrate glass of the first array if it is made by a wafer plus polymer casting technology.

7. Polarization Based Enhancements

Using polarized light permits further enhancements in this invention, which are disclosed next.

### Increasing the Number of Waist-Surfaces

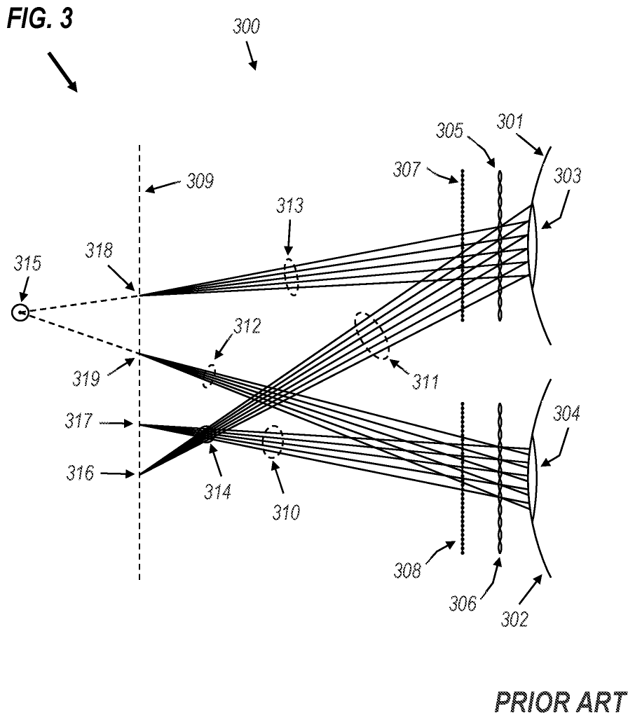

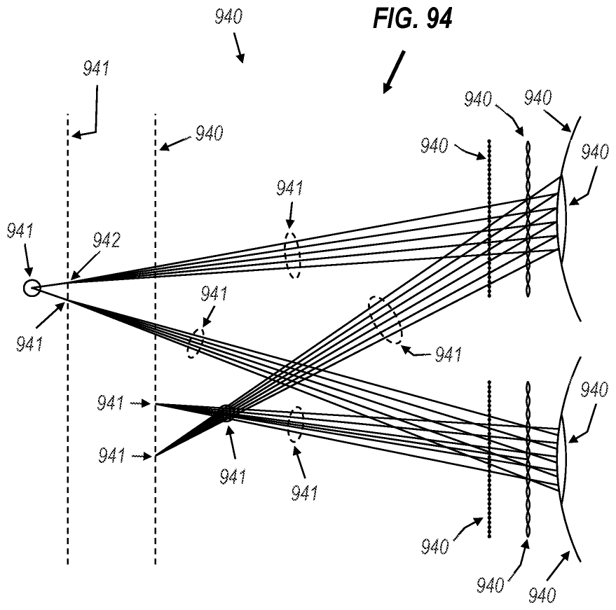

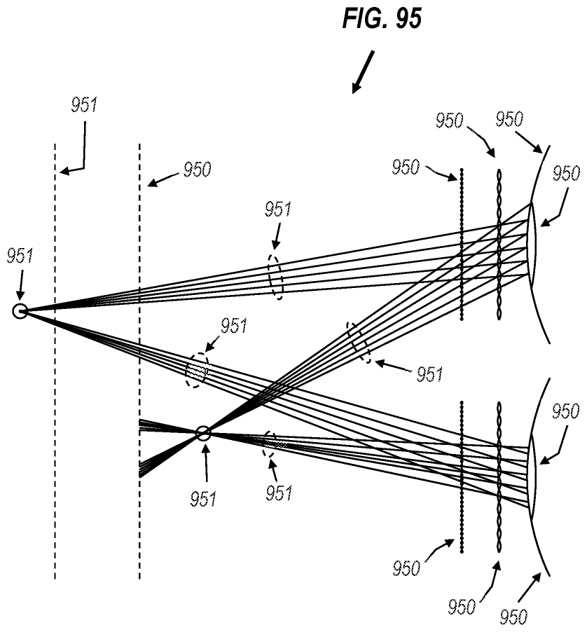

As a general rule, the greater number of waist-surfaces, the larger number of candidate accommodation surfaces, which helps to reduce the VAC. When two are available, one is set closer to the eye than the other, and when more than two are used, they are preferably spaced by a distance between 2 and 5 diopters along the frontwards direction. FIG. 94 illustrate this strategy, showing a stereoscopic system 9400 where eyes 9401 and 9402 with pupils 9403 and 9404 looking into microlens arrays 9405 and 9406 facing displays 9407 and 9408. Both microlens arrays are multi-focal, i.e., they are able to form pencils with waist plane selectable among 9409 or 9410, which are preferably designed to coincide with two accommodation planes (no interlacing is applied in the figure, but interlacing may be included too). Consider now that we want to show v-pixel 9415. It is closest to plane 9409 so we turn on the pencils that cross v-pixel 9415 and have waists at 9409. This configuration still shows VAC because the v-pixel is at position 9415 while eye 9401 accommodates at a-pixel 9417 and eye 9402 accommodates at a-pixel 9418, both at the waist plane 9409 which is also the accommodation plane of 9417 and 9418. However, by choosing an accommodation plane 9409 near the v-pixel 9415, the VAC is reduced with respect the situation of FIG. 3 where there is a single accommodation plane 309. Both eyes see the full resolution of virtual image 9409. Consider now that we want to show v-pixel 9416. It is closest to waist plane 9410 so we turn on the pencils that point at v-pixel 9416 and have waists at 9410, i.e., the pencils 9413 forming a-pixel 9419 and the pencils 9414 forming a-pixel 9420. Observe that in this case, the waist planes coincide with the accommodation plane. This is not the only possibility: we could have selected pencils such that the a-pixels coincide with the v-pixels but not with the pencil's waists, as it is normlay done in LFD and it is shown in FIG. 95.

FIG. 95 shows a stereoscopic system 9500 where eyes 9501 and 9502 with pupils 9503 and 9504 looking into microlens arrays 9505 and 9506 facing displays 9507 and 9508. Both microlens arrays are multi-focal, i.e., they are able to form pencils with waist plane selectable among positions 9509 and 9510, which are preferably designed to coincide with two accommodation planes (in the figure, with interlacing factor 1, but another factor could be used). By turning on pencils 9511 and 9512 one can create v-pixel 9513, which is also the locus of its two a-pixels. Then the eyes will also accommodate at position 9513 and therefore there will not be VAC. However, the apparent size of v-pixel 9513 may be larger than that of v-pixel 9415 as it results from the intersection of several pencils at a section which is bigger than their waist. Pencils 9511 and 9512 have their waists at waist plane 9509, closest to 3D pixel 9513 in order to reduce the loss of perceived resolution. Accordingly, turning on pencils 9514 and 9515 one can create v-pixel 9516. Pencils 9514 and 9515 have their waists at waist plane 9510, closest to v-pixel 9516 formed by two a-pixels also located at 9516.

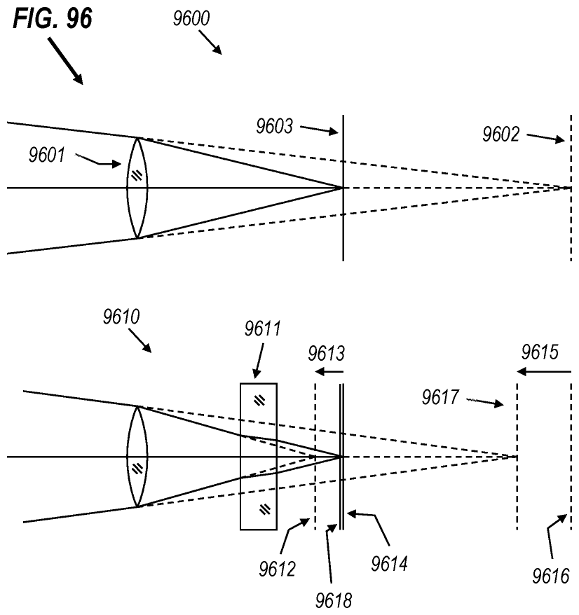

FIG. 96 shows configuration 9600 where an optic 9601 creates a virtual image 9602 of display 9603. Also shown is configuration 9610 with an added transparent block 9611. As light refracts in and out of said block, it will appear to come from a plane 9612, displaced by an amount 9613 relative to display 9614. The virtual image will then appear to have shifted by an amount 9615 from its original position 9616 to a new position 9617. The amount of virtual image shift 9615 depends on the refractive index of block 9611.

In one embodiment, block 9611 may be made of birefringent material, as for instance calcite, quartz and anisotropic polymers, as those that may be made from stretched polyester films. Unpolarized light emitted by display 9614 will be split into two polarizations (ordinary and extraordinary rays) that experience two different refractive indices as light crosses element 9611. As a consequence, two waist planes will be produced at two different distances. Pencils generated by this optical arrangement will be bifocal, i.e, with 2 waists: one at 9616 and the other at 9617.

Alternatively, the display and/or some element of the optics array may be moved with an actuator between the two positions, and the display maybe time multiplexed synchronized with those movement, so in the first half of the frame the waist in on one plane and the second half on the second plane. This method is less efficient and requires faster displays. Another option consists in dividing the lenslet array in two or more groups and design each one to provide pencils with different waist position. This lowers the potential x-y resolution of the virtual image, since those groups could be used to do interlacing in a single waist plane. Finally, lenslets providing pencils with two or more waists, as in multifocal intraocular lenses, may certainly help too, although the MTF quality at the waists planes are lower than in single waist pencils.

In another embodiment, display 9614 emits linearly polarized light and is covered by a liquid crystal panel 9618 (without any polarizing filter) that has the ability to rotate the polarization of the light by 90 degs when applied a voltage. Different portions of the panel (i.e., the liquid crystal panel pixels) may produce different polarization rotations, even down to the level of being possible to set the polarization for each individual pixel, even the display itself may have that capability (so 9618 would not be needed). Said different polarizations will experience different refractive indices as light crosses element 9611 and, as referred above, will produce virtual image planes at different distances. This embodiment then allows different regions of the virtual image plane to be placed at different distances, reducing the vergence-accommodation mismatch. With this optical arrangement we may have bifocal pencils with 2 waists (one at 9616 and another at 9617) whose relative brightness weight may be controlled with the voltage applied to the liquid crystal pixel, going from a single-waist pencil at 9616 up to a single-waist pencil at 9617 and passing by bifocal pencils whose 2 waists have a variable brightness contribution which depends on the voltage applied to the liquid crystal pixel. This analogue behavior of the variable relative brightness can be used to fine tune the accommodation location perception of bifocal pencils between the two waists, and therefore to fine tune a-pixels made of this type of pencils.

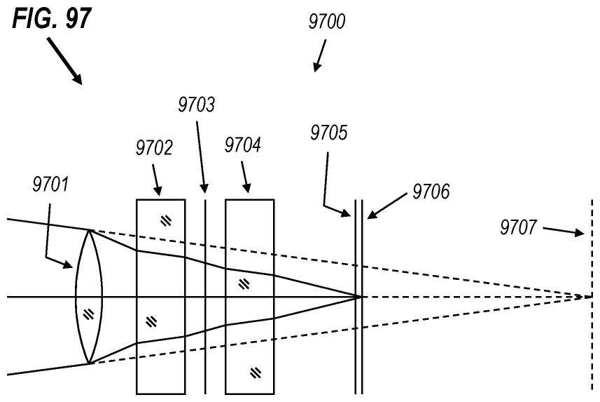

FIG. 97 shows embodiment 9700 composed of optic 9701, birefringent element 9702, liquid crystal panel 9703, birefringent element 9704, liquid crystal panel 9705 and display 9706 that emits polarized light. Liquid crystal panel 9703 may have the same or smaller pixel pitch as the microlens array. Said system, when the liquid crystal panels 9703 and 9705 are in a certain state, may produce a virtual image 9707.

Liquid crystal panel 9705 has the ability to rotate the polarization of the light crossing it. Said light, as it crosses birefringent element 9704, will experience a refractive index n_{2A} or n_{2B}, depending on the polarization state of the light. Said light then crosses liquid crystal panel 9703 which again has the ability to rotate the polarization of said light. Again, as said light crosses birefringent element 9702, will experience a refractive index n_{1A} or n_{1B}, depending on the polarization state of the light. This system therefore has four possible states, depending on the polarization rotation introduced by elements 9705 or 9703 which correspond to light experiencing a refractive index n_{2A} or n_{B2} at element 9704, and a refractive index n_{1A} or n_{1B} at element 9702. The crossing of element 9704 displaces virtual image 9707 as does the crossing of element 9702. This embodiment therefore has the ability to place the virtual image 9707 at four different distances from the display 9706.

Also, different regions of panels 9705 or 9703 may be addressed separately, rotating differently the polarization of light. This results an image split over different portions of image planes, placed at different distances, that is, the waist of the pencils will be located at those four distances by the adequate addressing of the 4 LCDs. Objects near the display 9706 may be represented on an image plane closer to 9706 while objects far from the display 9706 may be represented on an image plane further from 9706. This may be used to alleviate the vergence-accommodation mismatch. Alternatively, liquid 9703 can be switched and fast axis 9702 can be placed at 45 degs relative to the fast axis of 9704. As a consequence, 9702 will produce that the pencils will have two waists, and those waists pairs may be jointly shifted according to the addressing of 9705.

Additionally, a similar analogue control of the brightness relative weight explained for FIG. 96 can be applied in the configurations of FIG. 97, opening the possibility of a finer tuning of the pencil's accommodation location along its central ray.

Waist planes are preferably designed, as already mentioned, to coincide with accommodation planes. Alternatively, waist planes may be designed to be located in between two consecutive accommodation planes of the selected ones, to provide a more uniform resolution between both accommodation planes. Typical positions of the two waist surfaces may be between 0.25 to 1 m for the one closest to the eye, and between 0.75 to 5 m for the farthest one.

Using Adjacent Clusters of Orthogonal Polarizations

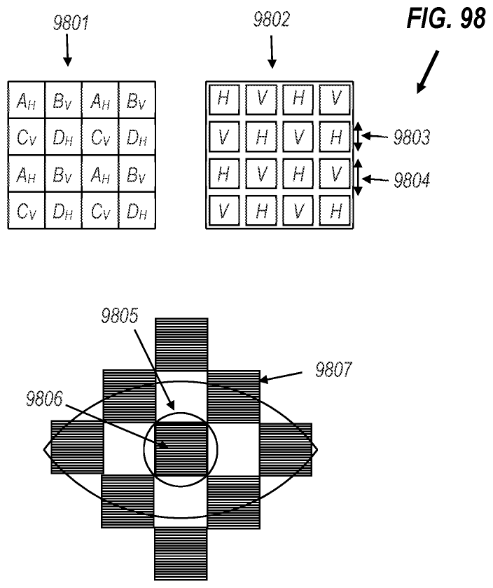

FIG. 98 shows elements of a display device with interlacing factor 2 and underfilling strategy. 9801 are the lenslet apertures, with families A, B, C and D. 9802 is the display, with two groups of clusters emitting orthogonal polarizations, for instance, vertical (V) and horizontal (H), which could be created with a Liquid crystal panel as 9705. Therefore, lenslets A and D have polarizers to transmit H polarized light (the one emitter by their corresponding clusters) and absorb the V polarized light (coming from adjacent clusters), and similarly, C and D lenslets have polarizers to transmit V light and absorb H light. If the ratio of 9803 to 9804 is 0.66, the design gets the maximum possible resolution by illuminating the pupil 9805 underfilling it but filling it the maximum possible: square 9806 (which is the union of all inner lit pencil prints on the pupil plane) is tangent to pupil 9805, and cross-talk squares as 9807 are also tangent to it (from the outside). This highest resolution design, when compared to the non-polarization reference described in [0288], result in a 1.2× higher resolution (given by the ratio 0.65/0.55). Practical design will require a slightly lower resolution to allow for pupil diameter variations and pupil tracker errors.

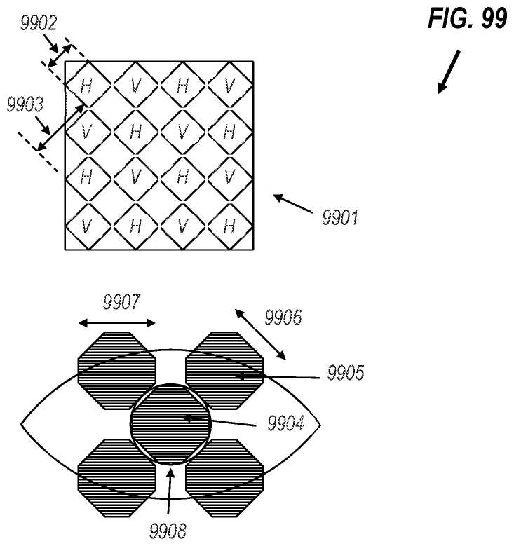

FIG. 99 shows an alternative embodiment with underfilling strategy, for the same lenslets 9801 but with interlacing factor 2^{1/2}. (so there are only two families A and B of lenslets in a chessboard configuration). In this case, clusters on display 9901 are rotated 45 degs with respect to the lenslets, and if the ratio 9902 to 9903 is 0.473, the design reaches its maximum resolution, in which the octagonal regions as 9904 and 9905, union of pencil prints on the pupil plane, are tangent to the pupil 9908. The octagon dimensions approximately fulfill that the ratio of 9907 to 9906 is 1.06, and its comparison with the non-polarization reference described in [0288], results also in a 1.2× higher resolution.

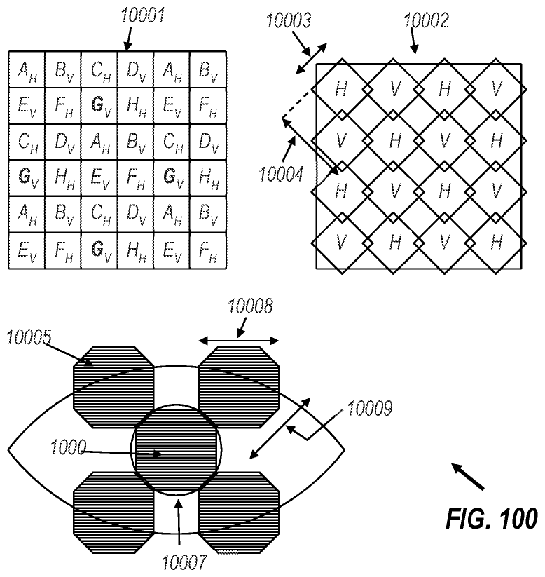

FIG. 100 shows a last embodiment, also with underfilling strategy, an interlacing factor 8^{1/2}, thus with 8 families (A to H) of lenslets 10001. In this case clusters on display 10002 are also rotated 45 degs with respect to the lenslets, and if the ratio 10003 to 10004 is 0.634, the design reaches its maximum resolution, in which the octagonal regions as 10006 and 10005, union of pencil prints on the pupil plane, are tangent to the pupil 10007. The octagon dimensions approximately fulfill that the ratio of 10009 to 10008 is also 1.06, and its comparison with the non-polarization reference described in [0288], results in a dramatic increase of resolution, by a factor 1.65×.

Notice that embodiments in FIG. 98 and FIG. 99 have a sizable dark gap between clusters, so the Liquid crystal panel as 9705 could be of low resolution compared to the display itself. However, the overlapping in the case of FIG. 100 forces the Liquid crystal panel as 9705 to have a resolution similar to that of the display, or to merge with the display, being this of an special type in which the polarization of its pixels can be selected.

1. A display device comprising:
a display, operable to generate a real image comprising a plurality of object pixels; and an optical system, comprising a plurality of lenslets, each lenslet having associated one cluster of object pixels;
wherein the assignation of object pixels to clusters may change periodically in time intervals, preferably a frame period;
wherein each lenslet produces a ray pencil from each object pixel of its corresponding cluster, said pencils having corresponding waists laying close to a waist surface;
wherein each lenslet projects its corresponding ray pencils towards an imaginary sphere at an eye position; said sphere being an approximation of the eyeball sphere and being in a fixed location relative to the user's skull;
wherein said ray pencils of each lenslet are configured to generate a partial virtual image from the real image of its corresponding cluster, and wherein the partial virtual images of the lenslets combine to form a virtual image to be visualized through a pupil of an eye during use;
wherein at least two of the lenslets cannot be made to coincide by a simple translation rigid motion;
wherein foveal rays are a subset of rays emanating from the lenslets during use that reach the eye and whose straight prolongation is away from the imaginary sphere center a distance smaller than a value between 2 and 4 mm;
wherein the corresponding foveal lenslets of a given field point are those intercepted by the foveal rays of that field point;
wherein the directional magnification function is a ratio of distance on the display surface over distance between field points; and
wherein for any field point of a gazeable region of a field of view, values of a directional magnification function for the foveal lenslets corresponding to that field point differ less than 10%.

2. The display device of claim 1, wherein the ray pencils are activated to make the accommodation pixels lay close to a waist surface.

3. The display device of claim 1, wherein there are more green color ray pencils than blue color ones.

4. The display device of claim 1, wherein at least one pencil is represented as a non-connected set in the phase space.

5. The display device of claim 1, wherein the only ray pencils of each lenslet that intersect said imaginary sphere inside a static pupil range are associated to the object pixels of its corresponding cluster;
wherein said static pupil range is the region of the imaginary sphere comprising the expected eye pupil positions.

6. The display device of claim 1, further comprising a display driver operative to assign and drive the object pixels of the lenslet clusters.

7. The display device of claim 1, further comprising a pupil tracker and a display driver operative to dynamically assign and drive the object pixels of the lenslet clusters.

8. The display device of claim 7, wherein the only ray pencils of each lenslet that intersect said imaginary sphere inside a dynamic pupil range are associated to the object pixels of its corresponding cluster;
wherein said dynamic pupil range is the region of the imaginary sphere comprising the expected eye pupil position provided by a pupil tracker.

9. The display device of claim 1, wherein waists of said pencils of adjacent lensets are interlaced at a waist surface.

10. The display device of claim 9, wherein the interlacing is produced by rotation of a display relative to a lenslet array.

11. The display device of claim 1, wherein the directional magnification in the radial direction multiplied by the square of the cosine of the polar angle is a decreasing function of the polar angle;
wherein the polar angle of a field is the angle formed by that field with the skull's frontward direction.

12. The display device of claim 1, wherein the directional magnification in the radial direction is a decreasing function of the polar angle.

13. The display device of claim 1, wherein there is at least a conforming lens along the ray path from the display to the eye.

14. The display device of claim 13, wherein said conforming lens has at least one surface with slope discontinuities.

15. The display device of claim 1, wherein the display device includes two or more displays per eye.

16. The display device of claim 1, wherein, for every direction angle, the directional magnification of at least one lenslet is maximum at its centered gazing field;
wherein said centered gazing field being associated to a ray trajectory passing through a lenslet exit aperture center and whose straight prolongation passes through the center of the imaginary sphere.

17. The display device of claim 1, wherein, for every direction angle, the image quality of at least one lenslet is maximum at its centered gazing field.

18. The display device of claim 1, wherein there are at least two waist surfaces, one closer to the eye during use than the other.

19. The display device of claim 18, wherein the waist surfaces are approximated by planes normal to the skull's frontward direction spaced by a distance between 2 and 5 diopters.

20. The display device of claim 18, wherein at least two pencils with waists at different waist surfaces are fed by light with orthogonal polarizations.

21. The display device of claim 1, further comprising a second display device, a mount to position the first and second display devices relative to one another such that their respective lenslets project the light towards two eyes of a human being, and a display driver operative to cause the display devices to display objects such that the two virtual images from the two display devices combine to form a single image when viewed by a human observer.

22. The display device of claim 20, wherein the pencils are activated so every vergence pixel has their two corresponding accommodation pixels laying on the waist surface closest to said vergence pixel.

23. The display device of claim 7, wherein the clusters are surrounded by unlit viewable object pixels;
wherein a viewable object pixel is an object pixel which illuminates at least one associated pencil that intersects the eye pupil.

24. The display device of claim 22, wherein the unlit viewable object pixels are more than 25% of the total of viewable object pixels.

25. (canceled)

26. The display device of claim 1, wherein at least 80% of the waists of pencils containing foveal rays and that are associated to objects pixels belonging to clusters do not overlap angularly from a center of the eye pupil.

27. The display device of claim 7, wherein the display driver drives more power to the viewable object pixels whose corresponding pencils enter partially the eye pupil to compensate for flux lost by vignetting.

28. The display device of claim 1, further comprising a mask to block the undesired light from the lenslet exit apertures.

29. The display device of claim 1, further comprising one or more actuators to shift components lenslet array relative to display to produce interlacing, waist-surface modification or eye prescription correction.

30. The display device of claim 1, wherein the light carried by pencils associated to object pixels of adjacent clusters have orthogonal polarizations.
